(19) United States
(12) Patent Application Publication
(10) Pub. No.: US 2025/0260809 A1
(43) Pub. Date: Aug. 14, 2025

(54) SYSTEMS AND METHODS FOR REDUCING A RECONSTRUCTION ERROR IN VIDEO CODING BASED ON A CROSS-COMPONENT CORRELATION

(71) Applicant: Sharp Kabushiki Kaisha, Sakai City (JP)

(72) Inventors: Kiran Mukesh MISRA, Vancouver, WA (US); Frank BOSSEN, Vancouver, WA (US); Christopher Andrew SEGALL, Vancouver, WA (US); Sachin G. DESHPANDE, Vancouver, WA (US)

(21) Appl. No.: 19/097,081

(22) Filed: Apr. 1, 2025

Related U.S. Application Data
(63) Continuation of application No. 18/617,986, filed on Mar. 27, 2024, now Pat. No. 12,301,803.
Application No. 18/617,986 is a continuation of application No. 17/766,322, filed on Apr. 4, 2022, now Pat. No. 11,979,566.
(60) Provisional application No. 62/913,065, filed on Oct. 9, 2019.
(60) Provisional application No. 62/950,000, filed on Dec. 18, 2019.

(51) Int. Cl. H04N 19/117; H04N 19/186; H04N 19/46; H04N 19/70; H04N 19/82

(52) U.S. Cl. CPC H04N 19/117; H04N 19/186; H04N 19/46; H04N 19/70; H04N 19/82

(57) ABSTRACT

A method of filtering reconstructed video data is disclosed. The method comprising: parsing a first syntax element used for setting cross-component filter coefficients; inputting a reconstructed luma picture sample array; deriving luma locations by using location corresponding to a current chroma sample; deriving a filter coefficient array by using the cross-component filter coefficients; deriving a variable by using the filter coefficient array and the reconstructed luma picture sample array defined by the luma locations; and deriving a scaled variable by using the variable, wherein the variable is modified by a sum of a sample of a current chroma block, which is defined by a predetermined location, and the scaled variable.

### TECHNICAL FIELD

This disclosure relates to video coding and more particularly to techniques for reducing a reconstruction error.

### BACKGROUND ART

Digital video capabilities can be incorporated into a wide range of devices, including digital televisions, laptop or desktop computers, tablet computers, digital recording devices, digital media players, video gaming devices, cellular telephones, including so-called smartphones, medical imaging devices, and the like. Digital video may be coded according to a video coding standard. Video coding standards define the format of a compliant bitstream encapsulating coded video data. A compliant bitstream is a data structure that may be received and decoded by a video decoding device to generate reconstructed video data. Video coding standards may incorporate video compression techniques. Examples of video coding standards include ISO/IEC MPEG-4 Visual and ITU-T H.264 (also known as ISO/IEC MPEG-4 AVC) and High-Efficiency Video Coding (HEVC). HEVC is described in High Efficiency Video Coding (HEVC), Rec. ITU-T H.265, December 2016, which is incorporated by reference, and referred to herein as ITU-T H.265. Extensions and improvements for ITU-T H.265 are currently being considered for the development of next generation video coding standards. For example, the ITU-T Video Coding Experts Group (VCEG) and ISO/IEC (Moving Picture Experts Group (MPEG) (collectively referred to as the Joint Video Exploration Team (JVET)) are working to standardized video coding technology with a compression capability that significantly exceeds that of the current HEVC standard. The Joint Exploration Model 7 (JEM 7), Algorithm Description of Joint Exploration Test Model 7 (JEM 7), ISO/IEC JTC1/SC29/WG11 Document: JVET-G1001, July 2017, Torino, IT, which is incorporated by reference herein, describes the coding features that were under coordinated test model study by the JVET as potentially enhancing video coding technology beyond the capabilities of ITU-T H.265. It should be noted that the coding features of JEM 7 are implemented in JEM reference software. As used herein, the term JEM may collectively refer to algorithms included in JEM 7 and implementations of JEM reference software. Further, in response to a “Joint Call for Proposals on Video Compression with Capabilities beyond HEVC,” jointly issued by VCEG and MPEG, multiple descriptions of video coding tools were proposed by various groups at the 10^{th} Meeting of ISO/IEC JTC1/SC29/WG11 16-20 Apr. 2018, San Diego, CA. From the multiple descriptions of video coding tools, a resulting initial draft text of a video coding specification is described in “Versatile Video Coding (Draft 1),” 10th Meeting of ISO/IEC JTC1/SC29/WG11 16-20 Apr. 2018, San Diego, CA, document JVET-J1001-v2, which is incorporated by reference herein, and referred to as JVET-J1001. The current development of a next generation video coding standard by the VCEG and MPEG is referred to as the Versatile Video Coding (VVC) project. “Versatile Video Coding (Draft 5),” 14th Meeting of ISO/IEC JTC1/SC29/WG11 19-27 Mar. 2019, Geneva, CH, document JVET-N1001-v8, which is incorporated by reference herein, and referred to as JVET-N1001, represents an iteration of the draft text of a video coding specification corresponding to the VVC project. “Versatile Video Coding (Draft 6),” 15th Meeting of ISO/IEC JTC1/SC29/WG11 3-12 Jul. 2019, Gothenburg, SE, document JVET-O2001-vE, which is incorporated by reference herein, and referred to as JVET-O2001, an iteration of the draft text of a video coding specification corresponding to the VVC project.

Video compression techniques enable data requirements for storing and transmitting video data to be reduced. Video compression techniques may reduce data requirements by exploiting the inherent redundancies in a video sequence. Video compression techniques may sub-divide a video sequence into successively smaller portions (i.e., groups of pictures within a video sequence, a picture within a group of pictures, regions within a picture, sub-regions within regions, etc.). Intra prediction coding techniques (e.g., spatial prediction techniques within a picture) and inter prediction techniques (i.e., inter-picture techniques (temporal)) may be used to generate difference values between a unit of video data to be coded and a reference unit of video data. The difference values may be referred to as residual data. Residual data may be coded as quantized transform coefficients. Syntax elements may relate residual data and a reference coding unit (e.g., intra-prediction mode indices, and motion information). Residual data and syntax elements may be entropy coded. Entropy encoded residual data and syntax elements may be included in data structures forming a compliant bitstream.

### SUMMARY OF INVENTION

In one example, a method of filtering reconstructed video data, the method comprising: parsing a first syntax element used for setting cross-component filter coefficients; inputting a reconstructed luma picture sample array; deriving luma locations by using location corresponding to a current chroma sample; deriving an filter coefficient array by using the cross-component filter coefficients; deriving a variable by using the filter coefficient array and the reconstructed luma picture sample array defined by the luma locations; and deriving a scaled variable by using the variable, wherein the variable is modified by a sum of a sample of a current chroma block, which is defined by a predetermined location, and the scaled variable.

In one example, a device for coding video data, the device comprising one or more processors configured to: code a first syntax element used for setting cross-component filter coefficients; input a reconstructed luma picture sample array; derive luma locations by using a location corresponding to a current chroma sample; derive an filter coefficient array by using the cross-component filter coefficients; derive a variable by using the filter coefficient array and the reconstructed luma picture sample array defined by the luma locations; and derive a scaled variable by using the variable, wherein the variable is modified by a sum of a sample of a current chroma block, which is defined by a predetermined location, and the scaled variable.

In one example, a device for decoding video data, the device comprising one or more processors configured to: decode a first syntax element used for setting cross-component filter coefficients; input a reconstructed luma picture sample array; derive luma locations by using a location corresponding to a current chroma sample; derive an filter coefficient array by using the cross-component filter coefficients; derive a variable by using the filter coefficient array and the reconstructed luma picture sample array defined by the luma locations; and derive a scaled variable by using the variable, wherein the variable is modified by a sum of a sample of a current chroma block, which is defined by a predetermined location, and the scaled variable.

### BRIEF DESCRIPTION OF DRAWINGS

FIG. 1 is a conceptual diagram illustrating an example of a group of pictures coded according to a quad tree multi-tree partitioning in accordance with one or more techniques of this disclosure.

FIG. 2A is a conceptual diagram illustrating example of coding a block of video data in accordance with one or more techniques of this disclosure.

FIG. 2B is a conceptual diagram illustrating example of coding a block of video data in accordance with one or more techniques of this disclosure.

FIG. 3 is a conceptual diagram illustrating an example of a video component sampling format that may be utilized in accordance with one or more techniques of this disclosure.

FIG. 4 is a block diagram illustrating an example of a video encoder that may be configured to encode video data according to one or more techniques of this disclosure.

FIG. 5 is a block diagram illustrating an example of cross component filter unit that may be configured to encode video data according to one or more techniques of this disclosure.

FIG. 6 is a conceptual diagram illustrating examples of reconstruction errors for multiple components of video data in accordance with one or more techniques of this disclosure.

FIG. 7 is conceptual diagram illustrating an example of reducing a reconstruction error using cross component filtering accordance with one or more techniques of this disclosure.

FIG. 8A is a block diagram illustrating example of cross component filter units that may be configured to reduce a reconstruction error according to one or more techniques of this disclosure.

FIG. 8B is a block diagram illustrating example of cross component filter units that may be configured to reduce a reconstruction error according to one or more techniques of this disclosure.

FIG. 8C is a block diagram illustrating example of cross component filter units that may be configured to reduce a reconstruction error according to one or more techniques of this disclosure.

FIG. 8D is a block diagram illustrating example of cross component filter units that may be configured to reduce a reconstruction error according to one or more techniques of this disclosure.

FIG. 9A is a block diagram illustrating example of cross component filter units that may be configured to reduce a reconstruction error according to one or more techniques of this disclosure.

FIG. 9B is a block diagram illustrating example of cross component filter units that may be configured to reduce a reconstruction error according to one or more techniques of this disclosure.

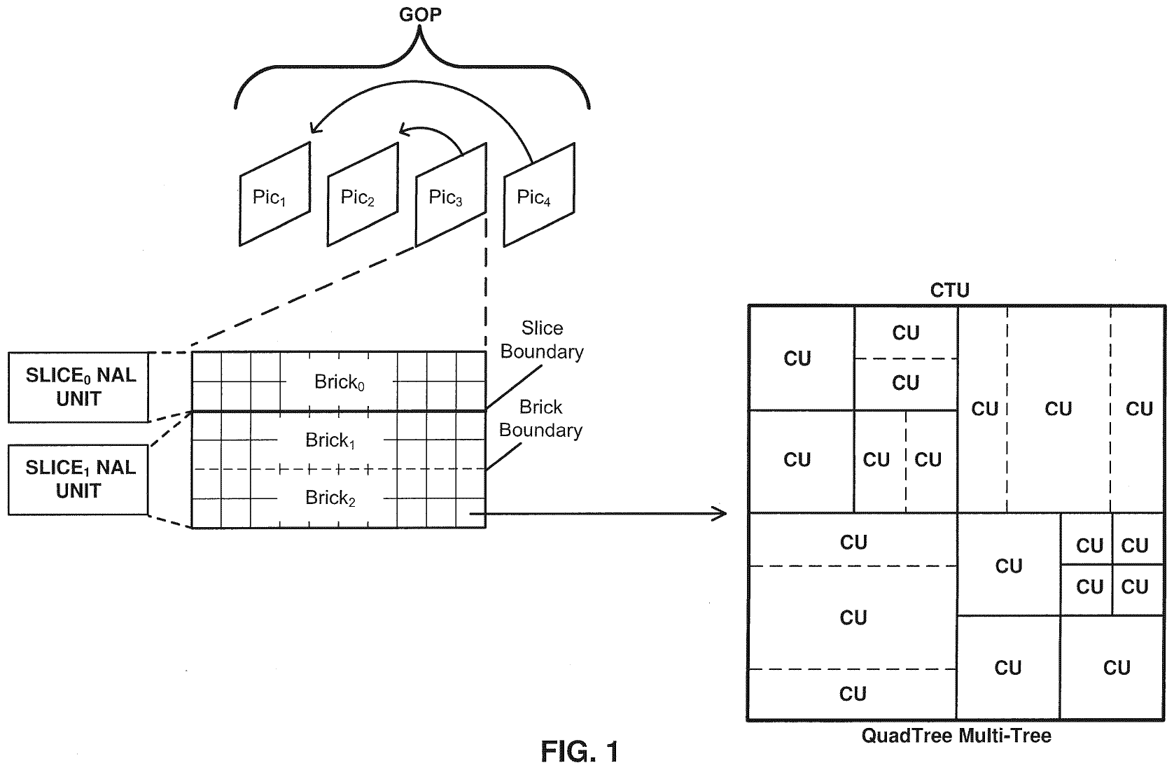

FIG. 1A is a conceptual diagram illustrating example of filter coefficient locations which may be used for cross component filtering in accordance with one or more techniques of this disclosure.

FIG. 10B is a conceptual diagram illustrating example of filter coefficient locations which may be used for cross component filtering in accordance with one or more techniques of this disclosure.

FIG. 10C is a conceptual diagram illustrating example of filter coefficient locations which may be used for cross component filtering in accordance with one or more techniques of this disclosure.

FIG. 10D is a conceptual diagram illustrating example of filter coefficient locations which may be used for cross component filtering in accordance with one or more techniques of this disclosure.

FIG. 10E is a conceptual diagram illustrating example of filter coefficient locations which may be used for cross component filtering in accordance with one or more techniques of this disclosure.

FIG. 10F is a conceptual diagram illustrating example of filter coefficient locations which may be used for cross component filtering in accordance with one or more techniques of this disclosure.

FIG. 11A is a conceptual diagram illustrating example of filter coefficient locations which may be used for cross component filtering in accordance with one or more techniques of this disclosure.

FIG. 11B is a conceptual diagram illustrating example of filter coefficient locations which may be used for cross component filtering in accordance with one or more techniques of this disclosure.

FIG. 11C is a conceptual diagram illustrating example of filter coefficient locations which may be used for cross component filtering in accordance with one or more techniques of this disclosure.

FIG. 11D is a conceptual diagram illustrating example of filter coefficient locations which may be used for cross component filtering in accordance with one or more techniques of this disclosure.

FIG. 12A is a conceptual diagram illustrating example of virtual line buffers which may be used for cross component filtering in accordance with one or more techniques of this disclosure.

FIG. 12B is a conceptual diagram illustrating example of virtual line buffers which may be used for cross component filtering in accordance with one or more techniques of this disclosure.

FIG. 12C is a conceptual diagram illustrating example of virtual line buffers which may be used for cross component filtering in accordance with one or more techniques of this disclosure.

FIG. 12D is a conceptual diagram illustrating example of virtual line buffers which may be used for cross component filtering in accordance with one or more techniques of this disclosure.

FIG. 13 is a block diagram illustrating an example of a video decoder that may be configured to decode video data according to one or more techniques of this disclosure.

FIG. 14 is a block diagram illustrating an example of cross component filter unit that may be configured to encode video data according to one or more techniques of this disclosure.

FIG. 15A is a block diagram illustrating example of cross component filter units that may be configured to reduce a reconstruction error according to one or more techniques of this disclosure.

FIG. 15B is a block diagram illustrating example of cross component filter units that may be configured to reduce a reconstruction error according to one or more techniques of this disclosure.

FIG. 15C is a block diagram illustrating example of cross component filter units that may be configured to reduce a reconstruction error according to one or more techniques of this disclosure.

### DESCRIPTION OF EMBODIMENTS

This application is related to U.S. Provisional Application No. 62/865,933, filed on Jun. 24, 2019; U.S. Provisional Application No. 62/870,752, filed on Jul. 4, 2019; U.S. Provisional Application No. 62/886,891, filed on Aug. 14, 2019; U.S. Provisional Application No. 62/899,053, filed on Sep. 11, 2019; U.S. Provisional Application No. 62/901,679, filed on Sep. 17, 2019; U.S. Provisional Application No. 62/904,399, filed on Sep. 23, 2019; U.S. Provisional Application No. 62/905,312, filed on Sep. 24, 2019; U.S. Provisional Application No. 62/910,317, filed on Oct. 3, 2019; and U.S. Provisional Application No. 62/913,065, filed on Oct. 9, 2019, each of which are incorporated by reference in their entirety.

In general, this disclosure describes various techniques for coding video data. In particular, this disclosure describes techniques for reducing a reconstruction error. It should be noted that although techniques of this disclosure are described with respect to ITU-T H.264, ITU-T H.265, JEM, JVET-N1001, and JVET-O2001 the techniques of this disclosure are generally applicable to video coding. For example, the coding techniques described herein may be incorporated into video coding systems, (including video coding systems based on future video coding standards) including video block structures, intra prediction techniques, inter prediction techniques, transform techniques, filtering techniques, and/or entropy coding techniques other than those included in ITU-T H.265, JEM, JVET-N1001, and JVET-O2001. Thus, reference to ITU-T H.264, ITU-T H.265, JEM, JVET-N1001, and/or JVET-O2001 is for descriptive purposes and should not be construed to limit the scope of the techniques described herein. Further, it should be noted that incorporation by reference of documents herein is for descriptive purposes and should not be construed to limit or create ambiguity with respect to terms used herein. For example, in the case where an incorporated reference provides a different definition of a term than another incorporated reference and/or as the term is used herein, the term should be interpreted in a manner that broadly includes each respective definition and/or in a manner that includes each of the particular definitions in the alternative.

In one example, a method comprises receiving reconstructed sample data for a current component of video data, receiving reconstructed sample data for one or more additional components of video data, deriving a cross component filter based on data associated with one or more additional components of video data, and applying a filter to the reconstructed sample data for a current component of video data based on the derived cross component filter and the reconstructed sample data for one or more additional components of video data.

In one example, a device comprises one or more processors configured to receive reconstructed sample data for a current component of video data, receiving reconstructed sample data for one or more additional components of video data, derive a cross component filter based on data associated with one or more additional components of video data, and apply a filter to the reconstructed sample data for a current component of video data based on the derived cross component filter and the reconstructed sample data for one or more additional components of video data.

In one example, a non-transitory computer-readable storage medium comprises instructions stored thereon that, when executed, cause one or more processors of a device to receive reconstructed sample data for a current component of video data, receiving reconstructed sample data for one or more additional components of video data, derive a cross component filter based on data associated with one or more additional components of video data, and apply a filter to the reconstructed sample data for a current component of video data based on the derived cross component filter and the reconstructed sample data for one or more additional components of video data.

In one example, an apparatus comprises means for receiving reconstructed sample data for one or more additional components of video data, means for deriving a cross component filter based on data associated with one or more additional components of video data, and means for applying a filter to the reconstructed sample data for a current component of video data based on the derived cross component filter and the reconstructed sample data for one or more additional components of video data. The details of one or more examples are set forth in the accompanying drawings and the description below. Other features, objects, and advantages will be apparent from the description and drawings, and from the claims.

Video content includes video sequences comprised of a series of frames (or pictures). A series of frames may also be referred to as a group of pictures (GOP). Each video frame or picture may divided into one or more regions. Regions may be defined according to a base unit (e.g., a video block) and sets of rules defining a region. For example, a rule defining a region may be that a region must be an integer number of video blocks arranged in a rectangle. Further, video blocks in a region may be ordered according to a scan pattern (e.g., a raster scan). As used herein, the term video block may generally refer to an area of a picture or may more specifically refer to the largest array of sample values that may be predictively coded, sub-divisions thereof, and/or corresponding structures. Further, the term current video block may refer to an area of a picture being encoded or decoded. A video block may be defined as an array of sample values. It should be noted that in some cases pixel values may be described as including sample values for respective components of video data, which may also be referred to as color components, (e.g., luma (Y) and chroma (Cb and Cr) components or red, green, and blue components). It should be noted that in some cases, the terms pixel value and sample value are used interchangeably. Further, in some cases, a pixel or sample may be referred to as a pel. A video sampling format, which may also be referred to as a chroma format, may define the number of chroma samples included in a video block with respect to the number of luma samples included in a video block. For example, for the 4:2:0 sampling format, the sampling rate for the luma component is twice that of the chroma components for both the horizontal and vertical directions.

A video encoder may perform predictive encoding on video blocks and sub-divisions thereof. Video blocks and sub-divisions thereof may be referred to as nodes. ITU-T H.264 specifies a macroblock including 16×16 luma samples. That is, in ITU-T H.264, a picture is segmented into macroblocks. ITU-T H.265 specifies an analogous Coding Tree Unit (CTU) structure (which may be referred to as a largest coding unit (LCU)). In ITU-T H.265, pictures are segmented into CTUs. In ITU-T H.265, for a picture, a CTU size may be set as including 16×16, 32×32, or 64×64 luma samples. In ITU-T H.265, a CTU is composed of respective Coding Tree Blocks (CTB) for each component of video data (e.g., luma (Y) and chroma (Cb and Cr)). It should be noted that video having one luma component and the two corresponding chroma components may be described as having two channels, i.e., a luma channel and a chroma channel. Further, in ITU-T H.265, a CTU may be partitioned according to a quadtree (QT) partitioning structure, which results in the CTBs of the CTU being partitioned into Coding Blocks (CB). That is, in ITU-T H.265, a CTU may be partitioned into quadtree leaf nodes. According to ITU-T H.265, one luma CB together with two corresponding chroma CBs and associated syntax elements are referred to as a coding unit (CU). In ITU-T H.265, a minimum allowed size of a CB may be signaled. In ITU-T H.265, the smallest minimum allowed size of a luma CB is 8×8 luma samples. In ITU-T H.265, the decision to code a picture area using intra prediction or inter prediction is made at the CU level.

In ITU-T H.265, a CU is associated with a prediction unit (PU) structure having its root at the CU. In ITU-T H.265, PU structures allow luma and chroma CBs to be split for purposes of generating corresponding reference samples. That is, in ITU-T H.265, luma and chroma CBs may be split into respective luma and chroma prediction blocks (PBs), where a PB includes a block of sample values for which the same prediction is applied. In ITU-T H.265, a CB may be partitioned into 1, 2, or 4 PBs. ITU-T H.265 supports PB sizes from 64×64 samples down to 4×4 samples. In ITU-T H.265, square PBs are supported for intra prediction, where a CB may form the PB or the CB may be split into four square PBs. In ITU-T H.265, in addition to the square PBs, rectangular PBs are supported for inter prediction, where a CB may by halved vertically or horizontally to form PBs. Further, it should be noted that in ITU-T H.265, for inter prediction, four asymmetric PB partitions are supported, where the CB is partitioned into two PBs at one quarter of the height (at the top or the bottom) or width (at the left or the right) of the CB. Intra prediction data (e.g., intra prediction mode syntax elements) or inter prediction data (e.g., motion data syntax elements) corresponding to a PB is used to produce reference and/or predicted sample values for the PB.

JEM specifies a CTU having a maximum size of 256×256 luma samples. JEM specifies a quadtree plus binary tree (QTBT) block structure. In JEM, the QTBT structure enables quadtree leaf nodes to be further partitioned by a binary tree (BT) structure. That is, in JEM, the binary tree structure enables quadtree leaf nodes to be recursively divided vertically or horizontally. In JVET-N1001 and JVET-O2001, CTUs are partitioned according a quadtree plus multi-type tree (QTMT or QT+MTT) structure. The QTMT in JVET-N1001 and JVET-O2001 is similar to the QTBT in JEM. However, in JVET-N1001 and JVET-O2001, in addition to indicating binary splits, the multi-type tree may indicate so-called ternary (or triple tree (T)) splits. A ternary split divides a block vertically or horizontally into three blocks. In the case of a vertical TT split, a block is divided at one quarter of its width from the left edge and at one quarter its width from the right edge and in the case of a horizontal TT split a block is at one quarter of its height from the top edge and at one quarter of its height from the bottom edge. Referring again to FIG. 1, FIG. 1 illustrates an example of a CTU being partitioned into quadtree leaf nodes and quadtree leaf nodes being further partitioned according to a BT split or a TT split. That is, in FIG. 1 dashed lines indicate additional binary and ternary splits in a quadtree.

As described above, each video frame or picture may divided into one or more regions. For example, according to ITU-T H.265, each video frame or picture may be partitioned to include one or more slices and further partitioned to include one or more tiles, where each slice includes a sequence of CTUs (e.g., in raster scan order) and where a tile is a sequence of CTUs corresponding to a rectangular area of a picture. It should be noted that a slice, in ITU-T H.265, is a sequence of one or more slice segments starting with an independent slice segment and containing all subsequent dependent slice segments (if any) that precede the next independent slice segment (if any). A slice segment, like a slice, is a sequence of CTUs. Thus, in some cases, the terms slice and slice segment may be used interchangeably to indicate a sequence of CTUs arranged in a raster scan order. Further, it should be noted that in ITU-T H.265, a tile may consist of CTUs contained in more than one slice and a slice may consist of CTUs contained in more than one tile. However, ITU-T H.265 provides that one or both of the following conditions shall be fulfilled: (1) All CTUs in a slice belong to the same tile; and (2) All CTUs in a tile belong to the same slice.

For intra prediction coding, an intra prediction mode may specify the location of reference samples within a picture. In ITU-T H.265, defined possible intra prediction modes include a planar (i.e., surface fitting) prediction mode, a DC (i.e., flat overall averaging) prediction mode, and 33 angular prediction modes (predMode: 2-34). In JEM, defined possible intra-prediction modes include a planar prediction mode, a DC prediction mode, and 65 angular prediction modes. It should be noted that planar and DC prediction modes may be referred to as non-directional prediction modes and that angular prediction modes may be referred to as directional prediction modes. It should be noted that the techniques described herein may be generally applicable regardless of the number of defined possible prediction modes.

For inter prediction coding, a reference picture is determined and a motion vector (MV) identifies samples in the reference picture that are used to generate a prediction for a current video block. For example, a current video block may be predicted using reference sample values located in one or more previously coded picture(s) and a motion vector is used to indicate the location of the reference block relative to the current video block. A motion vector may describe, for example, a horizontal displacement component of the motion vector (i.e., MVₓ), a vertical displacement component of the motion vector (i.e., MV_{y}), and a resolution for the motion vector (e.g., one-quarter pixel precision, one-half pixel precision, one-pixel precision, two-pixel precision, four-pixel precision). Previously decoded pictures, which may include pictures output before or after a current picture, may be organized into one or more to reference pictures lists and identified using a reference picture index value. Further, in inter prediction coding, uni-prediction refers to generating a prediction using sample values from a single reference picture and bi-prediction refers to generating a prediction using respective sample values from two reference pictures. That is, in uni-prediction, a single reference picture and corresponding motion vector are used to generate a prediction for a current video block and in bi-prediction, a first reference picture and corresponding first motion vector and a second reference picture and corresponding second motion vector are used to generate a prediction for a current video block. In bi-prediction, respective sample values are combined (e.g., added, rounded, and clipped, or averaged according to weights) to generate a prediction. Pictures and regions thereof may be classified based on which types of prediction modes may be utilized for encoding video blocks thereof. That is, for regions having a B type (e.g., a B slice), bi-prediction, uni-prediction, and intra prediction modes may be utilized, for regions having a P type (e.g., a P slice), uni-prediction, and intra prediction modes may be utilized, and for regions having an I type (e.g., an I slice), only intra prediction modes may be utilized. As described above, reference pictures are identified through reference indices. For example, for a P slice, there may be a single reference picture list, RefPicList0 and for a B slice, there may be a second independent reference picture list, RefPicList1, in addition to RefPicList0. It should be noted that for uni-prediction in a B slice, one of RefPicList0 or RefPicList1 may be used to generate a prediction. Further, it should be noted that during the decoding process, at the onset of decoding a picture, reference picture list(s) are generated from previously decoded pictures stored in a decoded picture buffer (DPB).

Quantized transform coefficients and syntax elements (e.g., syntax elements indicating a coding structure for a video block) may be entropy coded according to an entropy coding technique. An entropy coding process includes coding values of syntax elements using lossless data compression algorithms. Examples of entropy coding techniques include content adaptive variable length coding (CAVLC), context adaptive binary arithmetic coding (CABAC), probability interval partitioning entropy coding (PIPE), and the like. Entropy encoded quantized transform coefficients and corresponding entropy encoded syntax elements may form a compliant bitstream that can be used to reproduce video data at a video decoder. An entropy coding process, for example, CABAC, may include performing a binarization on syntax elements. Binarization refers to the process of converting a value of a syntax element into a series of one or more bits. These bits may be referred to as “bins.” Binarization may include one or a combination of the following coding techniques: fixed length coding, unary coding, truncated unary coding, truncated Rice coding, Golomb coding, k-th order exponential Golomb coding, and Golomb-Rice coding. For example, binarization may include representing the integer value of 5 for a syntax element as 00000101 using an 8-bit fixed length binarization technique or representing the integer value of 5 as 11110 using a unary coding binarization technique. As used herein, each of the terms fixed length coding, unary coding, truncated unary coding, truncated Rice coding, Golomb coding, k-th order exponential Golomb coding, and Golomb-Rice coding may refer to general implementations of these techniques and/or more specific implementations of these coding techniques. For example, a Golomb-Rice coding implementation may be specifically defined according to a video coding standard. In the example of CABAC, for a particular bin, a context provides a most probable state (MPS) value for the bin (i.e., an MPS for a bin is one of 0 or 1) and a probability value of the bin being the MPS or the least probably state (LPS). For example, a context may indicate, that the MPS of a bin is 0 and the probability of the bin being 1 is 0.3. It should be noted that a context may be determined based on values of previously coded bins including bins in the current syntax element and/or previously coded syntax elements. For example, values of syntax elements associated with neighboring video blocks may be used to determine a context for a current bin.

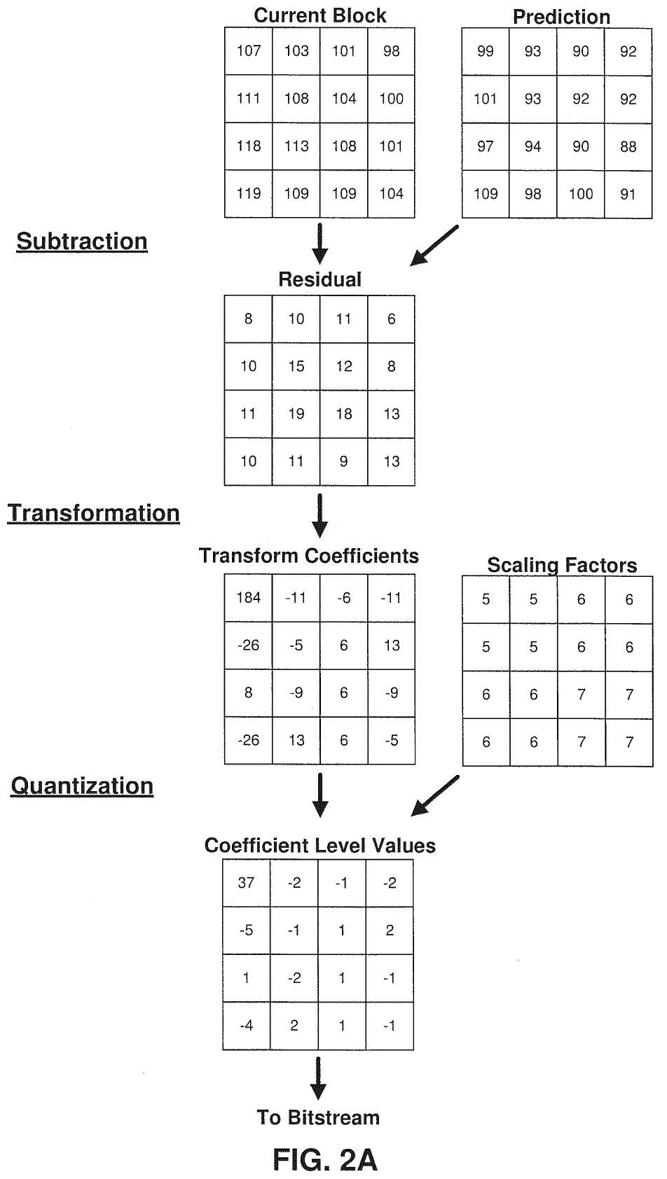

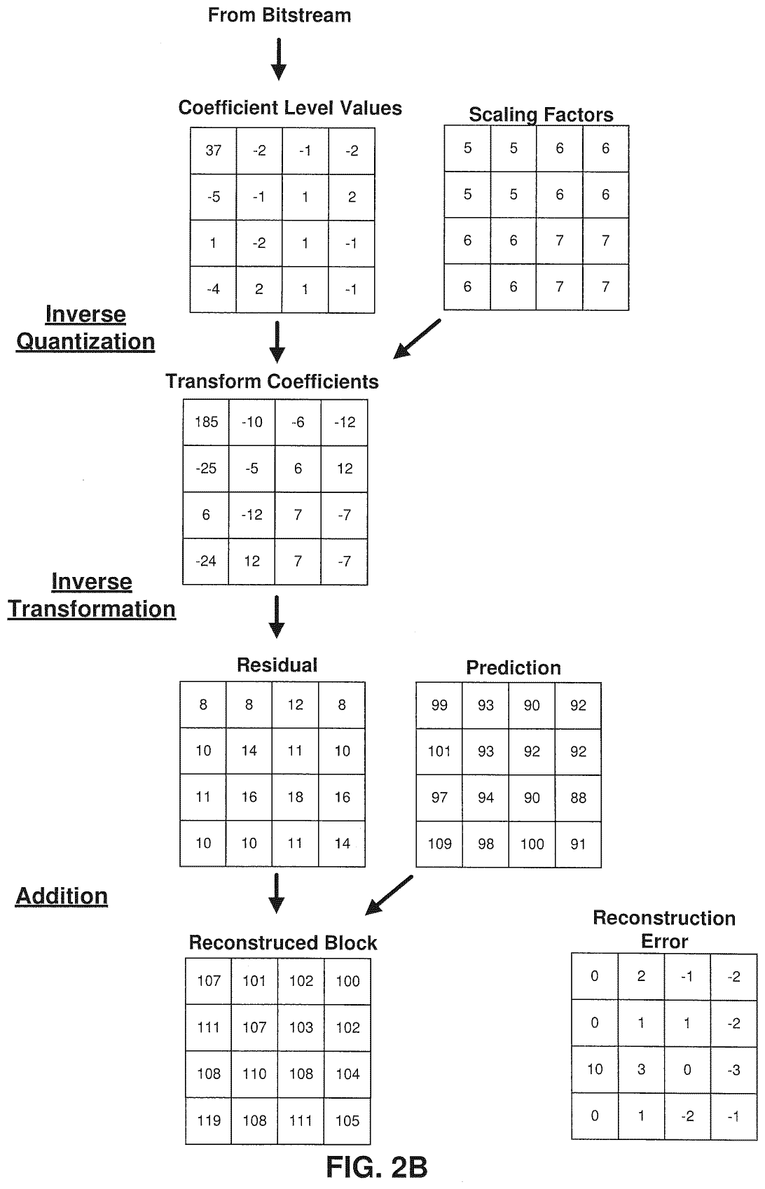

As described above, with respect to the examples illustrated in FIGS. 2A-2B, the sample values of a reconstructed block may differ from the sample values of the current video block that is encoded. Further, it should be noted that in some cases, coding video data on a block-by-block basis may result in artifacts (e.g., so-called blocking artifacts, banding artifacts, etc.) For example, blocking artifacts may cause coding block boundaries of reconstructed video data to be visually perceptible to a user. In this manner, reconstructed sample values may be modified to minimize the difference between the sample values of the current video block that is encoded and the reconstructed block and/or minimize artifacts introduced by the video coding process. Such modifications may general be referred to as filtering. It should be noted that filtering may occur as part of an in-loop filtering process or a post-loop filtering process. For an in-loop filtering process, the resulting sample values of a filtering process may be used for predictive video blocks (e.g., stored to a reference frame buffer for subsequent encoding at video encoder and subsequent decoding at a video decoder). For a post-loop filtering process the resulting sample values of a filtering process are merely output as part of the decoding process (e.g., not used for subsequent coding). For example, in the case of a video decoder, for an in-loop filtering process, the sample values resulting from filtering the reconstructed block would be used for subsequent decoding (e.g., stored to a reference buffer) and would be output (e.g., to a display). For a post-loop filtering process, the reconstructed block would be used for subsequent decoding and the sample values resulting from filtering the reconstructed block would be output.

Deblocking (or de-blocking), deblock filtering, or applying a deblocking filter refers to the process of smoothing the boundaries of neighboring reconstructed video blocks (i.e., making boundaries less perceptible to a viewer). Smoothing the boundaries of neighboring reconstructed video blocks may include modifying sample values included in rows or columns adjacent to a boundary. ITU-T H.265 provides where a deblocking filter is applied to reconstructed sample values as part of an in-loop filtering process. ITU-T H.265 includes two types deblocking filters that may be used for modifying luma samples: a Strong Filter which modifies sample values in the three adjacent rows or columns to a boundary and a Weak Filter which modifies sample values in the immediately adjacent row or column to a boundary and conditionally modifies sample values in the second row or column from the boundary. Further, ITU-T H.265 includes one type of filter that may be used for modifying chroma samples: Normal Filter.

In addition to applying a deblocking filter as part of an in-loop filtering process, ITU-T H.265 provides where Sample Adaptive Offset (SAO) filtering may be applied in the in-loop filtering process. In ITU-T H.265, SAO is a process that modifies the deblocked sample values in a region by conditionally adding an offset value. ITU-T H.265 provides two types of SAO filters that may be applied to a CTB: band offset or edge offset. For each of band offset and edge offset, four offset values are included in a bitstream. For band offset, the offset which is applied depends on the amplitude of a sample value (e.g., amplitudes are mapped to bands which are mapped to the four signaled offsets). For edge offset, the offset which is applied depends on a CTB having one of a horizontal, vertical, first diagonal, or second diagonal edge classification (e.g., classifications are mapped to the four signaled offsets).

Another type of filtering process includes the so-called adaptive loop filter (ALF). An ALF with block-based adaption is specified in JEM. In JEM, the ALF is applied after the SAO filter. It should be noted that an ALF may be applied to reconstructed samples independently of other filtering techniques. The process for applying the ALF specified in JEM at a video encoder may be summarized as follows: (1) each 2×2 block of the luma component for a reconstructed picture is classified according to a classification index; (2) sets of filter coefficients are derived for each classification index; (3) filtering decisions are determined for the luma component; (4) a filtering decision is determined for the chroma components; and (5) filter parameters (e.g., coefficients and decisions) are signaled.

According to the ALF specified in JEM, each 2×2 block is categorized according to a classification index C, where C is an integer in the inclusive range of 0 to 24. C is derived based on its directionality D and a quantized value of activity Å, according to the following equation:

$$C = 5 D + \tilde{A}$$

where D and Å, gradients of the horizontal, vertical and two diagonal direction are calculated sting a 1-D Laplacian as follows:

$$\text{?} = {{\sum }_{\text{?}}}^{\text{?}} {{\sum }_{\text{?}}}^{\text{?}} V \text{?} , V \text{?} = \vert 2 R ( k , \text{?} ) - R ( k , l - 1 ) - R ( k , \text{?} + 1 ) \vert ,$$

$$\text{?} = {{\sum }_{\text{?}}}^{\text{?}} {{\sum }_{\text{?}}}^{\text{?}} H \text{?} , H \text{?} = \vert 2 R ( k , \text{?} ) - R ( k - 1 , \text{?} ) - R ( k + 1 , \text{?} ) \vert ,$$

$$\text{?} = {{\sum }_{\text{?}}}^{\text{?}} {{\sum }_{\text{?}}}^{\text{?}} D 1 \text{?} , D 1 \text{?} = \vert 2 R ( k , \text{?} ) - R ( k - 1 , l - 1 ) - R ( K + 1 , \text{?} + 1 ) \vert$$

$$\text{?} = {{\sum }_{\text{?}}}^{\text{?}} {{\sum }_{\text{?}}}^{\text{?}} D 2 \text{?} , D \text{?} = \vert 2 R ( k , \text{?} ) - R ( k - 1 , l + 1 ) - R ( K + 1 , \text{?} - 1 ) \vert$$

$$\text{?} \text{indicates text missing or illegible when filed}$$

where, indices l and j refer to the coordinates of the upper left sample in the 2×2 block and R(l,j) indicates a reconstructed sample at coordinate (i,j). [symbol] [symbol]
Step 1.
Step 2.
Step 3.
Step 4.

In [symbol] , the activity value A is

[symbol]

$$A = {{\sum }_{\text{?}}}^{\text{?}} {{\sum }_{\text{?}}}^{\text{?}} ( {V}_{k , i} + \text{?} ) .$$

$$\text{?} \text{indicates text missing or illegible when filed}$$

where, A is further quantized to the range of 0 to 4, inclusively, and the quantized value is [symbol] as Å.

As described above, applying the ALF specified in JEM at a video encoder includes deriving sets of filter coefficients for each classification index and determining filtering decisions. It should be noted that the derivation of sets of filter coefficients and determination of filtering decisions may be an iterative process. That is, sets of filter coefficients may be updated based on filtering decisions and filtering decisions may be updated based on updated sets of filter coefficients and this may be repeated multiple times. Further, a video encoder may implement various proprietary algorithms to determine sets of filter coefficients and/or to determine filtering decisions. The techniques described herein are generally applicable regardless of how sets of filter coefficients are derived for each classification index and how filtering decisions are determined.

According to one example, sets of filter coefficients are derived by initially deriving a set of optimal filter coefficients for each classification index. Optimal filter coefficients are derived by comparing desired sample values (i.e., sample values in the source video) to reconstructed sample values subsequent to applying the filtering and by minimizing the sum of squared errors (SSE) between the desired sample values and the reconstructed sample values subsequent to performing the filtering. The derived optimal coefficients for each group may then be used to perform a basis filtering over the reconstructed samples in order to analyze the effectiveness of the ALF. That is, desired sample values, reconstructed sample values prior to applying the ALF, and reconstructed sample values subsequent to performing the ALF can be compared to determine the effectiveness of applying the ALF using the optimal coefficients.

According to the specified ALF in JEM, each reconstructed sample R(i,j) is filtered by determining the resulting in sample valve R′(i j) according to the following equation, wherein in the following equation below, L denotes filter length, and f(k,l) denotes the decoded filter coefficients.

$$\text{?} = {{\sum }_{\text{?}}}^{\text{?}} {{\sum }_{\text{?}}}^{\text{?}} f ( k , \text{?} ) \times R ( \text{?} + k , j + l )$$

$$\text{?} \text{indicates text missing or illegible when filed}$$

It should be noted that JEM defines three filter shapes (a 5×5 diamond, a 7×7 diamond, and a 9×9 diamond). It should be noted that in JEM, geometric transformations are applied to filter coefficients f(k,l) depending on gradient values: [symbol] as provided in Table 1.

TABLE 1

| Gradient values | Transformation |
|---|---|
| g_{d} [symbol] < g_{d1} and gₕ < gᵥ | No transformation |
| [symbol] < g_{d1} and g [symbol] < gₕ | Diagonal |
| g_{d} [symbol] < g_{d2} and g [symbol] < g [symbol] | Vertical flip |
| g_{d} [symbol] < g_{d2} and g [symbol] < g [symbol] | Rotation |

[symbol]

indicates data missing or illegible when filed

where the Diagonal, vertical flip, and Rotation are defined as follows:

$$Diagonal : {f}_{0} ( k , \text{?} ) = f ( \text{?} , k ) .$$

$$Vertical flip : {f}_{v} ( k , \text{?} ) = f ( k , K - l - 1 )$$

$$Rotation : f \text{?} ( k , \text{?} ) = f ( K - l - 1 , k )$$

$$\text{?} \text{indicates text missing or illegible when filed}$$

where K is the size of the filter and 0≤k, 1≤K−1 are coefficients coordinates, such that location (0,0) is at the upper left corner and location (K−1,K−1) is a the lower right corner.

JEM provides where up to 25 sets of luma filter coefficients can be signaled (i.e., one for each possible classification index). Thus, the optimal coefficients could be signaled for each classification index occurring in a corresponding picture region. However, in order to optimize the amount of data required to signal sets of luma filter coefficients versus the effectiveness of the filter, rate distortion (RD) optimizations may be performed. For example, JEM provides where sets of filter coefficients of neighboring classification groups may be merged and signaled using an array mapping a set of filter coefficients to each classification index. Further, JEM provides where temporal coefficient prediction may be used to signal coefficients. That is, JEM provides where sets of filter coefficients for a current picture may be predicted based on sets of filter coefficients of a reference picture by inheriting the set of filter coefficients used for a reference picture. JEM further provides where for intra prediction pictures, a set of 16 fixed filters may be available for predicting sets of filter coefficients. As described above, the derivation of sets of filter coefficients and determination of filtering decisions may be an iterative process. That is, for example, the shape of the ALF may be determined based on how many sets of filter coefficients are signaled and similarly, whether the ALF is applied to a region of a picture may be based on the sets of filter coefficients that are signaled and/or the shape of the filter. It should be noted that for the ALF filter each component uses a set of sample values from the respective component as input and derives output sample values. That is, an ALF filter is applied to each component independent of data in another component. Further, it should be noted that JVET-N1001 and JVET-O2001 specify deblocking, SAO, and ALF filters which can be described as being generally based on the deblocking, SAO, and ALF filters provided in ITU-T H.265 and JEM.

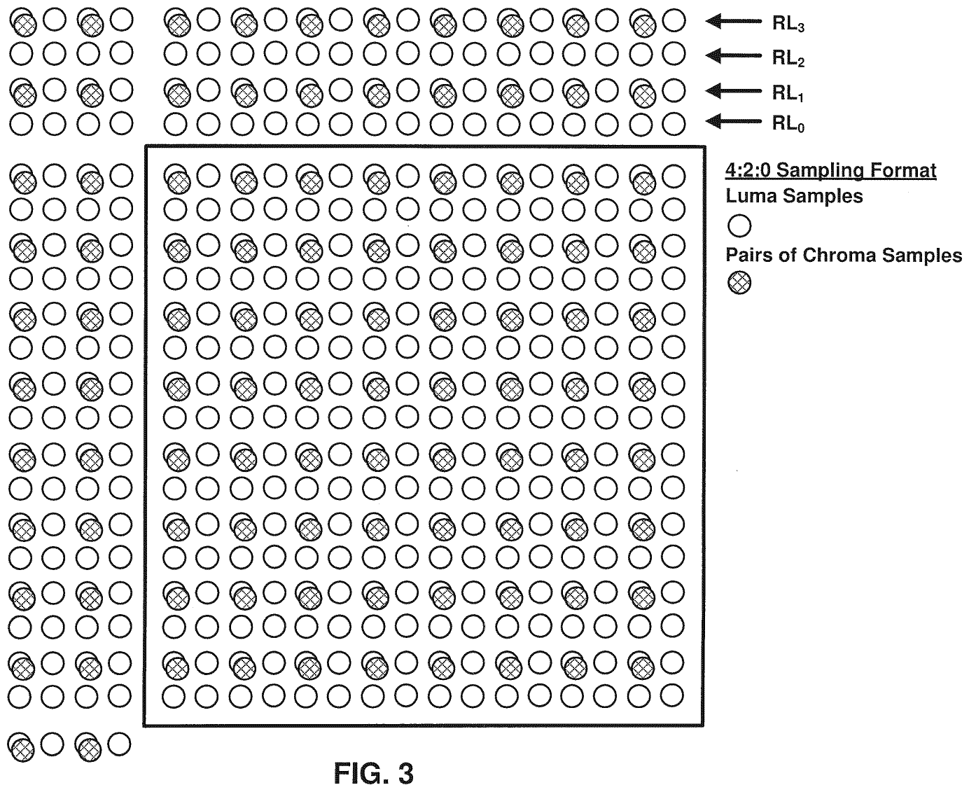

A video sampling format, which may also be referred to as a chroma format, may define the number of chroma samples included in a CU with respect to the number of luma samples included in a CU. For example, for the 4:2:0 sampling format, the sampling rate for the luma component is twice that of the chroma components for both the horizontal and vertical directions. As a result, for a CU formatted according to the 4:2:0 format, the width and height of an array of samples for the luma component are twice that of each array of samples for the chroma components. FIG. 3 is a conceptual diagram illustrating an example of a coding unit formatted according to a 4:2:0 sample format. FIG. 3 illustrates the relative position of chroma samples with respect to luma samples within a CU. As described above, a CU is typically defined according to the number of horizontal and vertical luma samples. Thus, as illustrated in FIG. 3, a 16×16 CU formatted according to the 4:2:0 sample format includes 16×16 samples of luma components and 8×8 samples for each chroma component. Further, in the example illustrated in FIG. 3, the relative position of chroma samples with respect to luma samples for video blocks neighboring the 16×16 CU are illustrated. For a CU formatted according to the 4:2:2 format, the width of an array of samples for the luma component is twice that of the width of an array of samples for each chroma component, but the height of the array of samples for the luma component is equal to the height of an array of samples for each chroma component. Further, for a CU formatted according to the 4:4:4 format, an array of samples for the luma component has the same width and height as an array of samples for each chroma component. Referring to FIG. 3, for luma samples, the line of samples immediately adjacent above the video block may be referred to as reference line 0 (RL₀) and the subsequent above lines of samples may to respectively referred to as reference line 1 (RL₁), reference line 2 (RL₂), and reference line 3 (RL₃). Similarly, columns of samples left of the current video block may be classified as references lines in a similar manner (i.e., the line of samples immediately adjacent left the video block may be referred to as reference line 0 (RL₀)).

With respect to the equations used herein, the following arithmetic operators may be used:
+ Addition
− Subtraction
* Multiplication, including matrix multiplication
x^{y} Exponentiation. Specifies x to the power of y. In other contexts, such notation is used for superscripting not intended for interpretation as exponentiation.
/ Integer division with truncation of the result toward or For example, 7/4 and −7/−4 are truncated to 1 and −7/4 and 7/−4 are truncated to −1.
+ Used to denote division in mathematical equations where no truncation or rounding is intended.

$$\frac{x}{y}$$

Used to denote division in mathematical equations where no truncation or rounding is intended.
x % y Modulus. Remainder or x divided by y, defined only for integers x and y with x>−0 and y>0.

Further, the following logical operators may be used:
x && y Boolean logical “and” of x and y
x∥y Boolean logical “or” of x and y
!Boo!can logical “no”
x?y:z If x is TRUE or not equal to 0, evaluates to the value; of y: otherwise, evaluates to the value of z.
   Further, the following relational operators may be used:
   > Greater than
   >= Greater than or equal to
   < Less than
   <= Less than or equal to
   == Equal to
   != Not equal to

Further, the following bit-wise operators may be used:
& Bit-wise “and”. When operating on integer arguments, operates on a twos complement representation of the integer value. When operating on a binary argument that contains fewer bits than another argument, the shorter argument is extended by adding more significant bits equal to 0,
   | Hit-wise “or”. When operating on integer arguments, operates on a two's complement representation of the integer value. When operating on a binary argument that contains fewer bits than another argument, the shorter argument is extended by adding more significant bits equal to 0.
\hat{ } Bit-wise “exclusive or”. When operating on integer arguments, operates on a two's complement representation of the integer value. When operating on a binary argument that contains fewer bits than another argument, the shorter argument is extended by adding more significant bits equal to 0.
x>>y Arithmetic right shift of a two's complement integer representation of x by y binary digits. This function is defined only for non-negative integer values of y. Bits shifted into the most significant bits (MSBs) as a result of the right shift have a value equal to the MSB of x prior to the shift operation.
x<<y Arithmetic left shift of a two's complement integer representation of x by y binary digits. This function is defined only for non-negative integer values of y. Bits shifted into the least significant bits (LSBs) as a result of the left shift have a value equal to 0.

Further, the following assignment operators may be used:
= Assignment operator
++ Increment, i.e., x++ is equivalent to x=x+1; when used in an array index, evaluates to the value of the variable prior to the increment operation.
−− Decrement. i.e., x−− is equivalent to x=x−1, when used in an array index, evaluates to the value of the variable prior to the decrement operation.
+= Increment by amount specified, i.e., x+=3 is equivalent to x=x+3, and x+−(−3) is equivalent to x=x+(−3).
−= Decrement by amount specified, i.e., x−=3 is equivalent to x=x−3, and x−=(−3) is equivalent to x=x−(−3)

Further, the following defined mathematical functions may be used:

$$Abs ( x ) = \{ \begin{matrix}x & ; & x >= 0 \\ - x & ; & x < 0\end{matrix}$$

Floor(x) the largest integer less than or equal to x.
Log 2(x) the base-2 logarithm of x.

$$Min ( x , y ) = \{ \begin{matrix}x & ; & x <= y \\ y & ; & x > y\end{matrix}$$

$$Max ( x , y ) = \{ \begin{matrix}x & ; & x >= y \\ y & ; & x < y\end{matrix}$$

$$Clip3 ( x , y , z ) = \{ \begin{matrix}x & ; & z < x \\ y & ; & z > y \\ z & ; & otherwise\end{matrix}$$

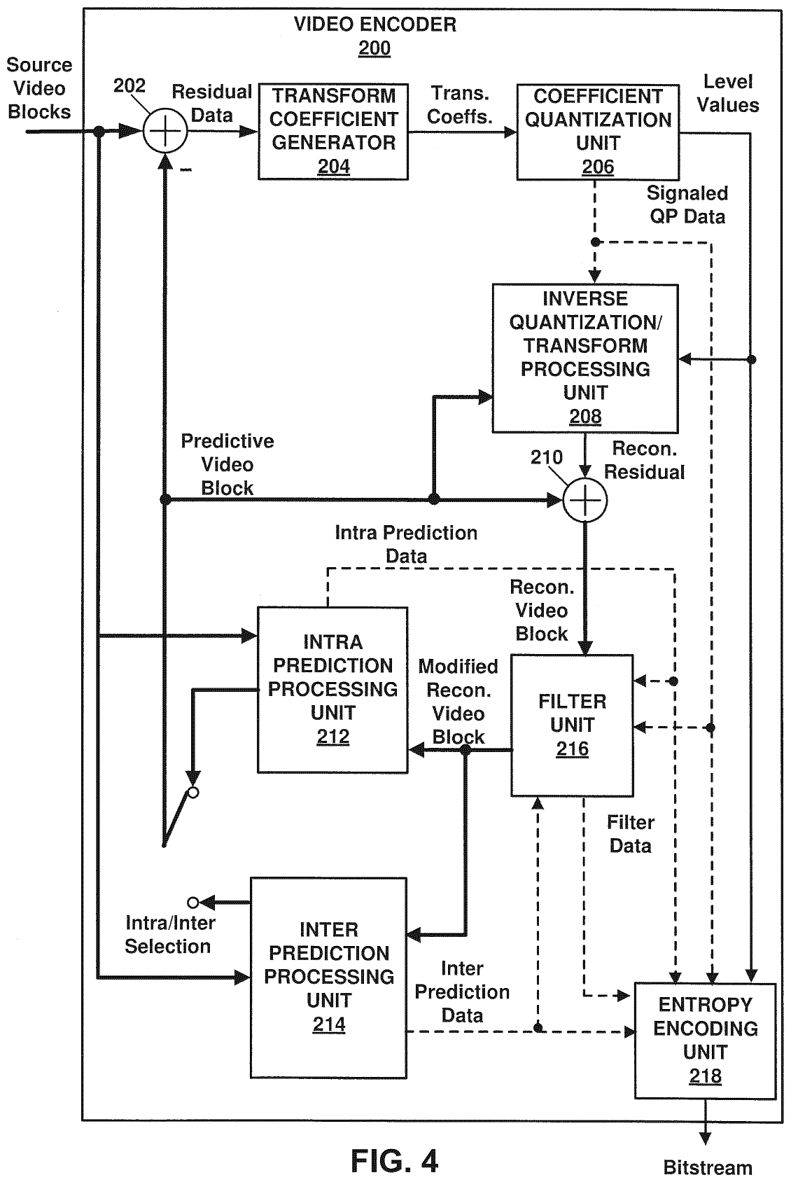

FIG. 4 is a block diagram illustrating an example of video encoder 200 that may implement the techniques for encoding video data described herein. It should be noted that although example video encoder 200 is illustrated as having distinct functional blocks, such an illustration is for descriptive purposes and does not limit video encoder 200 and/or sub-components thereof to a particular hardware or software architecture. Functions of video encoder 200 may be realized using any combination of hardware, firmware, and/or software implementations. In one example, video encoder 200 may be configured to encode video data according to the techniques described herein. Video encoder 200 may perform intra prediction coding and inter prediction coding of picture areas, and, as such, may be referred to as a hybrid video encoder. In the example illustrated in FIG. 4, video encoder 200 receives source video blocks. In some examples, source video blocks may include areas of picture that has been divided according to a coding structure. For example, source video data may include macroblocks, CTUs, CBs, sub-divisions thereof, and/or another equivalent coding unit. In some examples, video encoder 200 may be configured to perform additional sub-divisions of source video blocks. It should be noted that some techniques described herein may be generally applicable to video coding, regardless of how source video data is partitioned prior to and/or during encoding. In the example illustrated in FIG. 4, video encoder 200 includes summer 202, transform coefficient generator 204, coefficient quantization unit 206, inverse quantization/transform processing unit 208, summer 210, intra prediction processing unit 212, inter prediction processing unit 214, filter unit 216, and entropy encoding unit 218.

As illustrated in FIG. 4, video encoder 200 receives source video blocks and outputs a bitstream. Video encoder 200 may generate residual data by subtracting a predictive video block from a source video block. Summer 202 represents a component configured to perform this subtraction operation. In one example, the subtraction of video blocks occurs in the pixel domain. Transform coefficient generator 204 applies a transform, such as a discrete cosine transform (DCT), a discrete sine transform (DST), or a conceptually similar transform, to the residual block or sub-divisions thereof (e.g., four 8×8 transforms may be applied to a 16×16 array of residual values) to produce a set of residual transform coefficients. Transform coefficient generator 204 may be configured to perform any and all combinations of the transforms included in the family of discrete trigonometric transforms. As described above, in ITU-T H.265, TBs are restricted to the following sizes 4×4, 8×8, 16×16, and 32×32. In one example, transform coefficient generator 204 may be configured to perform transformations according to arrays having sizes of 4×4, 8×8, 16×16, and 32×32. In one example, transform coefficient generator 204 may be further configured to perform transformations according to arrays having other dimensions. In particular, in some cases, it may be useful to perform transformations on rectangular arrays of difference values. In one example, transform coefficient generator 204 may be configured to perform transformations according to the following sizes of arrays: 2×2, 2×4N, 4M×2, and/or 4M×4N. In one example, a 2-dimensional (2D) M×N inverse transform may be implemented as 1-dimensional (1D) M-point inverse transform followed by a 1D N-point inverse transform. In one example, a 2D inverse transform may be implemented as a 1D N-point vertical transform followed by a 1D N-point horizontal transform. In one example, a 2D inverse transform may be implemented as a 1D N-point horizontal transform followed by a 1D N-point vertical transform. Transform coefficient generator 204 may output transform coefficients to coefficient quantization unit 206.

Coefficient quantization unit 206 may be configured to perform quantization of the transform coefficients. As described above, the degree of quantization may be modified by adjusting a quantization parameter. Coefficient quantization unit 206 may be further configured to determine quantization parameters and output QP data (e.g., data used to determine a quantization group size and/or delta QP values) that may be used by a video decoder to reconstruct a quantization parameter to perform inverse quantization during video decoding. It should be noted that in other examples, one or more additional or alternative parameters may be used to determine a level of quantization (e.g., scaling factors). The techniques described herein may be generally applicable to determining a level of quantization for transform coefficients corresponding to a component of video data based on a level of quantization for transform coefficients corresponding another component of video data.

Referring again to FIG. 4, quantized transform coefficients are output to inverse quantization/transform processing unit 208. Inverse quantization/transform processing unit 208 may be configured to apply an inverse quantization and an inverse transformation to generate reconstructed residual data. As illustrated in FIG. 4, at summer 210, reconstructed residual data may be added to a predictive video block. In this manner, an encoded video block may be reconstructed and the resulting reconstructed video block may be used to evaluate the encoding quality for a given prediction, transformation, and/or quantization. Video encoder 200 may be configured to perform multiple coding passes (e.g., perform encoding while varying one or more of a prediction, transformation parameters, and quantization parameters). The rate-distortion of a bitstream or other system parameters may be optimized based on evaluation of reconstructed video blocks. Further, reconstructed video blocks may be stored and used as reference for predicting subsequent blocks.

As described above, a video block may be coded using an intra prediction. Intra prediction processing unit 212 may be configured to select an intra prediction mode for a video block to be coded. Intra prediction processing unit 212 may be configured to evaluate a frame and/or an area thereof and determine an intra prediction mode to use to encode a current block. As illustrated in FIG. 4, intra prediction processing unit 212 outputs intra prediction data (e.g., syntax elements) to entropy encoding unit 218 and transform coefficient generator 204. As described above, a transform performed on residual data may be mode dependent. As described above, possible intra prediction modes may include planar prediction modes, DC prediction modes, and angular prediction modes. Further, in some examples, a prediction for a chroma component may be inferred from an intra prediction for a luma prediction mode. Inter prediction processing unit 214 may be configured to perform inter prediction coding for a current video block. Inter prediction processing unit 214 may be configured to receive source video blocks and calculate a motion vector for PUs of a video block. A motion vector may indicate the displacement of a PU (or similar coding structure) of a video block within a current video frame relative to a predictive block within a reference frame. Inter prediction coding may use one or more reference pictures. Further, motion prediction may be uni-predictive (use one motion vector) or bi-predictive (use two motion vectors). Inter prediction processing unit 214 may be configured to select a predictive block by calculating a pixel difference determined by, for example, sum of absolute difference (SAD), sum of square difference (SSD), or other difference metrics. As described above, a motion vector may be determined and specified according to motion vector prediction. Inter prediction processing unit 214 may be configured to perform motion vector prediction, as described above. Inter prediction processing unit 214 may be configured to generate a predictive block using the motion prediction data. For example, inter prediction processing unit 214 may locate a predictive video block within a frame buffer (not shown in FIG. 4). It should be noted that inter prediction processing unit 214 may further be configured to apply one or more interpolation filters to a reconstructed residual block to calculate sub-integer pixel values for use in motion estimation. Inter prediction processing unit 214 may output motion prediction data for a calculated motion vector to entropy encoding unit 218. As illustrated in FIG. 4, inter prediction processing unit 214 may receive reconstructed video block via filter unit 216. Entropy encoding unit 218 receives quantized transform coefficients and predictive syntax data (i.e., intra prediction data, motion prediction data, QP data, etc.). It should be noted that in some examples, coefficient quantization unit 206 may perform a scan of a matrix including quantized transform coefficients before the coefficients are output to entropy encoding unit 218. In other examples, entropy encoding unit 218 may perform a scan. Entropy encoding unit 218 may be configured to perform entropy encoding according to one or more of the techniques described herein. Entropy encoding unit 218 may be configured to output a compliant bitstream, i.e., a bitstream that a video decoder can receive and reproduce video data therefrom.

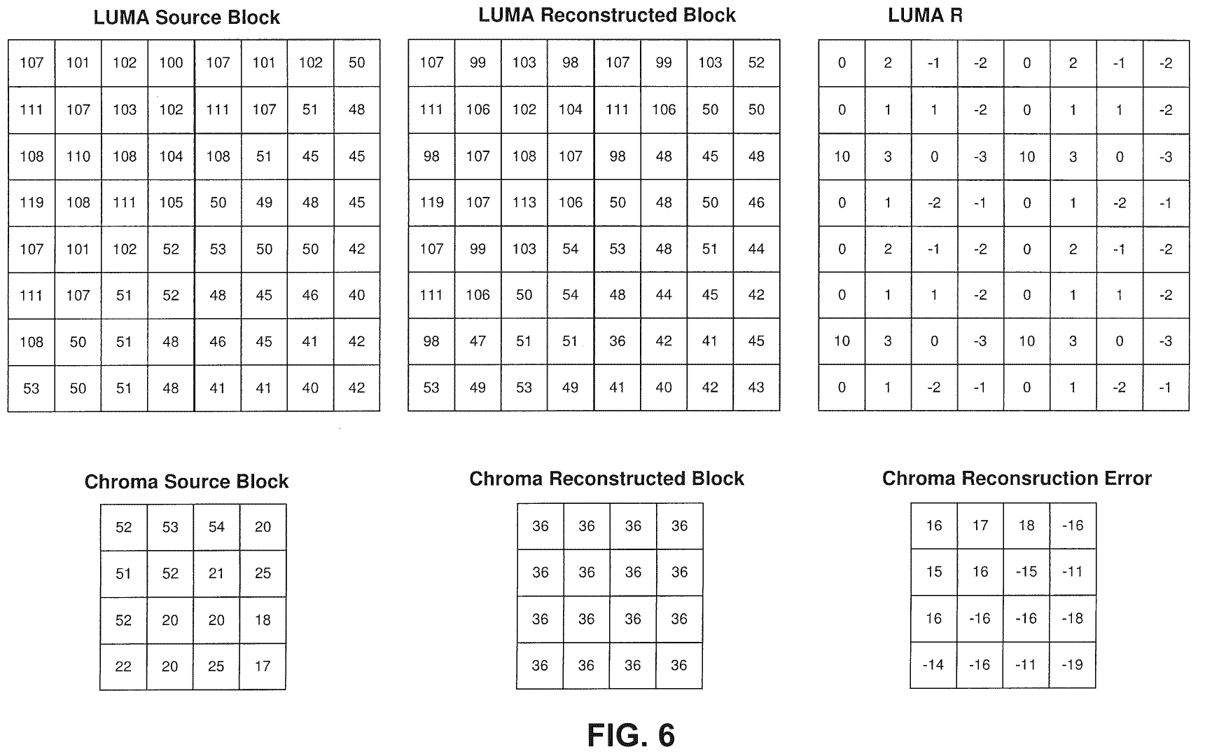

Referring again to FIG. 4, filter unit 216 may be configured to perform deblocking, Sample Adaptive Offset (SAO) filtering and/or ALF filtering as described above. Further, filter unit 216 may be configured to perform one or more the techniques described herein for reducing a reconstruction error according to cross-component correlation. As described above, for the ALF filter in JEM, each component uses a set of sample values from the respective component as input and derives output sample values in a manner that is independent of the other components. Filtering independently on a component-by-component basis may be less than ideal, as there may be correlations between components and/or channels of video data that may be useful for minimizing a reconstruction error. For example, referring to FIG. 6, FIG. 6 illustrates an example of an 8×8 luma source block and a corresponding 4×4 chroma source block (i.e., according to a 4:2:0 sampling format) and corresponding reconstructed blocks and reconstruction errors. As illustrated in FIG. 6, both of the source blocks include an edge about the diagonal, which would be typical in a case of a texture, a shape edge, or the like. However, for the reconstructed chroma component the fidelity is lost (e.g., due to a high level of quantization, etc.) compared to the luma component and the edge is not recovered.

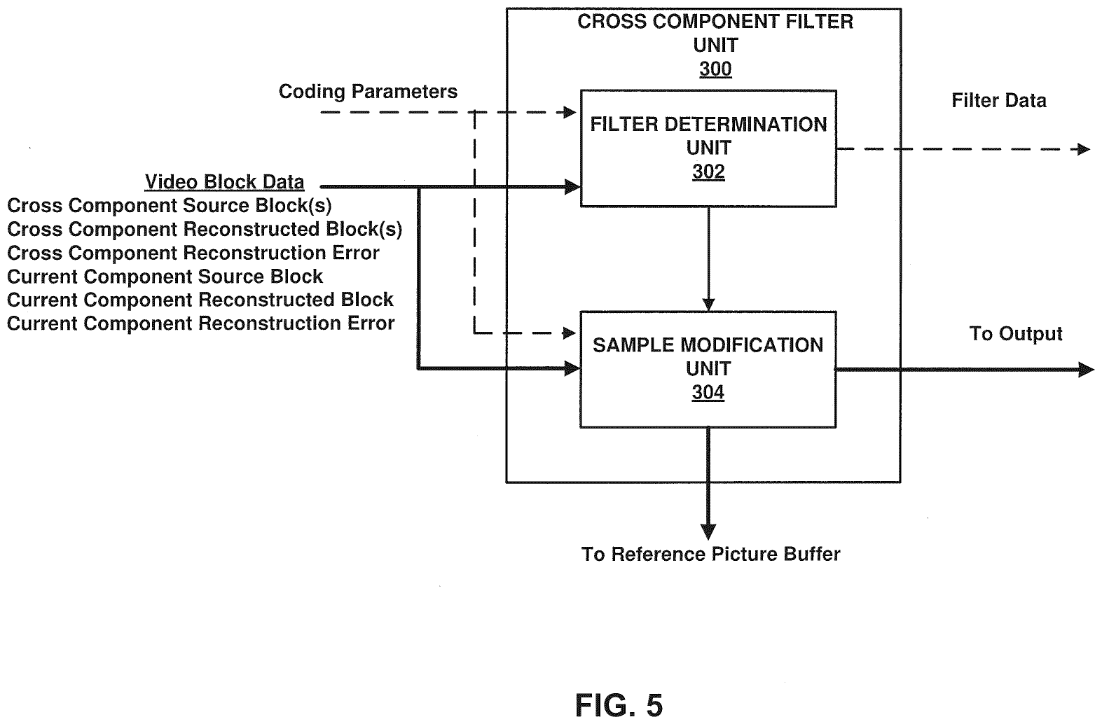

According to the techniques herein, a filter unit may be configured to predict and/or refine information in a first color channel and/or component from information in a second color channel and/or component, which may provide improved coding efficiency of the first color channel and/or component, as the fidelity of the color channel and/or component is increased with a small number of bits. FIG. 5 illustrates an example of a cross component filter unit that may be configured to encode video data according to one or more techniques of this disclosure. As illustrated in FIG. 5, cross component filter unit 300 includes filter determination unit 302 and sample modification unit 304. It should be noted that cross component filter unit 300 illustrates an example of a cross component filter unit that may be present in a video encoder. Examples of corresponding cross component filter units that may be present in a video decoder are described in further detail below. As illustrated in FIG. 5, filter determination unit 302 and sample modification unit 304 may receive coding parameter information (e.g., an intra prediction mode) available at the time a current block is encoded/decoded and video block data which, as illustrated in FIG. 5, at a video encoder, may include: Cross Component Source Block(s); Cross Component Reconstructed Block(s); Cross Component Reconstruction Error; Current Component Source Block; Current Component Reconstructed Block; and Current Component Reconstruction Error. That is, referring to the example illustrated in FIG. 6, when the chroma reconstructed block is to be filtered, all of the information in FIG. 6 may be available at cross component filter unit 300. As such, filter determination unit 302 may derive a filter to be used on the chroma reconstructed block based on the video data and sample modification unit 304 may perform filtering according to the derived filter. As illustrated in FIG. 5, sample modification unit 304 may output the modified reconstructed block to the reference picture buffer (i.e., as an in-loop filter) and output the modified reconstructed block to an output (e.g., a display). Further, as illustrated in FIG. 5, filter determination unit 302 may output filter data. That is, filter data specifying a derived filter may be signaled to a video decoder. Examples of such signaling are described in further detail below. It should be noted that with respect to FIG. 6, that there may be several ways of reducing a reconstruction error at a video encoder, e.g., reducing quantization and/or performing an improved prediction technique. Further, in some cases, it may be possible for a video encoder to signal the reconstruction error directly. However, cross component filtering according to the techniques herein provides a way to reduce a reconstruction error while signaling a relatively small amount of information. That is, for example, the cross component filtering techniques described herein may provide a way to reduce a reconstruction error at a video decoder while being more efficient that other techniques for reducing a reconstruction error. For example, it may take fewer bits to signal filter data than to signal higher fidelity residual information for a component.

Thus, cross component filter unit 300 may operate by taking a first color component and one or more second color components as input and provide an enhanced, first color component as output. It should be noted that although the examples herein are described with respect to luma, Cb and Cr components, the techniques described herein are generally applicable to other video formats (e.g., RGB) and other types of video information such as infra-red, depth, disparity or other characteristics.

The following equation provides an example of model of a filter that takes an input sample values from multiple components and outputs a filtered sample value fᵢ(x,y) and thus, in one example, cross component filter unit 300 may implement a filter process based on the equation.

$${f}_{i} ( x , y ) = {\sum }_{( {x}_{0} , {y}_{0} ) ∈ {S}_{i , 0}} {I}_{0} ( g ( x , y , i , 0 ) + {x}_{0} , h ( x , y , i , 0 ) + {y}_{0} ) {c}_{0} ( {x}_{0} , {y}_{0} ) + {\sum }_{( {x}_{1} , {y}_{1} ) ∈ {S}_{i , 1}} {I}_{1} ( g ( x , y , i , 1 ) + {x}_{1} , h ( x , y , i , 1 ) + {y}_{1} ) {c}_{1} ( {x}_{1} , {y}_{1} ) + {\sum }_{( {x}_{2} , {y}_{2} ) ∈ {S}_{i , 2}} {I}_{2} ( g ( x , y , i , 2 ) + {x}_{2} , h ( x , y , i , 2 ) + {y}_{2} ) {c}_{2} ( {x}_{2} , {y}_{2} )$$

Where, [symbol] [symbol]
is an output of component i at sample location (x,y);
[symbol] Defines a set of sample value locations relative to as origin in the respective component 0, 1, 2;
[symbol] Determine the original of support based on x, y, i and input component. The function, [symbol] may further depend on chroma format, [symbol]
[symbol] Are filler coefficient values for support region for each component;
[symbol] Are input sample values from each component; and
[symbol] is a Sample value of component i in sample location (x,y) prior to filtering.

In one example, according to the techniques herein, the application of cross component filtering may be based on the properties of samples included in a filter support region. For example, in one example, the luma sample values in a support region may be analyzed and whether cross component filtering is applied may be based on the analysis. For example, in one example, variance and/or deviation of samples in a support region may be computed and if the variance and/or deviation has certain characteristics, e.g., the region is smooth (i.e., the variance is less than a threshold), then no cross component filtering may be applied for the region. In one example, the cross component filter selection (including whether a filter is applied and when a filter is applied, which filter is applied) may be based on a luma classification filter index of a luma sample corresponding to the chroma sample being evaluated. In one example, the classification filter index for a luma sample may be derived as described in JVET-O2001. In one example, no cross component filtering may be applied for when a luma classification filter index is determined to be in a subset of luma classification filer indices. As described in further detail below, values of local region control flags and/or syntax elements may be used to indicate/determine whether cross-component filtering is applied for a region and if cross-component filtering is applied for a region, which cross-component filter is applied. In one example, the application of cross component filtering may be based on properties of samples included in a filter support region and/or values of local region control flags and/or syntax elements. That is, for example, how luma support samples are analyzed may be based on a local region control flag and/or syntax elements (e.g., if flag=0, compute/evaluate variance, otherwise, compute/evaluate luma classification filter index). Further, in one example, filter selection be based on values of syntax elements and properties of luma support samples. For example, a value of 0 for a syntax element may indicate cross component filtering is not applied for a region, a value of 1 for the syntax element and the variance of luma support being greater than a threshold may indicate a filter having a first filter coefficient set is applied, a value of 1 for the syntax element and the variance of luma support not being greater than a threshold may indicate a filter having a second filter coefficient set is applied, a value of 2 for the syntax element and the variance of luma support being greater than a threshold may indicate a filter having a third filter coefficient set is applied, a value of 2 for the syntax element and the variance of luma support not being greater than a threshold may indicate a filter having a fourth filter coefficient set is applied, etc.

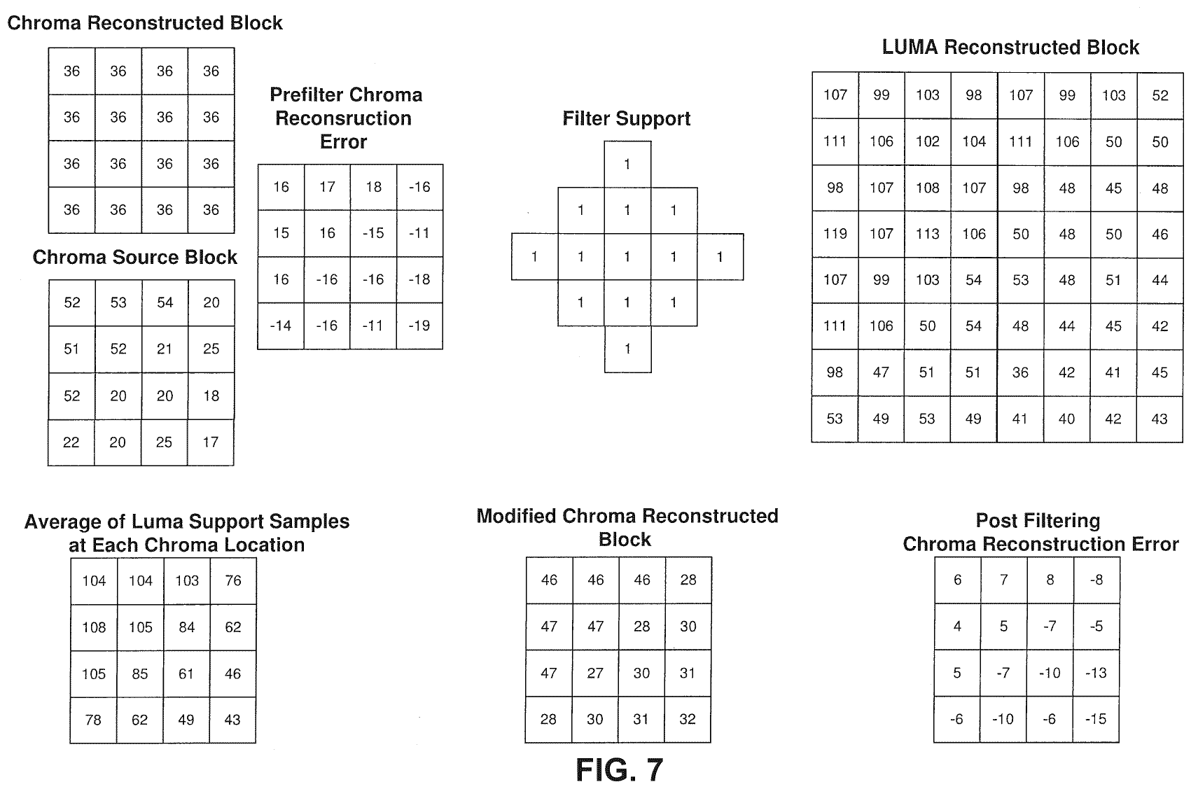

As described above, cross component filter unit 300 may generally operate by taking a first and one or more second color components as input and provide an enhanced first color component as output. That is, a filtering process performed by cross component filter unit 300 may take as input luma sample values which may be used to predict the difference between original respective chroma sample value and output refined chroma sample values based on the prediction. Referring again to the example illustrated in FIG. 6, FIG. 7 is conceptual diagram illustrating an example of reducing a reconstruction error using cross component filtering accordance with one or more techniques of this disclosure. FIG. 7 provides an example where a reconstruction error is reduced by taking the average of support samples and if the average is greater than 90, the average divided by 10 is added to the reconstructed sample; and if the average is not greater than 90, the average divided by 10 is subtracted from the reconstructed sample. That is, in the example, the prediction filter is generally described as: if support average is greater than threshold1, add weight1 multiplied by support average; else add weight2 multiplied by support average. As illustrated in the example illustrated in FIG. 7, the post filtering chroma reconstruction error provides reconstruction error reduction. Thus, according to the techniques herein, cross component filtering may reduce a reconstruction error according to a cross component filter defined according to logical functions, thresholds, weights, and the like.

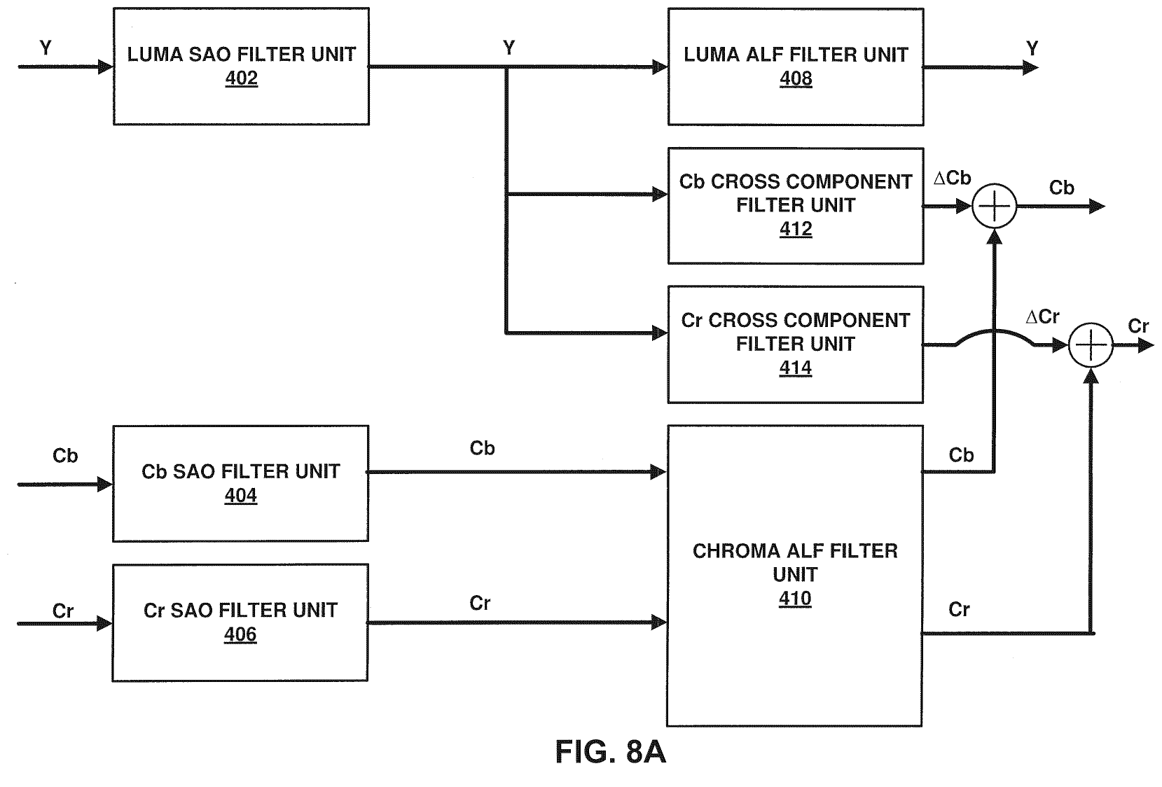

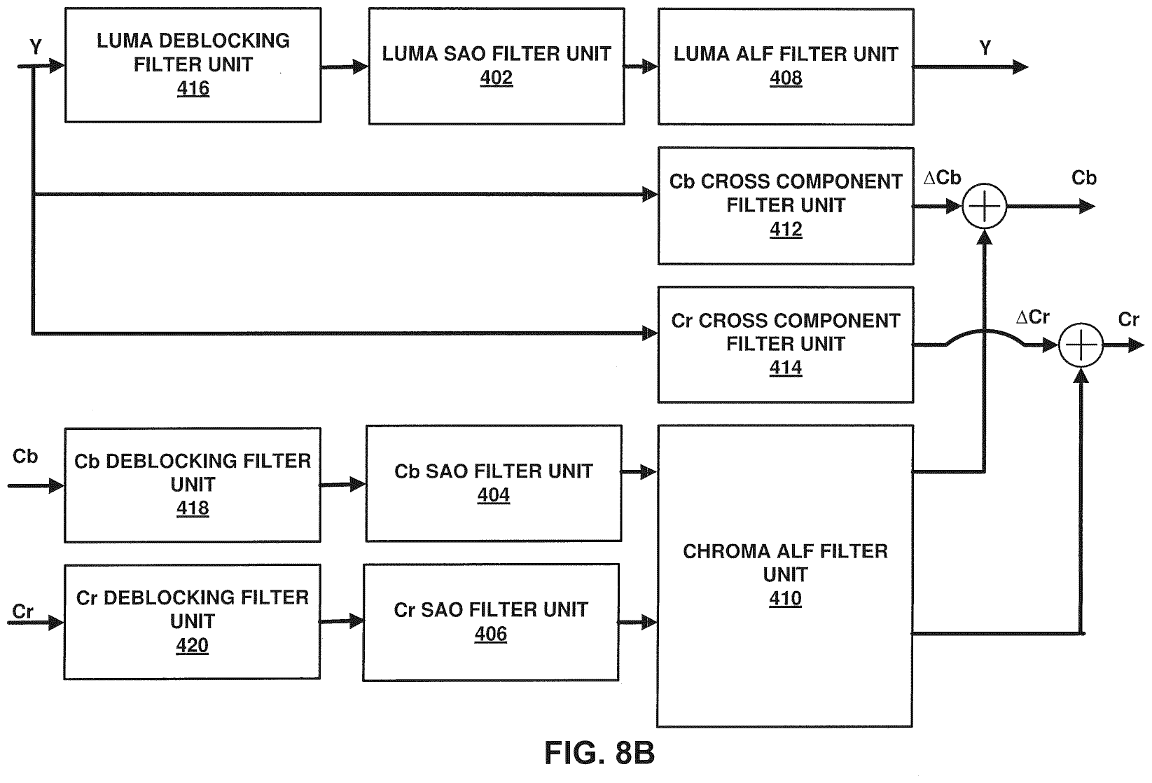

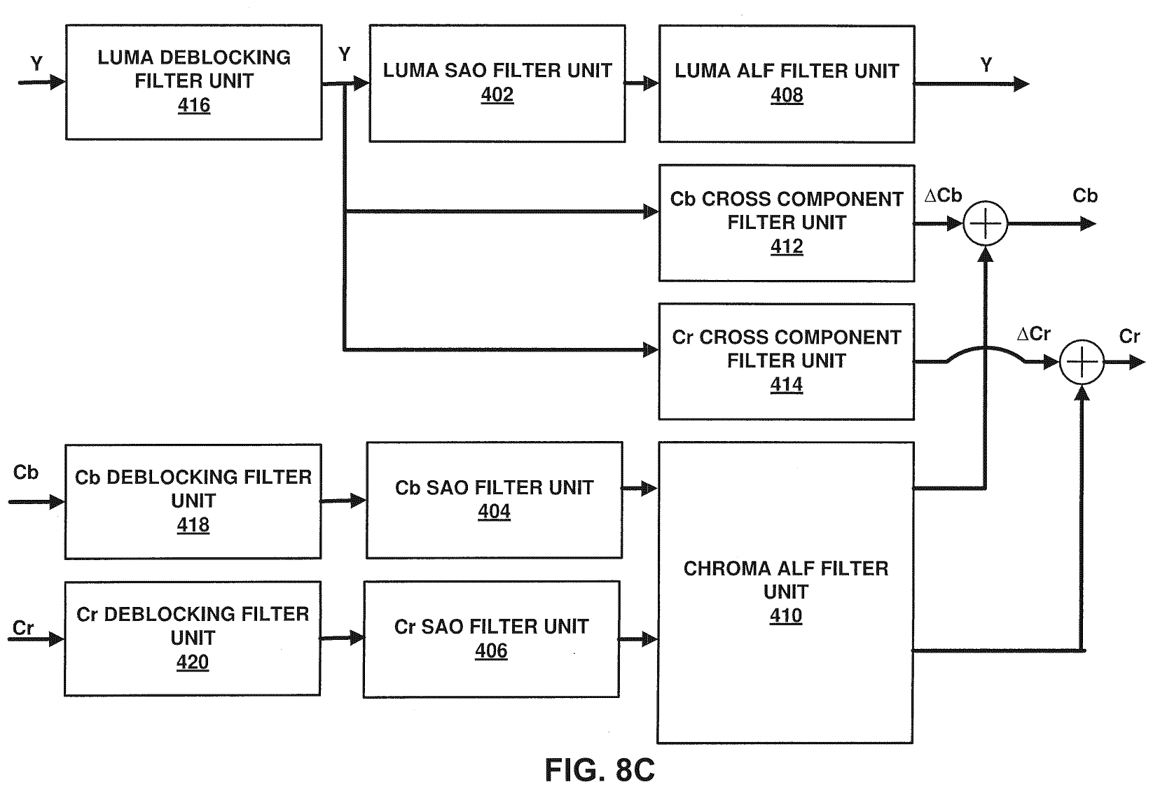

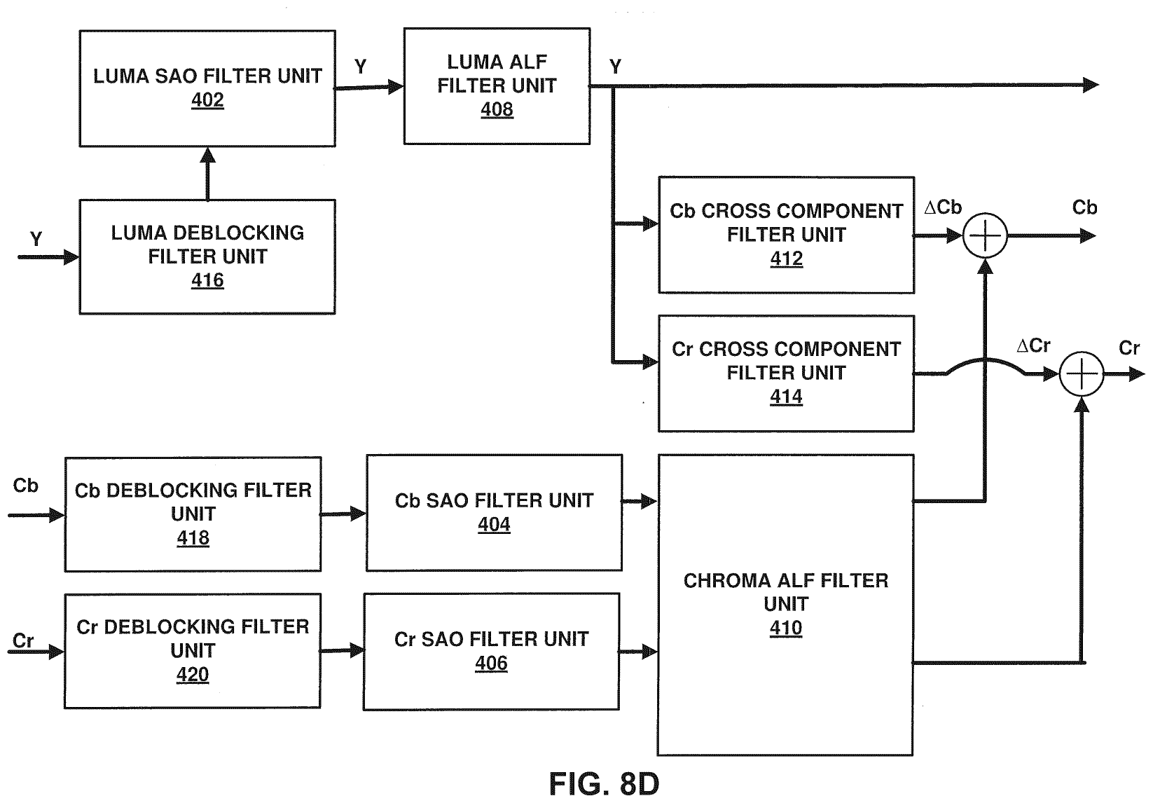

As described above, JVET-N1001 and JVET-O2001 include deblocking, SAO, and ALF filters, cross component filter techniques described herein may be performed as various point in a filter chain. That is, for example, at various stages of in-loop filtering. FIGS. 8A-8D are block diagrams illustrating examples of cross component filter units that may be configured to reduce a reconstruction error according to one or more techniques of this disclosure. In FIGS. 8A-8D, luma SAO filter unit 402 represent a filtering unit configured to perform SAO filtering on luma sample values, Y, for example, SAO filtering as provided in JVET-N1001 or JVET-O2001; Cb SAO filter unit 404 represent a filtering unit configured to perform SAO filtering on chroma Cb sample values, for example, SAO filtering as provided in JVET-N1001 or JVET-O2001; Cb SAO filter unit 406 represent a filtering unit configured to perform SAO filtering on Cb sample values, for example, SAO filtering as provided in JVET-N1001 or JVET-O2001; luma ALF filter unit 408 represent a filtering unit configured to perform ALF filtering on luma sample values, Y, for example, ALF filtering as provided in JVET-N1001 or JVET-O2001; chroma ALF filter unit 410 represent a filtering unit configured to perform ALF filtering on chroma sample values, for example, ALF filtering as provided in JVET-N1001 or JVET-O2001; luma deblocking filter unit 416 represents a filtering unit configured to perform deblocking filtering on luma sample values, Y, for example, deblocking filtering as provided in JVET-N1001 or JVET-O2001; Cb deblocking filter unit 418 represents a filtering unit configured to perform deblocking filtering on Cb sample values, for example, deblocking filtering as provided in JVET-N1001 or JVET-O2001; and Cr deblocking filter unit 420 is represents a filtering unit configured to perform deblocking filtering on Cr sample values, for example, deblocking filtering as provided in JVET-N1001 or JVET-O2001. Further, in FIGS. 8A-8D, Cb cross component filter unit 412 represents an example of a cross component filter configured to generate a Cb refinement, ΔCb, according to one or more of the techniques described herein; and Cr cross component filter unit 414 represents an example of a cross component filter configured to generate a Cr refinement, ΔCr, according to one or more of the techniques described herein. Thus, as illustrated FIGS. 8A-8D cross component filtering according to the techniques herein may be applied as various points in a filtering chain. That is, cross component filtering input may be received at various points in a filtering chain and cross component filtering refinements may be output at various points in a filtering chain. It should be noted that in the example illustrated in FIG. 8B, the input of luma deblocking is used as input to filtering which may have the advantage of reducing line buffer requirements. It should be noted that in the example illustrated in FIG. 8C, the output of luma deblocking is used as input to filtering which may have the advantage of reducing line buffer requirements with slightly improved coding efficiency. It should be noted that in the example illustrated in FIG. 8D, the output of ALF luma is used as input to filtering which may have the advantage of improved coding efficiency.

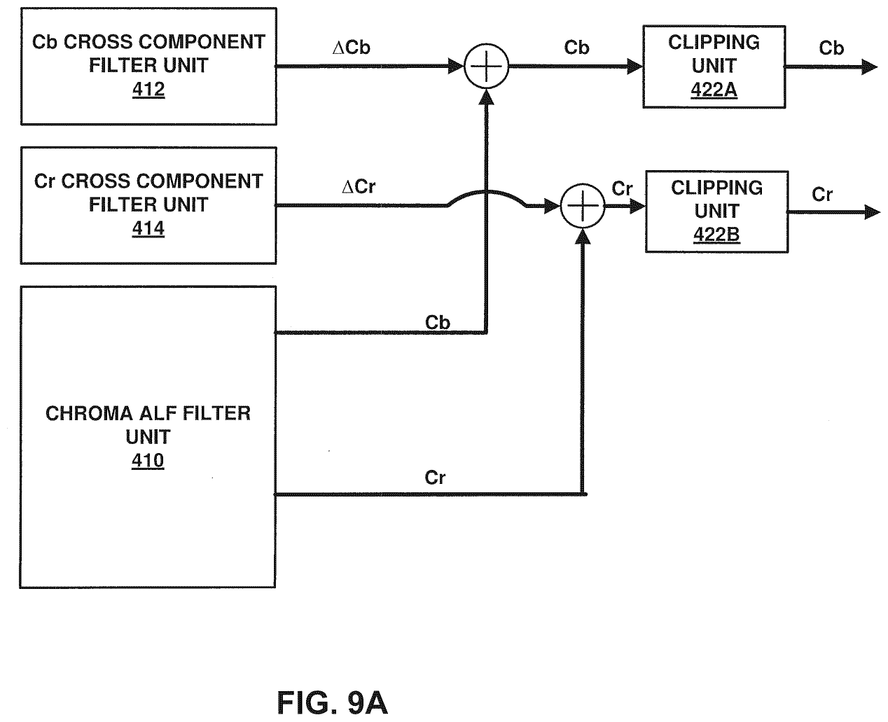

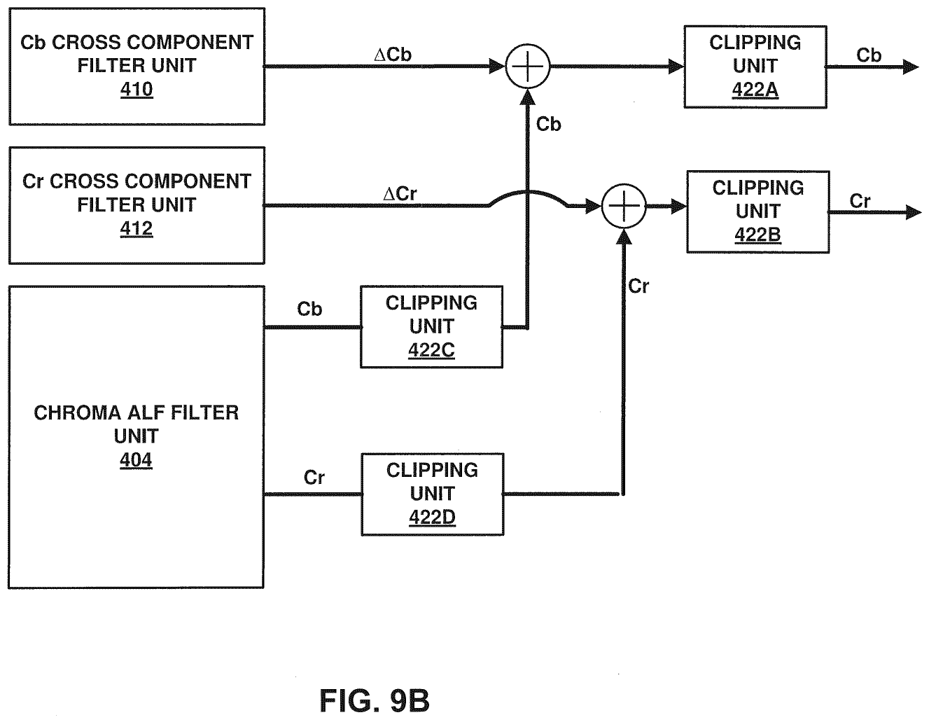

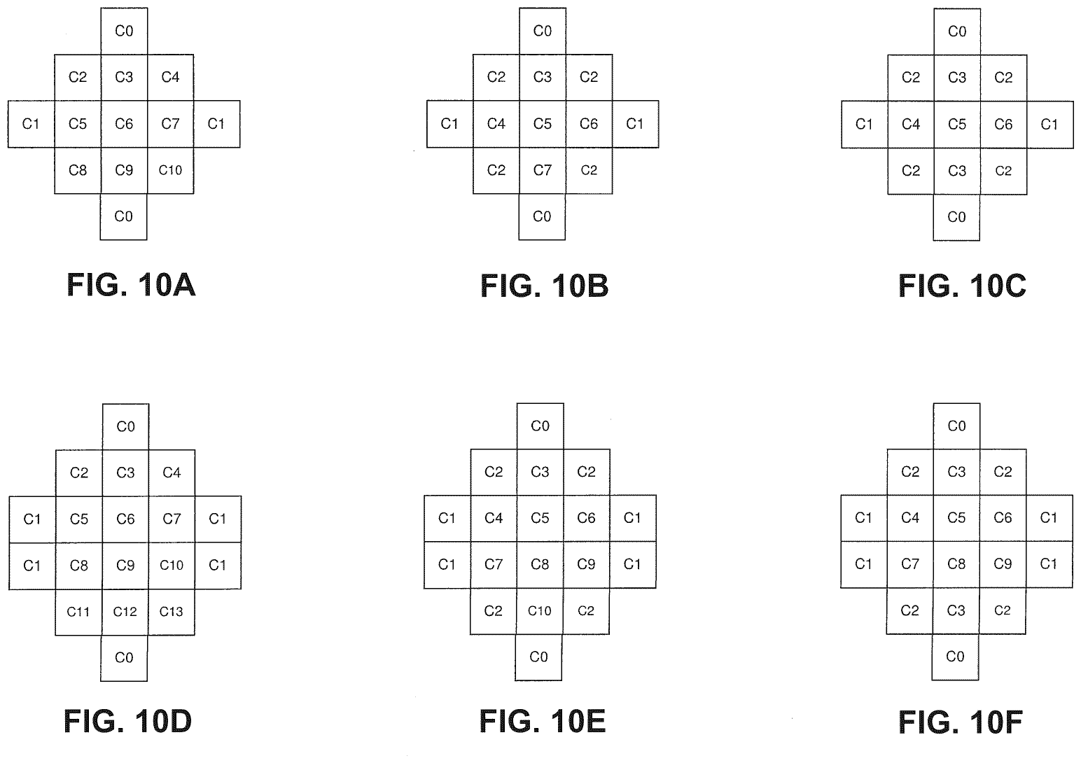

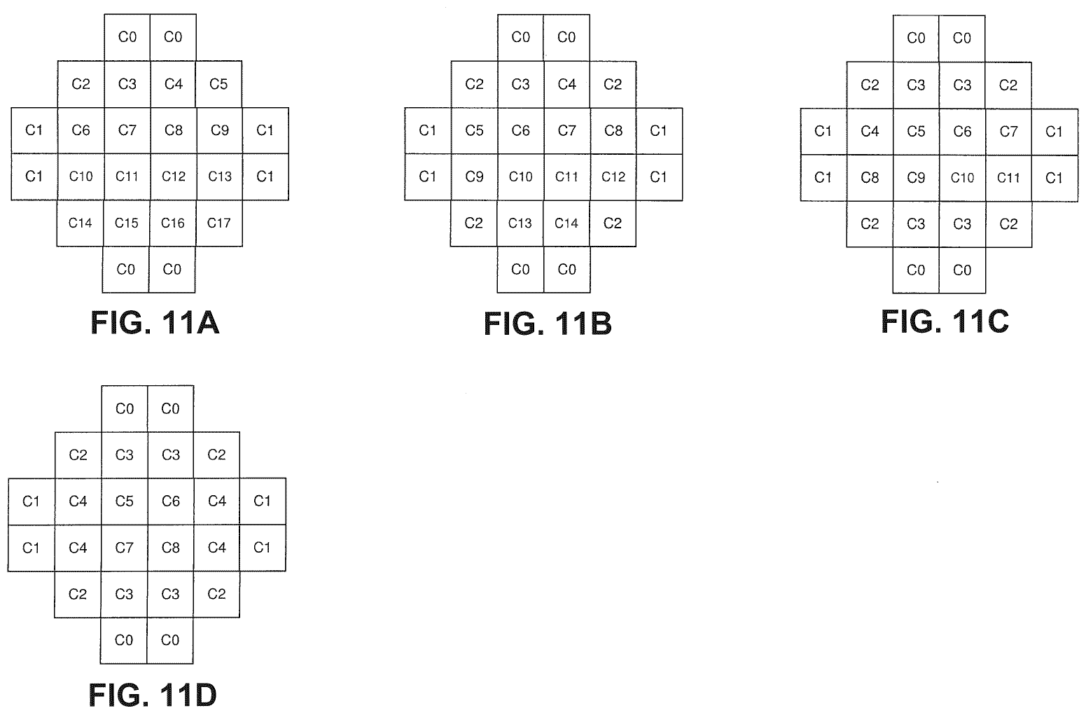

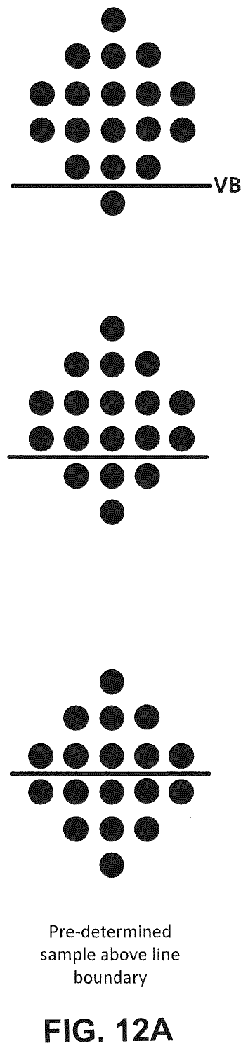

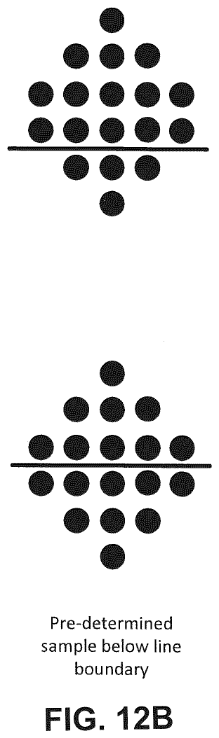

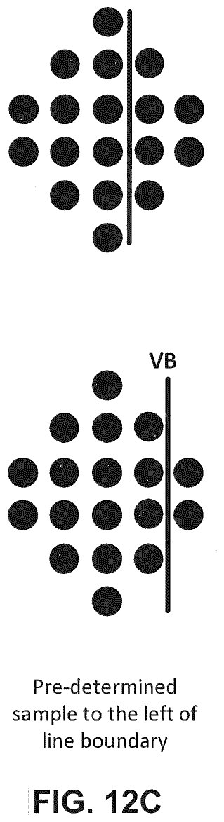

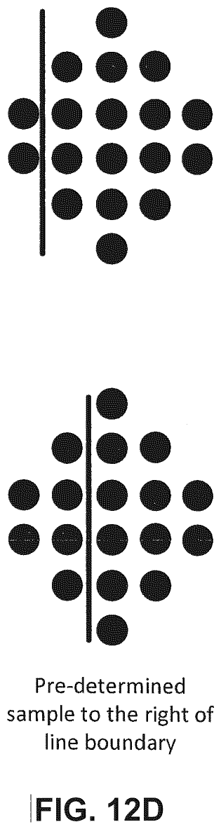

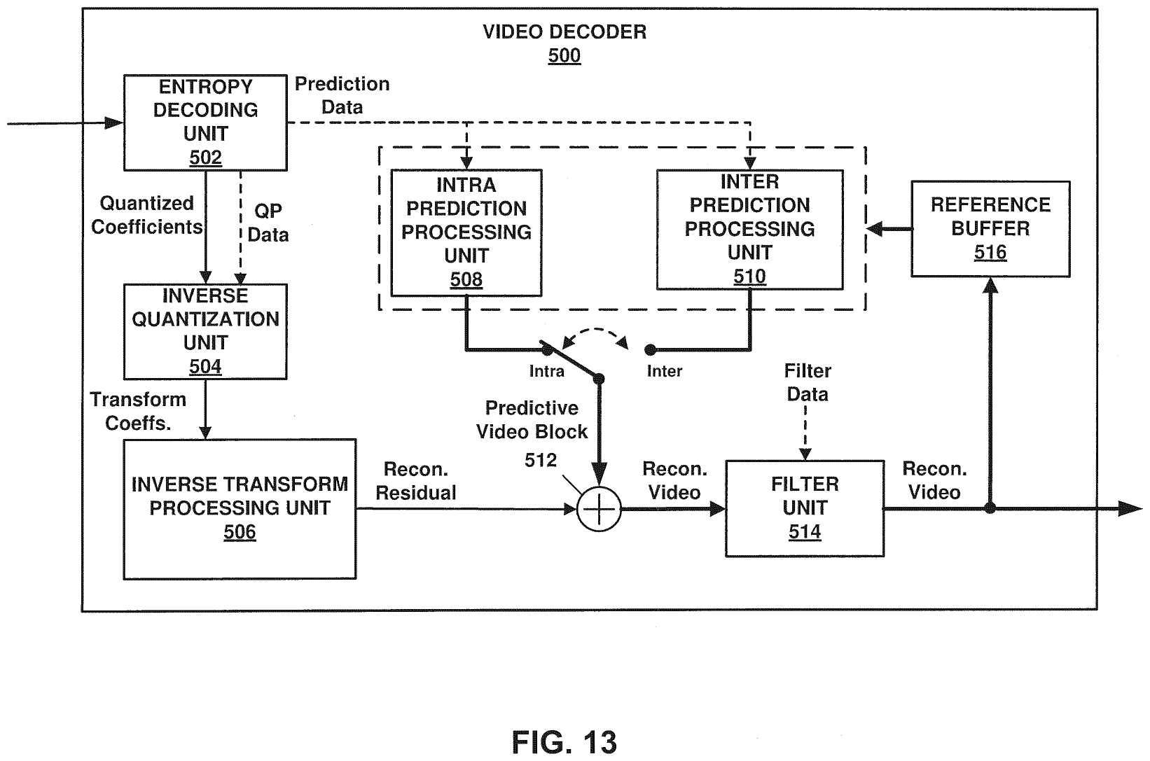

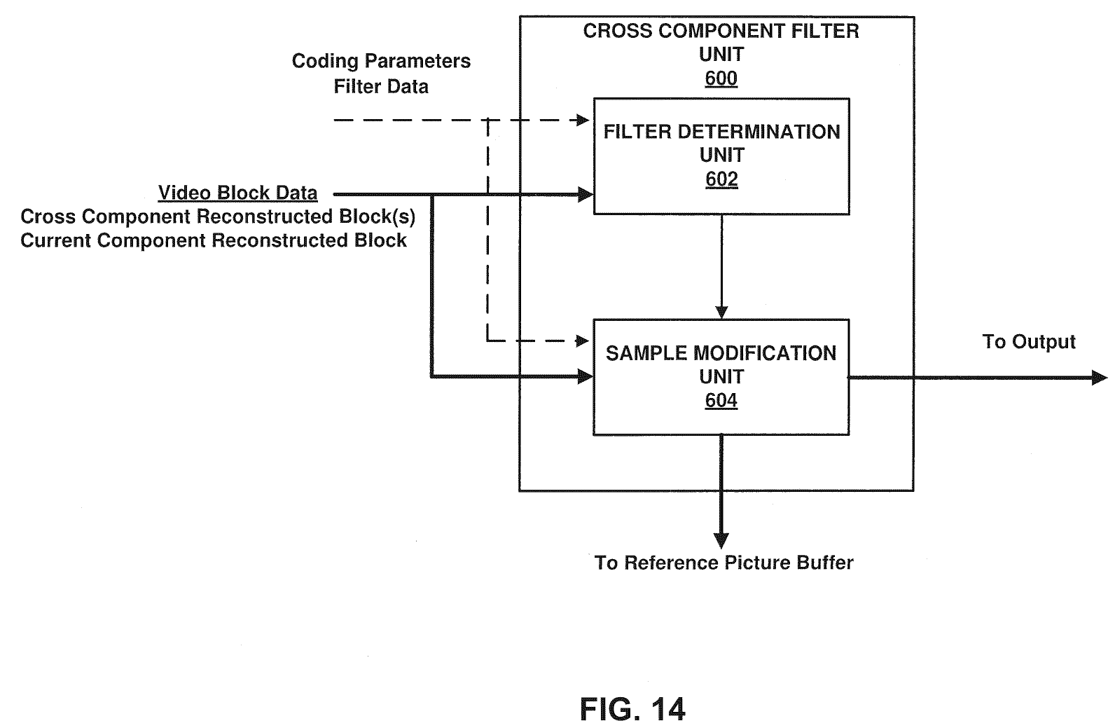

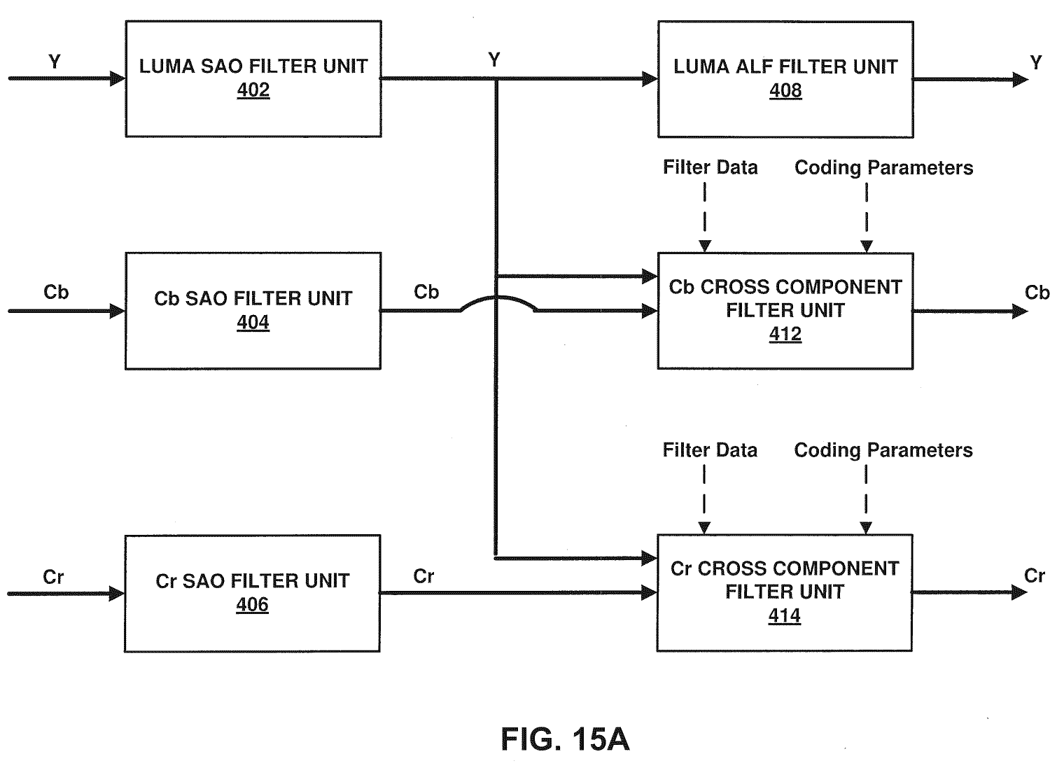

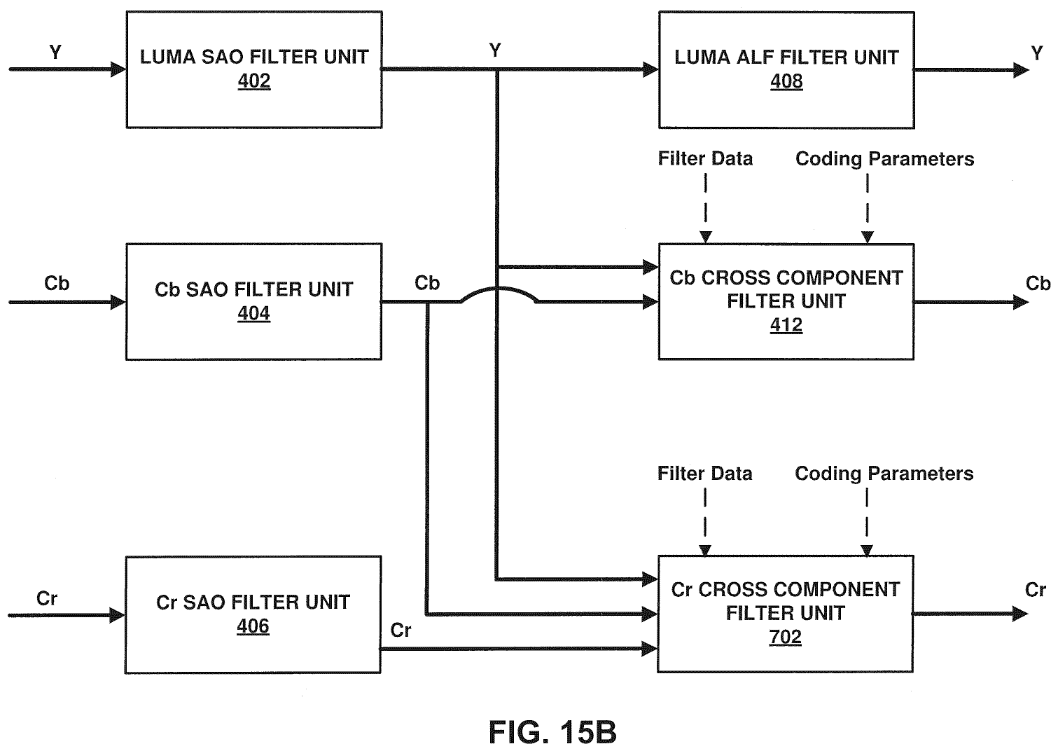

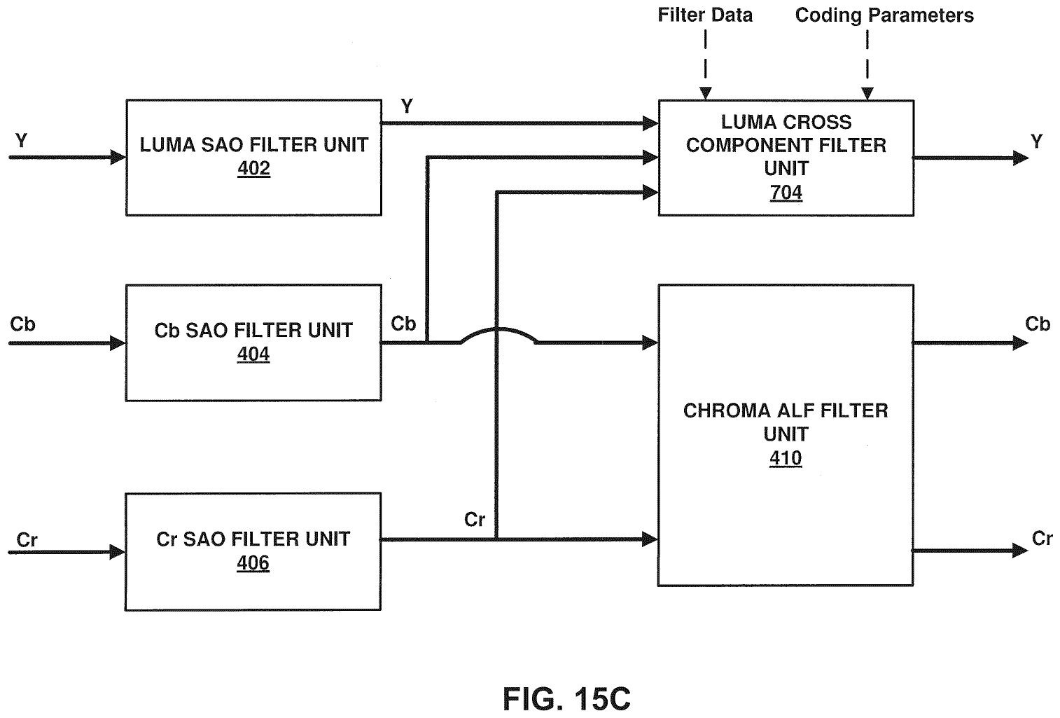

Further, cross component filter techniques described herein may further include performing clipping operations at various points in a filter chain. That is, for example, at various stages of in-loop filter. FIGS. 9A-9B are block diagrams illustrating examples of cross component filter units that may be configured to reduce a reconstruction error according to one or more techniques of this disclosure. In FIGS. 9A-9B, commonly numbered elements are described above with respect to FIGS. 8A-8D and clipping units 422A-422D may be configured to perform a clipping function based on an output bit depth of respective component e.g., Clip3(0, 2^{BitDepthC}−1, *). It should be noted that clipping units 422A-422D may be selectively enabled based on whether particular types of filtering are performed.

As described above, for each support sample a filter coefficient may be determined and signaled. That is, for example, for 5×5, 5×6, 6×6, and/or 6×6 filter coefficients may be signaled. FIGS. 10A-10C illustrate examples of signaling filter coefficients for 5×5 filters. FIGS. 10D-10F illustrate examples of signaling filter coefficients for 5×6 (and similarly, 6×5) filters. FIGS. 11A-11D illustrate examples of signaling filter coefficients for 6×6. In each of FIGS. 10A-11D, respective filter coefficients for a filter are indicated by CN. Thus, in cases, where the same CN value is provided multiple locations of the same filter, the filter coefficients are that same, i.e., shared. In this manner, the number of filter coefficients that is signaled for a filter is reduced. For example, in FIG. 10D, 14 filter coefficients are signaled for the 18 support locations.

In one example, it may be desirable to limit the number of line buffers within an architecture where samples are processed CTU-by-CTU. That is, for example, a virtual line boundary provides where for each CTU, samples above the horizontal VB can be processed before the lower CTU comes, but samples below the horizontal VB cannot process until the lower CTU becomes available. JVET-N1001 and JVET-O2001 define a horizontal virtual line boundary (VB) for luma ALF and luma SAO. According to the techniques herein this VB may be reused for the luma-input-chroma-output filter defined herein. Further, a vertical VB may be reused for the luma-input-chroma-output filter defined herein, and/or subsets of VBs may be reused for luma-input-chroma-output filter defined herein. Further, there are two cases defined, for which the support samples in the luma component may be derived/modified: when a pre-determined luma sample (corresponding to chroma sample being decoded for e.g. based on chroma location type) is above the VB and the support spans across the VB; and when a pre-determined luma sample (corresponding to chroma sample being decoded e.g., based on chroma location type) is below the VB and the support spans across the VB. In an example, the pre-determined sample is the sample at the position corresponding to coefficient C6 for 5×6 luma support illustrated in FIG. 10D. FIGS. 12A-12D are conceptual diagrams illustrating examples of virtual line buffers which may be used for cross component filtering in accordance with one or more techniques of this disclosure. In FIG. 12A, samples below a horizontal VB are obtained by copying samples above and closest to virtual line boundary and in same column. In FIG. 12B, samples below a horizontal VB are obtained by copying samples below and closest to virtual line boundary and in same column. In one example, a luma VB is four samples from the horizontal CTU boundary. In one example, each CTU, SAO and ALF can process samples to left of the vertical VB before the right CTU comes, but cannot process samples to right of the vertical VB until the right CTU becomes available. Example modifications when support spans across vertical virtual boundary (VB) is shown in FIGS. 12C-12D. In FIG. 12C, samples to right of vertical VB are obtained by copying samples to left and closest to virtual line boundary and in same row. In FIG. 12D, samples to left of vertical VB are obtained by copying samples right and closest to virtual line boundary and in same row. In an example, a luma VB is four samples from the vertical CTU boundary. In one example, according to the techniques herein, with respect to a generating sample for a horizontal VB, one may consider a vertical and a horizontal axis passing through the center of the support region. The samples being copied may be obtained by copying samples in a column that are at the same distance from the vertical axis, but on the opposite side of the vertical axis. In one example, the sample being copied may be copied from a row that is at the same distance from the horizontal axis but on the opposite side. In one example, according to the techniques herein, with respect to a generating sample for a vertical VB, one may consider a vertical and a horizontal axis passing through the center of the support region. The samples being copied may be obtained by copying samples in a row that are at the same distance from the vertical axis, but on the opposite side of the horizontal axis. In one example, the sample being copied may be copied from a column that is at the same distance from the vertical axis, but on the opposite side. In one example, according to the techniques herein, with respect to generating samples for a VB, samples may be obtained by symmetric padding. That is, with respect to a horizontal VB samples may be copied from the same column and at the same sample distance from the VB and with respect to a vertical VB, samples may be copied from the same row and at the same sample distance from the VB. That is, sample values are mirrored about the VB. It should be noted that section 8.8.5.2 Coding tree block filtering process for luma samples of JVET-O2001 provides a padding scheme for luma samples across a virtual boundary for use with respect to an ALF process. In one example, according to the techniques herein, for cross-component filtering, a similar padding scheme may be used. In one example, according to the techniques herein, when one or more support samples are unavailable, e.g., due to a VB, cross-component filtering may be disabled.

In one example, cross-component filter coefficients for cross-component filters is carried its own independent parameter set e.g., APS. In one example cross-component filter coefficients is carried in a parameter set e.g. APS, that is different from the non-cross-component filters (e.g. ALF in JVET-N1001-v8). In one example, instead of the 5×6 filter, an embodiment may use the 7×7 ALF filtering process described in JVET-N1001-v8 clause on “Coding tree block filtering process for luma samples.” This would further reduce the number of coefficients that need to be signaled. In the above description, a filtering operation is applied to refine the samples in a color component and/or channel and signaling that could enable/disable the operation on a frame-by-frame and location-by-location basis is provided. In one example, the filtering operation may also be implemented so that at each frame and/or location, multiple filtering operations are available and, the described signaling may be used to transmit the multiple filters and select among the available filters. In one example, an embodiment may use a 3×4 diamond shaped filter. It should be noted that in other examples other filters sizes and shapes may be used (e.g., 3×3, 4×3, 4×4, etc.). In one example, when a 3×4 diamond shaped filter is used, eight unique coefficients may be used. It should be noted that, in other examples, for each filter size and shape described herein, the number of unique coefficients that are used and/or signaled may vary in order to optimize signaling overhead. In one example, when a 3×4 diamond shaped filter is used, up to four unique filters per component may be specified (e.g., on a sequence, picture, tile, or slice level) and when filtering is applied one of the four may be selected. In one example, according to the techniques herein, local region control flags may be shared between different chroma channels.

In one example, for alf_cross_component_cb_idc and/or alf_cross_component_cr_idc only the first bin may be context ended (i.e. the other bins may be bypass coded). In one example, the derivation of the context for the first bin may be as follows:

Input to the process is the luma location [symbol] specifying the top-left luma sample of the current luma block relative to the top-left sample of the current picture, the [symbol] component [symbol] the current coding quadtree depth [symbol] , the dual

[symbol]

Output of this process is [symbol] .

The location [symbol] is set to [symbol] the destination process for neighboring block

[symbol]

The location [symbol] is set equal to [symbol] and the [symbol] for neighboring block availability as specific is invoked with the location [symbol] , the neighboring location [symbol] set is equal to [symbol] set equal to FALSE, and

[symbol]

The assignment

[symbol]

[symbol]

TABLE 10

| Syntax element | condL | condA | etxSetIdx |
|---|---|---|---|
| [symbol] | [symbol] | [symbol] | 0 |
| [symbol] | [symbol] | [symbol] | 0 |

[symbol]

indicates data missing or illegible when filed

With respect to Table 10, in one example, each of the [symbol] texts may be replaces with [symbol] .

In one example, according to the techniques herein, an implementations of cross component filtering may be based on the following syntax and semantics. With respect to the following syntax and semantics, in Table 13, syntax elements alf_cross_component_cb_filter_signal_flag, alf_cross_component_cr_filter_signal_flag, alf_cross_component_cb_coeff_abs, alf_cross_component_cb_coeff_sign, alf_cross_component_cr_coeff_abs, and alf_cross_component_cr_coeff_sign, are added to the [symbol] structure provided in JVFT-O2001, It should be noted that the alf_data( ) syntax structure provided in JVET-O2001 is provided in the adaptation parameter set syntax structure. In table 16, syntax elements slice_cross_component_alf_cb_enabled_flag, slice_cross_component_alf_cb_ [symbol] _temporal_layer_filter_flag. slice_cross_component_alf_cb_aps_id, slice_cross_component_alf_sb_log 2_ [symbol] , and slice_cross_component_alf_cr_enabled_flag, slice_cross_component_alf_cr_ [symbol] _temporal_layer_filter_flat, slice_cross_component_alf_cr_aps_id, and slice_cross_component_alf_sb_log 2_control_size_ [symbol] are added to the slice_header( ) syntax structure provided JVET-O2001. In table 17, syntax elements alf_cross_component_ch_flag and alf_cross_component_cr_flat are added to the coding_tree_unit( ) syntax structure provided in JVET-O2001.

TABLE 15

| | Descriptor |
|---|---|
| [symbol] | |
| [symbol] | [symbol] |
| [symbol] | [symbol] |
| [symbol] | [symbol] |
| [symbol] | [symbol] |
| [symbol] | |
| [symbol] | [symbol] |
| [symbol] | [symbol] |
| [symbol] | |
| [symbol] | |
| [symbol] | [symbol] |
| [symbol] | |
| [symbol] | [symbol] |
| [symbol] | |
| [symbol] | |
| [symbol] | [symbol] |
| [symbol] | |
| [symbol] | |
| [symbol] | |
| [symbol] | |
| [symbol] | [symbol] |
| [symbol] | |
| [symbol] | [symbol] |
| [symbol] | |
| [symbol] | |
| [symbol] | |
| [symbol] | |
| [symbol] | |
| [symbol] | |
| [symbol] | |
| [symbol] | [symbol] |
| [symbol] | |
| [symbol] | |
| [symbol] | |
| [symbol] | |
| [symbol] | |
| [symbol] | [symbol] |
| [symbol] | |
| [symbol] | [symbol] |
| [symbol] | |
| [symbol] | [symbol] |
| [symbol] | |
| [symbol] | [symbol] |
| [symbol] | |
| [symbol] | |
| [symbol] | |
| [symbol] | [symbol] |
| [symbol] | |
| [symbol] | |
| [symbol] | |
| [symbol] | |
| [symbol] | |
| [symbol] | [symbol] |
| [symbol] | |
| [symbol] | [symbol] |
| [symbol] | |
| [symbol] | |
| [symbol] | [symbol] |
| [symbol] | |
| [symbol] | [symbol] |
| [symbol] | |

[symbol]

indicates data missing or illegible when filed

TABLE 16

| | Descriptor |
|---|---|
| [symbol] | |
| [symbol] | [symbol] |
| [symbol] | |
| [symbol] | |
| [symbol] | |
| [symbol] | |
| [symbol] | [symbol] |
| [symbol] | |
| [symbol] | |
| [symbol] | |
| [symbol] | [symbol] |
| [symbol] | |
| [symbol] | |
| [symbol] | [symbol] |
| [symbol] | |
| [symbol] | [symbol] |
| [symbol] | |
| [symbol] | |
| [symbol] | [symbol] |
| [symbol] | |
| [symbol] | [symbol] |
| [symbol] | |
| [symbol] | [symbol] |
| [symbol] | |
| [symbol] | [symbol] |
| [symbol] | |
| [symbol] | [symbol] |
| [symbol] | |
| [symbol] | |
| [symbol] | [symbol] |
| [symbol] | |
| [symbol] | [symbol] |
| [symbol] | |
| [symbol] | [symbol] |
| [symbol] | [symbol] |
| [symbol] | |
| [symbol] | |
| [symbol] | [symbol] |
| [symbol] | |
| [symbol] | [symbol] |
| [symbol] | |
| [symbol] | [symbol] |
| [symbol] | [symbol] |
| [symbol] | |
| [symbol] | |
| [symbol] | |
| [symbol] | |
| [symbol] | [symbol] |
| [symbol] | |
| [symbol] | [symbol] |
| [symbol] | |
| [symbol] | [symbol] |
| [symbol] | [symbol] |
| [symbol] | |
| [symbol] | |
| [symbol] | |
| [symbol] | [symbol] |
| [symbol] | |
| [symbol] | [symbol] |
| [symbol] | |
| [symbol] | [symbol] |
| [symbol] | |
| [symbol] | |
| [symbol] | |
| [symbol] | |
| [symbol] | |

[symbol]

indicates data missing or illegible when filed

TABLE 17

| | Descriptor |
|---|---|
| [symbol] | |
| [symbol] | |
| [symbol] | |
| [symbol] | |
| [symbol] | |
| [symbol] | |
| [symbol] | [symbol] |
| [symbol] | |
| [symbol] | |
| [symbol] | [symbol] |
| [symbol] | |
| [symbol] | |
| [symbol] | [symbol] |
| [symbol] | |
| [symbol] | |
| [symbol] | [symbol] |
| [symbol] | |
| [symbol] | [symbol] |
| [symbol] | |
| [symbol] | |
| [symbol] | |
| [symbol] | [symbol] |
| [symbol] | |
| [symbol] | [symbol] |
| [symbol] | |
| [symbol] | |
| [symbol] | [symbol] |
| [symbol] | |
| [symbol] | [symbol] |
| [symbol] | |
| [symbol] | |
| [symbol] | |
| [symbol] | |
| [symbol] | |
| [symbol] | |
| [symbol] | |
| [symbol] | |
| [symbol] | |
| [symbol] | [symbol] |
| [symbol] | |
| [symbol] | |
| [symbol] | |
| [symbol] | |
| [symbol] | |
| [symbol] | |
| [symbol] | |
| [symbol] | |
| [symbol] | |

[symbol]

indicates data missing or illegible when filed

With respect to Table 15, in one example, the semantics may be based on the following:

alf_luma_filter_signal_flag equal to 1 specifies [symbol] is signaled, alf_luma_filter_signal_flag equal to 0 specifies that a luma filter set is not signaled.

alf_chroma_filter_signal_flag equal to 1 specifies that a chroma filter is signalled [symbol] equal to 0 specifies that a chroma filter is not signalled. When ChromaArrayType is equal to 0, alf_chroma_filter_signal_flag shall be equal to 0.

The variable [symbol] specifying the number of different adaptive loop filters is set to equal to 25. alf_cross_component_cb_filter_signal_flag equal to 1 specifies that a cross component cb filter is signaled. [symbol] equal to 0 specifies that a cross component Cb filter is not signalled. When CromaArrayType is equal to 0, alf_cross_component_cb_filter_signal_flag shall be equal to 0.

alf_cross_component_cr_filter_signal_flag equal to 1 specifies that a cross component Cr filter is signalled. alf_cross_component_cr_filter_signal_flag equal to 0 specifies that a cross component Cr filter is nx signalled. When ChromaArrayType is equal to 0, alf_cross_component_cr_filter_signal_flag shall be equal to 0.

alf_luma_clip_flag equal to 0 specifies that linear adaptive loop filtering is applied to luma component alf_luma_clip_flag equal to 1 specifies that non-linear adaptive loop filtering may be applied to luma component.

alf_luma_num_filters_signalled_minus1 plus 1 specifies the number of adaptive loop filter classes for which luma coefficients can be signalled. The value alf_luma_num_filters_signalled_minus1 shall be in the range of 0 to [symbol] −1, inclusive.

[symbol] specifies the [symbol] of the signalled adaptive loop filter luma coefficient deltas for the filter class indicated by [symbol] ranging from 0 to [symbol] −1. When [symbol] is not present, it is inferred to be equal to 0. The length of [symbol] is [symbol] bits.

alf_luma_coeff_signalled_flag equal to 1 indicates that [symbol] is signalled alf_luma_coeff_signalled_flag equal to 0 indicates that alf_coeff_flag[ [symbol] ] is signalled.

alf_luma_coeff_flag [symbol] equals 1 specifies that the coefficients of the luma filter indicated by [symbol] are signalled alf_luma_coeff_flag[ [symbol] ] equal to 0 [symbol] indicated by [symbol] are set to equal 0. When not present, [symbol] is set equal to 1.

[symbol] specifies the absolute value of the j-th coefficient of the signalled luma filter indicated by [symbol] . When [symbol] is not present, it is inferred to be equal 0.

The order k of the [symbol] is set equal to 3.3

alf_luma_coeff_sign[sfIds][j] specifies the sign of the j-th luma coefficient of the filter indicated by sfIdx as follows:
if alf_luma_coeff_sign[ [symbol] ][j] is equal to [symbol] , the corresponding luma filter coefficient [symbol] a [symbol] value.
Otherwise (alf_coeff_sign [symbol] is equal to 1 [symbol] , the corresponding luma filter coefficient has a negative value.
   When [symbol] is not present, it is inferred to be equal to 0.

The variable [symbol] with [symbol] , j=0.11 is initialized as follows:

$$\text{?}$$

$$\text{?} \text{indicates text missing or illegible when filed}$$

The luma filter coefficients [symbol] with elements [symbol] , with [symbol] and j=0.11 are derived as follows:

[symbol]

The fixed filter coefficients [symbol] with 1= [symbol] , j=0.11 and the class to filter mapping [symbol] with m=0.15 and n=0.24 are derived as follows:

```
  Alf [symbol] Coeff =

[symbol]

[symbol]

        0, 0, 2, −3, [symbol] , −4, 1, 7, −1, 1, −1, [symbol] [symbol]
        0, 0, 0, 0, 0, −1, 0, 1, 0, 0, −1, 2 [symbol] [symbol]
        0, 0, 0, 0, 0, 0, 0, 1, 0, 0, 0, 0 [symbol] [symbol]
        0, 0, 0, 0, 0, 0, 0, 0, 0, 0, −1, 1 [symbol] [symbol]
        2, 2, −7, −3, 0, −5, 13, 22, 12, −3, −3, 17 [symbol] [symbol]
        −1, 0, 6, −8, 1, −5, 1, 23, 0, 2, −5, 10 [symbol] [symbol]
        0, 0, −1, −1, 0, −1, 2, 1, 0, 0, −1, 4 [symbol] [symbol]
        0, 0, 3, −11, 1, 0, −1, [symbol] , [symbol] , 2, −9, 9 [symbol] [symbol]
        0, 0, 8, −8, −2, −7, 4, 4, 2, 1, −1, 25 [symbol] [symbol]
        0, 0, 1, −1, 0, −3, 1, 3, −1, 1, −1, 3 [symbol] [symbol]
        0, 0, 3, −3, 0, −6, 5, −1, 2, 1, −4, 21 [symbol] [symbol]
  −7, 1, 5, 4, −3, 5, 11, 13, 12, −8, 11, 12 [symbol] [symbol]
  −5, −3, 6, −2, −3, 8, 14, 15, 2, −7, 11, 16 [symbol] [symbol]
  2, −1, −6, −5, −2, −2, 20, 14, −4, 0, −3, 25 [symbol]
  3, 1, [symbol] , −4, 0, −8, 22, 5, −3, 2, −10, 29 [symbol] [symbol]
  2, 1, −7, −1, 2, −11, 23, −5, 0, 2, −10, 29 [symbol] [symbol]
  −6, −3, 8, 9, −4, 8, 9, 7, 14, −2, 8, 9 [symbol] [symbol]
  2, 1, −4, −7, 0, −8, 17, 22, 1, −1, −4, 23 [symbol] [symbol]
  3, 0, −5, −7, 0, −7, 15, 18, −5, 0, −5, 27 [symbol] [symbol]
  2, 0, 0, −7, [symbol] , −10, 13, −13, −4, 2, −7, 24 [symbol] [symbol]
  3, [symbol] , −13, 4, −2, [symbol] , 9, 21, 25, −2, −3, 12 [symbol] [symbol]
  −5, −2, 7, −3, −7, 9, 8, 9, 16, −2, 15, 12 [symbol] [symbol]
  0, −1, 0, −7, −5, 4, 11, 11, [symbol] , −6, 12, 21 [symbol] [symbol]
  3, −2, −3, [symbol] , −4, −1, 16, 15, −2, −3, 3, 26 [symbol] [symbol]
  2, 1, [symbol] , [symbol] , −1, −8, 16, 4, −2, 1, [symbol] , [symbol] [symbol]
  2, 1, −4, −2, 1, −10, 17, −2, 0, 2, −11, [symbol] [symbol]
  1, −2, 7, −15, −16, 10, [symbol] , [symbol] , 20, 11, 14, 11 [symbol] [symbol]
  2, 2, [symbol] , −13, −13, 4, 8, 12, 2, −3, 16, 24 [symbol] [symbol]
  1, 4, 0, −7, −8, −4, [symbol] , [symbol] , −2, −2, [symbol] , 29 [symbol] [symbol]
  1, 1, 2, −4, −1, −6, 6, 3, −1, −1, −3, [symbol] [symbol]
  −7, [symbol] , 2, 10, −2, 3, 7, 11, 19, −7, 8, 10 [symbol] [symbol]
  0, −2, −5, −3, −2, 4, 20, [symbol] , −1, −3, −1, 22 [symbol] [symbol]
  3, −1, −8, −4, −1, −4, [symbol] , 8, −4, 2, −8, 28 [symbol] [symbol]
  0, 3, −14, 3, 0, 1, 19, 17, 8, −3, −7, 20 [symbol] [symbol]
0, 2, −1, −8, 3, −6, [symbol] , 21, 1, 1, −9, 13 [symbol] [symbol]
−4, −2, [symbol] , 20, −2, 2, 3, 5, 21, 4, 6, 1 [symbol] [symbol]
2, [symbol] , −1, −9, −4, 2, 14, 16, [symbol] , −6, [symbol] , 24 [symbol] [symbol]
2, 1, 5, −16, −7, 2, 3, 11, 15, −3, 11, 22 [symbol] [symbol]
1, 2, 3, −11, −2, −5, 4, 8, 9, −3, −2, 26 [symbol] [symbol]
0, −1, 10, −9, −1, −8, 2, 3, 4, 0, 0, 29 [symbol] [symbol]
1, 2, 0, −5, 1, −9, 9, 3, 0, 1, −7, 20 [symbol] [symbol]
−2, 8, −6, −4, 3, −9, −8, 45, 14, 2, −13, 7 [symbol] [symbol]
1, −1, 16, −19, −8, −4, −5, 2, 19, 0, 4, [symbol] [symbol]
1, 1, −3, 0, 2, −11, 15, −5, 1, 2, −9, 24 [symbol] [symbol]
0, 1, −2, 0, 1, −4, 4, 0, 0, 1, −4, 7 [symbol] [symbol]
0, 1, 2, −5, 1, −6, 4, 10, −2, 1, −4, 10 [symbol] [symbol]
3, 0, −3, −6, −2, −6, 14, 8, −1, −1, −3, 31 [symbol] [symbol]
0, 1, 0, −2, 1, −6, 5, 1, 0, 1, −5, 13 [symbol] [symbol]
3, 1, [symbol] , −10, −21, [symbol] , 7, 6, 13, 5, 15, 21 [symbol] [symbol]
2, 4, 3, −12, −13, 1, 7, 8, 3, 0, 12, 26 [symbol] [symbol]
3, 1, −8, −2, 0, −6, 18, 2, −2, 3, −10, [symbol] [symbol]
1, 1, −4, −1, 1, −5, 8, 1, −1, 2, −5, 10 [symbol] [symbol]
0, 1, −1, 0, 0, −2, 2, 0, 0, 1, −2, 3 [symbol] [symbol]
1, 1, −2, −7, 1, −7, 14, 18, 0, 0, −7, 21 [symbol] [symbol]
0, 1, 0, −2, 0, −7, 8, 1, −2, 0, −3, 24 [symbol] [symbol]
0, 1, 1, −2, 2, −10, 10, 0, −2, 1, −7, 23 [symbol] [symbol]
0, 2, 2, −11, 2, −4, −3, 39, 7, 1, −10, 9 [symbol] [symbol]
      1, 0, 13, −16, −5, −6, −1, 8, 6, 0, 6, 29 [symbol] [symbol]
      1, 3, 1, −6, −4, −7, 9, 6, −3, −2, 3, 33 [symbol] [symbol]
      4, 0, −17, −1, −1, 5, 26, 8, −2, 3, −15, 30 [symbol] [symbol]
      0, 1, −2, 0, 2, −8, 12, −6, 1, 1, −6, [symbol] [symbol]
      0, 0, 0, −1, 1, −4, 4, 0, 0, 0, −3, 11 [symbol] [symbol]
      0, 1, 2, −8, 2, −6, 5, 15, 0, 2, −7, 9 [symbol] [symbol]
      1, −1, 12, −15, −7, −2, 3, 6, 6, −1, 7, 30 [symbol] [symbol]
    , [symbol]
indicates data missing or illegible when filed
```

```
AlfClassTo [symbol] Map =

[symbol]

[symbol]

[symbol]

    , 2, 2, 3, 3, 4, 53, 9, [symbol] , 52, 4, 4, 3, 9, 2, 8, 10, 9, 1, 3, 39, 39, 10, 9, 52 [symbol] [symbol]
    11, 12, 13, 14, 15, 30, 11, 17, 18, 19, 16, 20, 20, 4, 53, 21, 22, 23, 14, 25, 26, 26, 27, 28, 10 [symbol] [symbol]
    16, 12, 31, 32, 14, 16, 30, 33, 53, 34, 35, 16, 20, 4, 7, 16, 21, 36, 18, 19, 21, 26, 37, 38, 39 [symbol] [symbol]
    35, 11, 13, 14, 43, 35, 16, 4, 34, 62, 35, 35, 30, 56, 7, 35, 21, 38, 24, 40, 16, 21, 48, 57, 39 [symbol] [symbol]
    11, 31, 32, 43, 44, 16, 4, 17, 34, 45, 30, 20, 20, 7, 5, 21, 22, 46, 40, 47, [symbol] , 48, [symbol] , 58, 10 [symbol] [symbol]
    12, 13, 50, 51, 52, 11, 17, 53, 45, 9, 30, 4, 53, 19, 0, 22, 23, 25, 43, 44, 37, 27, 28, 10, 55 [symbol] [symbol]
    30, 33, 62, 51, 44, 20, 41, 56, 34, 45, 20, 41, 41, 56, 5, 30, 56, 38, 40, 47, 11, 37, 42, 57, [symbol] [symbol] [symbol]
    35, 11, 23, 32, 14, 35, 20, 4, 17, 18, [symbol] , 20, 20, 20, 4, 16, 21, 36, 46, 25, 41, 26, 48, 49, 58 [symbol] [symbol]
    12, 31, 59, 59, 3, [symbol] , [symbol] , 59, 59, [symbol] , 4, 33, 17, 59, [symbol] , 22, 36, 59, 59, 60, [symbol] , 36, 59, [symbol] , [symbol] [symbol] [symbol]
    31, 25, 15, 60, 60, 22, 17, 19, 55, 55, 20, 20, 53, 19, [symbol] , 22, 46, 25, 43, 60, 37, 28, 10, 55, 52 [symbol] [symbol]
    12, 31, 32, [symbol] , 51, 11, 33, 53, 19, 45, 16, 4, 4, 53, 5, 22, 36, 18, 25, 43, 26, 27, 27, 28, 10 [symbol] [symbol] [symbol]
        , [symbol] , 44, [symbol] , 3, 4, 53, 45, [symbol] , [symbol] , 4, 56, 5, 0, [symbol] , 5, 10, 47, 52, 3, [symbol] , 39, [symbol] , 9, [symbol] [symbol] [symbol]
        12, 34, 44, 44, 3, 56, 56, 62, 45, 9, [symbol] , [symbol]  7, 5, 0, 22, [symbol] , 40, 47, 52, 48, 57, [symbol] , 10, 9 [symbol] [symbol]
        35, 11, 23, 14, [symbol] , [symbol] , 20, 41, 56, 62, 16, 20, 41, 56, 7, 16, 21, 38, 24, 40, 26, 26, 42, 57, [symbol] [symbol] [symbol]
        33, 34, 51, 51, 52, 41, 41, 34, 62, 0, 41, 41, 56, 7, 5, 56, 38, 38, 40, 44, 37, 42, 57, 39, 10 [symbol] [symbol]
        16, 31, [symbol] , 15, [symbol] , [symbol] , 4, 17, 19, 25, 22, 20, 4, [symbol] , 19, 21, 22, 46, 25, [symbol] , 26, 48, 63, 58, 55 [symbol] [symbol]
      , [symbol]
indicates data missing or illegible when filed
```

alf_chroma_clip_flag[altIxd] equal to 0 specifies that linear adaptive loop filtering is applied on chroma components when using the chroma filter with index [symbol] equal to 1 specifies that non-linear adaptive loop [symbol] is applied on chroma components when using the chroma filter with index [symbol] . When not present, alf_chroma_clip_flag[ [symbol] ] is inferred to be equal to 0. alf_chroma_coeff_abs[ [symbol] ][i] specifies the absolute value of the j-th chroma filter coefficient for the alternative chroma filter with index [symbol] . When alf_chroma_coeff_abs[ [symbol] ][j] is not present, it is inferred to be equal 0. Its is [symbol] of bitstream [symbol] that the values of alf_chroma_coeff_abs[ [symbol] ][j] shall be in the range of 0 to [symbol] −1, inclusive.

alf_chroma_coeff_sign[altIdx][j] specifies the sign of the j-th chroma filter coefficient for the alternative chroma filter with index [symbol] as follows:
if alf_chroma_coeff_sign( [symbol] )[j] is equal to 0, the corresponding chroma filter coefficient has a positive value.
Otherwise (alf_chroma_coeff_sign[altIdx][j] is equal to 1), the corresponding chroma filter coefficient has a negative value.

When alf_chroma_coeff_sign[altIdx][j] is not present, it is inferred to be equal to 0.

The chroma filter coefficients [symbol] [adaptive_parameter_set_id][altIdx] with elements [symbol] [adaptive_parameter_set_id][altIdx][j], with altIdx=0 [symbol] , j=0.5 are derived as follows:

$${AlfCoeff}_{C} [ adaptation\_parameter \_set \_id ] [ altIdx ] [ j ] = alf\_chroma \_coeff \_abs [ altIdx ] [ j ] * ( 1 - 2 * alf\_chroma \_coeff \_sign [ altIdx ] [ j ] )$$

It is a requirement of [symbol] conformance that the values of [symbol] [adaptive_parameter_set_id][altIdx][j] with altIdx=0 [symbol] , j=0.5 shall be in the range of [symbol] =1 to [symbol] =1, inclusive.

alf_cross_component_ch_coeff_abs[j] specifies the absolute value of the j-th cross component Cb filter coefficient. When alf_cross_component_ch_coeff_abs[j] is not present, it is inferred to be equal to 0.

The order k of the exp-Golumb binarization [symbol] is set equal to 3.

alf_cross_component_ch_coeff_coeff[j] specifies the sign of the j-th cross component Cb filter coefficient as follows:
If alf_cross_component_ch_coeff_sgn[j] is equal to 0, the corresponding cross component Cb filter coefficient has a positive value.
Otherwise (alf_cross_component_cb_sign[j] is equal to 1), the corresponding cross component Cb filter coefficient has a negative value.

When alf_cross_component_ch_coeff_sign[j] is not present, it is inferred to be equal to 0.

The cross component Cb filter coefficients [symbol] with elements [symbol] , with j=0.13 are derived as follows:

$${CcAlfApsCoeff}_{Cb} [ adaptation\_parameter \_set \_id ] [ j ] = alf\_cross \_component \_cb \_coeff \_abs [ j ] * ( 1 - 2 * alf\_cross \_component \_cb \_coeff \_sign [ j ] )$$

It is a requirement of [symbol] conformance that the values of [symbol] , with j=0.13 shall be in the range of [symbol] to [symbol] −1, inclusive.

alf_cross_component_cr_coeff_abs[j] specifies the absolute value of the j-th cross component Cr filter coefficient. When alf_cross_component_cr_coeff_abs[j] is not present, it is inferred to be equal to 0.

The order k of the exp-Golumb binarization [symbol] is set equal to 3.

alf_cross_component_cr_coeff_sign[j] specifies the sign of the j-th cross component Cr filter coefficient as follows:
If alf_cross_component_cr_coeff_sign[j] is equal to 0, the corresponding cross component Cr filter coefficient has a positive value.
Otherwise [alf_cross_component_cr_sign[j] is equal to 1), the corresponding cross component Cr filter coefficient has a negative value.

When alf_cross_component_cr_coeff_sign[j] is not present, it is inferred to be equal to 0.

The cross component Cr filter coefficients [symbol] adaption_parameter_set_id] with elements [symbol] d adaptive_parameter_set_id][j], with j=0.13 are derived as follows:

$${CcAlfApsCoeff}_{Cr} [ adaptation\_parameter \_set \_id ] [ j ] = alf\_cross \_component \_cr \_coeff \_abs [ j ] * ( ( 1 - 2 * alf\_cross \_component \_cr \_coeff \_sign [ j ] )$$

It is a requirement of bitstream conformance that the values of [symbol] [adaption_parameter_set_id][j] with j=0.13 shall be in the range of −2 [symbol] to 2 [symbol] −1, inclusive.

alf_chroma_clip_Idx[altIdx][j] specifies the clipping index of the clipping value to use before multiplying by the j-th coefficient of the alternative chroma filter with index [symbol] . It is a requirement of bitstream conformance that the values of alf_chroma_clip_idx[altIdx][j] with altIdx=0_alf_chroma_ [symbol] _alt_filters_minus1, j=0.5 shall be in the range of 0 to 3, inclusive.

The chroma filter clipping values [symbol] with elements [symbol] , with altIdx=0 [symbol] , j=0.5 are derived as specified in Table 18 depending on bitDepth set equal to BitDepth_{C} and [symbol] are equal to alf_chroma_clip_idx[altIdx][j].

TABLE 18

[symbol]

Idx

| bitDepth | 0 | 1 | 2 | 3 |
|---|---|---|---|---|
| 8 | 255 | 64 | 16 | 4 |
| 9 | [symbol] | 108 | 23 | [symbol] |
| 10 | 1023 | 181 | 32 | 6 |
| 11 | 2047 | 304 | 45 | 7 |
| 12 | 4095 | 512 | 64 | 8 |
| 13 | [symbol] | [symbol] | [symbol] | 10 |
| 14 | [symbol] | [symbol] | 128 [symbol] | 11 |
| 15 | [symbol] | [symbol] | 181 | [symbol] |
| 16 | [symbol] | [symbol] | [symbol] | 16 |

[symbol]

indicates data missing or illegible when filed

Further, with respect to Table 15, it should be noted that JVET O2001 provides the following syntax and semantics for the adaptation parameter set syntax structure:

TABLE 19

| | Descriptor |
|---|---|
| [symbol] | [symbol] |
| [symbol] | [symbol] |
| [symbol] | |
| [symbol] | |
| [symbol] | |
| [symbol] | |
| [symbol] | |
| [symbol] | |
| [symbol] | [symbol] |
| [symbol] | |
| [symbol] | |
| [symbol] | [symbol] |
| [symbol] | |

[symbol]

indicates data missing or illegible when filed

Each APS RBSP shall be avail able to the decoding process prior to it being referred, included in at least one access unit with TemporalId less than or equal to the TemporalID of the coded slice NAL unit that refers it or provided through external means.

Let [symbol] to the [symbol] of an APS NAL unit. If the layer with [symbol] equal to [symbol] is an independent layer) i.e. ups_independent_layer_flag[GeneralLayerIds[aspLayerid]] is equal to 1), the APS NAL unit containing the APS RBSP shall have [symbol] equal to eh [symbol] of a coded slice NAL unit that refers it. Otherwise, the APS NAL unit containing the APS RBSP shall have nub_layer_id either equal in the nub_layer_id of a coded slice NAL unit that refers it, or equal to the nub_layer_id of a direct dependent layer of the layer containing a coded slice NAL unit that refers it.

All APS NAL units with a particular value of adaptation_parameter_set_idc and a particular value of aps_params_type within an access unit shall have the same content.

adaptation_parameter_set_id provides an identifier for the APS for reference by other syntax elements. When ups_param_type is equal to ALF_APS or SCALING_APS, the value of the adaptation_parameter_set_id shall be in the range of 0 to 7, inclusive.

When aps_params_type is equal to LMCS_APS, the value of adaptation_parameter_set_id shall be in the range of 0 to 3, inclusive.

adaptation_parameter_set_id specifies the type of APS parameters carried in the APS as specified in Table 20. When aps_params_type is equal to 1 (LMCS_APS), the value of adaptation_parameter_set_id shall be in the range of 0 to 3, inclusive.

TABLE 20

| | Name of | |
|---|---|---|
| aps_param_type | aps_params_type | Type of APS parameters |
| 0 | [symbol] | [symbol] |
| 1 | [symbol] | [symbol] |
| 2 | [symbol] | [symbol] |
| [symbol] | [symbol] | [symbol] |

[symbol]

indicates data missing or illegible when filed

NOTE—Each type of APSs uses a separate value space for adaptation_parameter_set_id.

NOTE—An APS NAL unit (with a particular value of adaptation_parameter_set_id and a particular value of aps_params_type) can be shared across pictures, and different slices within a picture can refer to different ALF APSs.
sps_extension_flag equal to 0 specifies that no aps_extension_data_flag syntax elements are present in the APS RBSP syntax structure, sps_extension_Flag equal to 1 specifies that there are aps_extnesion_data_flag syntax elements present in the APS RBSP syntax structure.
aps_extension_data_flag may have any value. Its presence and value do not affect decoder conformance to profiles specified in this version of this Specification. Decoders conforming to this version of this specification shall ignore ups_extension_data_flag syntex elements.

With respect to Table 16, in one example, the semantics may be based on the following:

slice_pic_parameter_set_id specifies the value of pps_pic_parameter_set_id for the PPS in use. The value of slice_pic_parameter_set_id shall be in the range of 0 to 63, inclusive.

It is a requirement of bitstream conformance that the value of TemporalId of the current picture shall be greater than or equal to the value of TemporalId of the PPS that has pps_pic_parameter_set_id equal to slice_pic_parameter_set_id.

cabac_init_flag specifies the method for determining the initialization table used in the initialization process for context variable. When cabac_init_flag is not present, it is inferred to be equal to 0.

slice_qp_delta specifies the initial value of [symbol] to be used for the coding blocks in the slice until modified by the value of CuQpDeltaVal in the coding unit layer. The initial value of the Qp_{Y} quantization parameter for the slice, SliceQp_{Y}, is derived as following:

$${SliceQp}_{Y} = 26 + init\_qp \_minus26 + slice\_qp \_delta$$

The value of SliceQp_{Y} shall be in the range of [symbol] to 63, inclusive.

Where,
[symbol] _qp_minus26 plus 26 specifies the initial value of SliceQp_{Y} for each slice referring to the PPS. The initial value of SliceQp_{Y} is modified at the slice layer when a non-zero value of slice_cp_delta is decoded.

The value of init_cp_minus26 shall be in the range of −(25+ [symbol] ) to −37, inclusive.

slice_sao_luma_flag equal to 1 specifies that SAO is enabled for the luma component in the current slice; slice_sao_luma_flag equal to 0 specifies that SAO is disabled for the luma component in the current slice. When slice_sao_luma_flag is not present, it is inferred to be equal to 0.

slice_sao_chroma_flag equal to 1 specifies that SAO is enabled for the chroma component in the current slice, slice_sao_chroma_flag equal to 0 specifies that SAO is disabled for the chroma component in the current slice. When slice_sao_chroma_flag is not present, it is inferred to be equal to 0.

slice_alf_enabled_flag equal to 1 specifies that adaptive loop filter is enabled and may be applied to Y, Cb, or Cr [symbol] component in a slice. slice_alf_enabled_flag equal to 0 specifies that adaptive loop filter is disabled for all colour components in a slice.

slice_num_slf_aps_ides_luma specifies the number of ALF APSs that the slice refers to. The value of slice_num_slf_aps_ides_luma shall be in the range of 0 to 7, inclusive.

slice_alf_aps_id_luma[i] specifies the adaptation_parameter_set_id of the i-th ALF APS that the luma componenet of the slice refers to The TemporalId of the APS NAL unit having aps_params_type equal to ALF_APS and adaptation_paremeter_set_id equal to slice_alf_aps_id_luma[i] shall be less than or equal to the TemporalId of the coded slice NAL unit.

For intra slices and slices in an IRAP picture, slice_alf_aps_id_luma[i] shall not refer to an ALF APS associated with other pictures rather than the picture containing the intra slices of the IRAP picture.

slice_alf_chroma_idc equal to 0 specifies that the adaptive loop filter is not applied to Cb and Cr colour components slice_alf_chroma_idc equal to 1 indicates that the adaptive loop filter is applied to the Cb colour component, slice_alf_chroma_idc equal to 2 indicates that the adaptive loop filter is applied to Cb and Cr colour components. When slice_alf_chroma_idc is not present, it is inferred to be equal to 0.

slice_alf_aps_id_chroma specifies the adaptation_parameter_set_id of the ALF APS that the chroma component of the slice refers to. The TemporalID of the APS NAL unit having sps_param_type equal to ALF_APS and adaptation_parameter_set_id equal to slice_alf_aps_id_chroma shall be less than or equal to the TemporalId of the coded slice NAL unit.

For intra slices and slices in an IRAP picture, slice_alf_aps_id_chroma shall not refer to an ALF APS associated with other pictures rather than the picture containing the intra slices or the IRAP pictures.

slice_cross_component_alf_cb_enabled_flag equal to 0 specifies that the cross-component Cb filter is not applied to Cb colour component. slice_cross_component_alf_cb_enabled_flag equal to 1 indicates that the cross component Cb filter is applied to the Cb colour component. When slice_cross_component_alf_cb_enabled_flag is not present, it is inferred to be equal to 0.

slice_cross_component_alf_cb_reuse_temporal_layer_filter_flag equal to 1 specifies that the cross component Cb filter coefficients, with j=0.13, inclusive is set equal to CcAlfTemporalCoeff_{Cb}[TemporalId][j].

slice_cross_component_alf_cb_reuse_temporal_layer_filter_flag equal to 0 and slice_cross_component_alf_cb_enable_flag is equal to 1 specifies that the syntax element slice_cross_component_alf_cb_aps_id is present in current slice header.

When slice_cross_component_alf_cb_enabled_flag is equal to 1, and slice_cross_component_alf_cb_reuse_temporal_layer_filter_flag is equal to 0, the elements of CcAlfTemporalCoeff_{Cb}[TemporalId][j] and CcAlfCoeff_{Cb}[j], with j=0.13 are derived as follows:
CcAlfTemporalCoeffCb[TemporalId][j]= [symbol] [slice_cross_component_alf_cb_aps_id][j]
CcAlfCoeffCb[j]=CcAlfApsCoeffCb[slice_cross_component_alf_cb_aps_id][j]

When slice_cross_component_alf_cb_enabled_flag is equal to 1, and slice_cross_component_alf_cb_reuse_temporal_layer_filter_flag is equal to 1, the elements of CcAlfCoeffCb[j], with j=0.13

It should be noted that in some example, [symbol] could be conditionally signaled either with [symbol] and/or NAL unit type being Non-IRAP and non-GDR and when not present inferred to equal 0.

A NAL unit type being Non-IRAP and non-GDR can be expressed by the following condition statement:

if( nal_unit_type != IDR_W_RADL && nal_unit_type != IDR_N_LP &&
nal_unit_type != CRA_NUT && nal_unit_type != GDR_NUT )

A NAL unit type being Non-IRAP and non_GDR and if (slice_type !=1) can be expressed by the following condition statement:

if( nal_unit_type != IDR_W_RADL && nal_unit_type != IDR_N_LP &&
nal_unit_type != CRA_NUT && nal_unit_type != GDR_NUT &&
slice_type [symbol] [symbol] ) [symbol]
indicates data missing or illegible when filed

slice_cross_component_alf_cb_aps_id specifies the adaptation_paramenter_set_id that the Cb colour component of the slice refers to. The TemporalId of the APS NAL unit having aps_params_type equal to ALF_APS and adaption_parameter_set_id equal to slice_cross_component_alf_cb_aps_id shall be less than or equal to the TemporalId of the coded slice NAL unit.

For intra slice and slice in an IRAP picture, slice_cross_component_alf_cb_aps_id shall not refer to an ALF APS associated with other pictures rather than the picture containing the intra slices or the IRAP picture.

When slice_cross_component_alf_cb_enabled_flag equal to 1, it is a requirement of bitstream conformance that, for all slices of the current picture, the ALF APS referred to by slice_cross_component_alf_cb_aps_id shall be the same.

slice_cross_component_alf_cb_log 2_control_size_minus4 specifies the control block size in number of chroma samples for the Cb colour component. slice_cross_component_alf_cb_log 2_conrol_size_minus4 shall be in the range 0 to Min(Log 2(CtblWidthC), Log 2(CtblheightC))−4, inclusive.

The variable CcAlfWidthCbl, and CcAlfHeightCbl, are derived as follows:

$$CcAlfWidthCbL = ( 1 << ( slice\_cross \_component \_alf \_cb \_log2 \_control \_size \_minus4 + 4 ) ) * SubWidthC \\ CcAlfHeightCbL = ( 1 << ( slice\_cross \_component \_alf \_cb \_log2 \_control \_size \_minus4 + 4 ) ) * SubHeightC$$

slice_cross_component_alf_cr_enabled_flag equal to 0 specifies that the cross component Cr filter is not applied to Cr colour component. slice_cross_component_alf_cr_enabled_flag equal to 1 indicates that the cross component adaptive loop filter is applied to the Cr colour component. When slice_cross_component_alf_cr_enabled_flag is not present, it is inferred to be equal to 0.

With respect to Table 16, in one example syntax elements slice_cross_component_alf_cb_enabled_flag and slice_cross_component_alf_cr_enabled_flag may be grouped into a single [symbol] (ChromaArrayType !=0)]) statement.

slice_cross_component_alf_cr_reuse_temporal_layer_filter_flag equal to 1 specifies that the cross component Cr filter coefficient, with j=0.13, inclusive is set equal to CcAlfTemporalCoeff_{Cr}[TemporalId][j].

slice_cross_component_alf_cr_reuse_temporal_layer_filter_flag equal to 0 and slice_cross_component_alf_cr_enabled_flag is equal to 1 specifies that the syntax element slice_cross_component_alf_cr_aps_id is present in current slice header.

When slice_cross_component_alf_cr_enabled_flag is equal to 1, and slice_cross_component_alf_cr_reuse_temporal_layer_filter_flag is equal to 0, the [symbol] of [symbol] and [symbol] with j=0.13 are derived as follows:

[symbol]

[symbol]

When slice_cross_component_alf_cr_enabled_flag is equal to 1, and slice_cross_component_alf_cb_reuse_temporal_layer_filter_flag is equal to 1, the elements of [symbol] , with j=0.13 are derived as follows:

[symbol]

It should be [symbol] that in some examples, slice_cross_component_alf_cr_reuse_temporal_layer_filter_flag would be conditionally signalled either with [symbol] and/or NAL unit type being Non-IRAP ad non-GDR and when not present inferred to equal 0.

slice_cross_component_alf_cr_aps_id specifies the adaptation_parameter_set_id that the Cr colour component of the slice refers to. The TemporalId of the APS NAL unit having [symbol] equal to ALF_APS and adaptation_parameter_set_id equal to slice_cross_component_alf_cr_aps_id shall be less than or equal to the TemporalId of the coded slice NAL unit.

For intra slices and slices in IRAP picture, slice_cross_component_alf_cr_aps_id shall [symbol] refer to an ALF APS associated with other pictures rather than the picture containing the intra slices or the IRAP picture.

When slice_cross_component_alf_cr_enabled_flag equal to 1, it is a requirement of bitstream conformance that, for all slices of the current picture, the ALF APS referred to by slice_cross_component_alf_cr_aps_id shall be the same.

slice_cross_component_alf_cr_log 2_control_size_minus4 specifies the control block size in number of chroma samples for the Cr colour component. slice_cross_component_alf_cr_log 2_control_size_minus4 shall be in the range 0 to Min(Log 2( [symbol] ), Log 2( [symbol] ))−4, inclusive.

The variable [symbol] and [symbol] are derived as followed:

$$CcAlfWidthCrL = ( 1 << ( slice\_cross \_component \_alf \_cr \_log2 \_control \_size \_minus4 + 4 ) ) * SubWidth \\ CcAlfHeightCrL = ( 1 << ( slice\_cross \_component \_alf \_cr \_log2 \_control \_size \_minus4 + 4 ) ) * SubHeightC$$

deblocking_filter_override_flag equal to 1 specifies that deblocking parameters are present in the slice header. deblocking_filter_override_flag equal to 0 specifies that deblocking parameters are not present in the slice header. When not present, the value of deblocking_filter_override_flag is inferred to be equal to 0.

deblocking_filter_disabled_flag equal to 1 specifies that the operation of the deblocking filter is not applied for the current slice, deblocking_filter_disabled_flag equal to 0 specifies that the operation of the deblocking filter is applied for the current slice. When deblocking_filter_disabled_flag is not present, it is inferred to be equal to pps_deblocking_filter_disabled_flag.

slice_beta_offset_div2 and slice_tc_offset_div2 specify the deblocking parameter offsets for [symbol] and [symbol] (divided by 2) for the current slice. The values of slice_beta_offset_div2 and slice_tc_offset_div2 shall both be in the range of −6 and 6, inclusive. When not present, the values of slice_beta_offset_div2 and slice_beta_offset_div2 are inferred to be equal to pps_beta_offset_div2 and pps_tc_offset_div2 and slice_tc_offset_div2 are inferred to be equal to [symbol] and [symbol] , negatively.

slice_lmcs_enabled_flag equal to 1 specifies that luma [symbol] with chroma sealing is enabled for the current slice. slice_lmcs_enabled_flag equal to 0 specifies that luma mapping with chroma sealing is not enabled for the current slices. When slice_lmcs_enabled_flag is not present, it is inferred to be equal to 0.

slice_lmcs_aps_id specifies the adaptation_parameter_set_id of the LMCS APS that the slice refers to. The TemporalId of the APS NAL unit having aps_params_type equal to LMCS_APS and adptation_parameter_set_id equal to slice_lmcs_aps_id shall be less than or equal to the TemporalId of the [symbol] slice NAL unit.

When [symbol] , the value of slice_lmcs_aps_id shall be the same for all slices of a picture.

slice_chroma_residual_scale_flag equal to 1 specifies that chroma residual sealing is enabled for the current slice, slice_chroma_residual_scale_flag equal to 0 specifies the chroma residual sealing is not enabled for the current slice. When slice_chroma_residual_scale_flag is not present, it is inferred to be equal 0.

Further, [symbol] following

[symbol]

[symbol] equal to 1 specifies [symbol] [symbol] after the deblocking filter process [symbol] offset process is not applied to the

[symbol]

[symbol] equal to 0 specifies that the adaptive loop filter is disabled. sps_alf_enabled_flag equal to 1 specifies that the adaptive loop filter is enabled.

sps_lmcs_enabled_flag equal to 1 specifies that luma mapping with chroma sealing is used in the CVS.

sps_lmcs_enabled_flag equal to 0 specifies that luma mapping with chroma sealing is not used in that CVS.

loop_filter_across_subpic_enabled_flag[i] equal to 1 specifies that in-loop filtering operations may be performed across the boundaries of the i-th subpicture in each coded picture in the CVS. loop_filter_across_subpic_enabled_flag[i] equal to 0 specifies that in-loop filtering operations are not performed across the boundaries of the i-th subpicture in each coded picture in the CVS. When not present, the values of loop_filter_across_subpic_enabled_flag[i] is inferred to be equal to 1.

[symbol] equal to 1 specifies that [symbol] is present in slice headers referring to the [symbol] equal to 0 specifies that [symbol] is not present in slice headers referring to the PPS.

deblocking_filter_override_enabled_flag equal to 1 specifies the presence of deblocking_filter_override_flag in the slice headers for the pictures referring to the PPS. deblocking_filter_override_enabled_flag equal to 0 specifies the absences of deblocking_filter_override_flag in the slice headers for pictures referring to the PPS. When not present, the value of deblocking_filter_override_enabled_flag is inferred to be equal to 0.

loop_filter_across_bricks_enabled_flag equal to 1 specifies that in-loop filtering operations may be performed across brick boundaries in pictures referring to the PPS. loop_filter_across_bricks_enabled_flag equal to 0 specifies that in-loop filtering operations are not performed across brick boundaries in pictures referring to the PPS. The in-loop filtering operations include the deblocking filter, sample adaptive offset filter, and adaptive loop filter operations. When not present, the value of loop_filter_across_bricks_enabled_flag is inferred to be equal to 1.

loop_filter_across_slices_enabled_flag equal to 1 specifies that in-loop filtering [symbol] may be performed across slice boundaries in pictures referring to the PPS, loop_filter_across_slices_enabled_flag equal to 0 specifies that in-loop filtering operations are not performed [symbol] slice boundaries in pictures referring to the PPS. The in-loop filtering operations include the deblocking filter, sample adaptive offset filter, and adaptive loop filter operations. When not present, the value of loop_filter_across_slices_enabled_flag is inferred to be equal to 0.

Further with respect to Table 16, the variables ChromaArrayType, SubWidthC, and SubheightC may ne derived as provided in Table 21:

TABLE 21

| [symbol] | [symbol] | [symbol] | [symbol] | [symbol] | [symbol] |
|---|---|---|---|---|---|
| 0 | 0 | [symbol] | 0 | 1 | 1 |
| 1 | 0 | [symbol] | 1 | 2 | 2 |
| 2 | 0 | [symbol] | 2 | 2 | 1 |
| 3 | 0 | [symbol] | [symbol] | 1 | 1 |
| 3 | 1 | [symbol] | 0 | 1 | 1 |

[symbol]

indicates data missing or illegible when filed

Further with respect to Table 16, JVET-O2001 includes the following syntax elements in the sequence parameter set syntax structure:

[symbol] plus 5 specifies the luma coding tree block size [symbol] each CTU. It is a requirement of [symbol] that the value of [symbol] be less than or equal to 2.

[symbol] plus 2 specifies the [symbol] luma coding block size. The variables [symbol] and [symbol] are derived as follows:

$$CtbLog 2 SizeY = log2\_ctu \_size \_minus5 + 5 \\ CtbSizeY = 1 << CtbLog 2 SizeY \\ MinCbLog 2 SizeY = log2\_min \_luma \_coding \_block \_size \_minus2 + 2 \\ MinCbSizeY = 1 << MinCbLog 2 SizeY \\ IbcBufWidthY = 128 * 128 / CtbSizeY \\ IbcBufWidthC = IbcBufWidthY / SubWidthC \\ VSize = Min ( 64 , CtbSizeY )$$

The variables [symbol] and [symbol] which specify the width and height, respectively, of the array for each chroma [symbol] , may be derived as follows:
If [symbol] is [symbol] to 0 [symbol] is equal to 1, [symbol] and [symbol] are both equal to 0.
Otherwise, [symbol] and [symbol] are derived as follows:

$$\text{?}$$

$$\text{?} \text{indicates text missing or illegible when filed}$$

Further, with respect to Table 17, JVET-O2001 includes the following syntax elements in the picture parameter set syntax structure:

pic_width_in_luma_samples specifies the width of each decoded picture referring to the PPS in units of [symbol] shall no be equal to 0, shall be an integer multiple of [symbol] and shall be less than or equal to

[symbol]

When [symbol] equal to 1, the value of pic_width_in_luma_samples shall be equal to

[symbol]

pic_height_in_luma_samples specifies the height of each decoded picture referring to the PPS in units of luma samples, pic_height_in_luma_samples shall not be equal to 0 and shall be an integer multiple of [symbol] and shall be less than or equal to

[symbol]

When subpics_present_flag is equal to 1, the value of pic_height_in_luma_samples shall be equal to pic_height_max_in_luma_samples.

Let [symbol] and [symbol] be n the pic_width_in_luma_samples and pic_height_in_luma_samples, respectively, of a reference picture of a current picture referring to this PPS. Is a requirement of [symbol] that all of the following conditions are satisfied:
pic_width_in_luma_samples*2 shall be greater than or equal to [symbol]
pic_height_in_luma_samples*2 shall be greater than or equal to [symbol]
pic_width_in_luma_samples shall be less than or equal to [symbol]
pic_height_in_luma_samples shall be less than or equal to

[symbol]

The variables [symbol] [symbol] and [symbol] are derived as follows:

$$PicWidthInCtbsY = Ceil ( pic\_width \_in \_luma \_samples + CtbSizeY ) \\ PicHeightInCtbsY = Ceil ( pic\_height \_in \_luma \_samples + CtbSizeY ) \\ PicSizeInCtbY = PicWidthInCtbsY * PicHeightInCtbsY \\ PicWidthInMinCbsY = pic\_width \_in \_luma \_samples / MinCbSizeY \\ PicHeightInMinCbsY = pic\_height \_in \_luma \_samples / MinCbSizeY \\ PicSizeInMinCbsY = PicWidthInMinCbsY * PicHeightInMinCbsY \\ PicSizeInSamplesY = pic\_width \_in \_luma \_samples * pic\_height \_in \_luma \_samples \\ PicWidthInSamplesC = pic\_width \_in \_luma \_samples / SubWidthC \\ PicHeightInSamplesC = pic\_height \_in \_luma \_samples / SubHeightC$$

Further, JVET-O2001 includes the following syntax elements in the picture parameter set syntax structure.

pps_loop_filter_across_vitrual_boundaries_disabled_flag equal to 1 specifies that the in-loop filtering operations are disabled across the virtual boundaries in pictures referring to the PPS. pps_loop_filter_across_vitrual_boundaries_disabled_flag equal to 0 specifies that no such disabling of in-loop filtering operations is applied in pictures referring to the PPS. The in-loop filtering operations include the deblocking filter, sample adaptive offset filter, and adaptive loop filter operations. When not present, the value of pps_loop_filter_across_virtual_boundaries_disblaed_flag is inferred to be equal to 0.

pps_num_ver_virtual_boundaries specifies the number of pps_virtual_boundaries_pos_x[i] syntax elements that are present in the PPS. When pps_num_ver_virtual_boundaries is not present, it is inferred to be equal to 0.

pps_virtual_boundaries_pos_i[i] is used to compute the value of [symbol] , which specifies the location of the [symbol] vertical virtual boundary in units of luma samples. pps_virtual_boundaries_pos_i[i] shall be in the range of 1 to [symbol] , inclusive.

The location of the vertical virtual boundary [symbol] is derived as follows:

[symbol]

The distance between any two vertical boundaries shall be greater than or equal to [symbol] samples.

pps_num_hor_virtual_boundaries specifies the number of pps_virtual_boudaries_y[i] syntax elements that are present in the PPS. When pps_num_hor_virtual_boundaries is not present, it is inferred to be equal to 0.

pps_virtual_boundaries_pos_y[i] is used to compute the value of [symbol] , which specifies the location of the i-th horizontal virtual boundary in units of luma samples, pps_virtual_boundaries_pos_y[i] shall be in the range of 1 to [symbol] (pic_height_in_luma_samples+8)−1, inclusive.

The location of the horizontal virtual boundary PpsVirtualBoundariesPosY[i] is derived as follows:
PpsVirtualBoundariesPosY[i]=pps_virtual_boundaries_pos_y[i]*8

The distance between any two horizontal virtual boundaries shall be greater than or equal to CtbSizeY luma samples.

“Versatile Video Coding (Draft 7),” 16th Meeting of ISO/IEC JTC1/SC29/WG11 1-11 Oct. 2019, Geneva, CH, document JVET-P2001-vE, which is incorporated by reference herein, and referred to as JVET-P2001, is an update to JVET-O2001 and represents the current iteration of the draft text of a video coding specification corresponding to the VVC project. JVET-P2001 includes a picture header syntax structure which includes information that is common for all slices of the coded picture associated with the picture (PH). Table 28 illustrates the portion of the syntax structure of the picture header provided in JVET-P2001 which is relevant to filtering operations.

TABLE 28

| | Descriptor |
|---|---|
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |

[symbol]

indicates data missing or illegible when filed

With respect to Table 28, JVHT-P2001 provides the following [symbol] :
The [symbol] contains information that is [symbol] for all slices of the coded picture [symbol] with the PH.

[symbol] equal to 1 specifies that [symbol] and [symbol] are present in the [symbol] . [symbol] equal to 0 specifies that [symbol] and [symbol] are not present in the PH. When [symbol] is not present, it is inferred to be equal to 0.

pic_sao_enabled_present_flag equal to 1 specifies that pic_sao_enabled_present_flag and pic_sao_chroma_flag are present in the PH. pic_sao_enabled_present_flag equal to 0 specifies that pic_sao_luma_flag and pic_sao_chroma_flag are not present in the PH. When pic_sao_enabled_present_flag is not present, it is inferred to be equal to 0.

pic_sao_luma_flag equals to 1 specifies that SAP is enabled for the luma component in all slices associated with the PH; pic_sao_luma_flag equal to 0 specifies that SAP for the luma component may be disabled for one, or more, or all slices associated with the PH. When pic_sao_luma_flag is not present, it is inferred to be equal to 0.

pic_sao_chroma_flag equal to 1 specifies that SAP is enabled for the chroma component in all slices associated with the PH; pic_sao_chroma_flag equal to 0 specifies that SAP for chroma component may be disabled for one, or more, or all slices associated with the PH. When pic_sao_chroma_flag is not present, it is inferred to be equal to 0.

pic_alf_enabled_present_flag equal to 1 specifies that pic_alf_enabled_flag, pic_num_alf_aps_ids_luma, [symbol] , pic_alf_chroma_idc, and [symbol] are present in the PH. pic_alf_enabled_present_flag equal to 0 specifies that pic_alf_enabled_flag, pic_num_alf_aps_ids_luma, pic_alf_id_luma[i], pic_alf_chroma_idc, and pic_alf_aps_id_chroma are not present in the PH. When pic_alf_enabled_present_flag is not present, it is inferred to be equal to 0.

pic_alf_enabled_flag equal to 1 specifies that adaptive loop filter enabled for all slices associated with the PH and may be applied to Y, Cb, or Cr colour component in the slices. pic_alf_enabled_flag equal to [symbol] specifies that adaptive lamp filter may be disabled for one, or more, or all slices associated with the PH. When not present, pic_alf_enabled_flag is inferred to be equal to 0.

pic_num_alf_sps_ids_luma specifies the number of ALF APS that the slices associated with the PH refers to.

pic_alf_aps_luma[i] specifies the adaptive_parameter_set_id of the i-th ALF APS that the luma component of the slices associated with the PH refers to.

The value of alf_luma_filter_signal_flag of the APS NAL unit having aps_params_type equal to ALF_APS and adaptation_parameter_set_id equal to pic_alf_aps_id_luma[i] shall be equal to 1.

pic_alf_chroma_idc equal to 0 specifies that the adaptive loop filter is not applied to Cb and Cr colour components. pic_alf_chroma_idc equal to 1 indicates that the adaptive loop filter is applied to the Cb colour component. pic_alf_chroma_idc equal to 2 indicates that the adaptive loop filter is applied to the Cr colour component. pic_alf_chroma_idc equal to 3 indicates that the adaptive loop filter is applied to Cb and Cr colour components. When pic_alf_chroma_idc is not present, it is inferred to be equal to 0.

pic_alf_aps_id_chroma specifies the adaption_parameter_set_id of the ALF APS that the chroma component of the slices associated with the PH refers to.

The value of alf_chroma_filter_signal_flag of the APS NAL unit having aps_params_type equal to ALF_APS and adaptation_parameter_set_id equal to pic_alf_chroma_idc shall be equal to 1.

pic_dep_quant_enabled_flag equal to 0 specifies that dependent quantization is disabled for slices associated with the PH. pic_dep_quant_enabled_flag equal to 1 specifies that dependent quantization is enabled for slices associated with the PH. When not present, the value of the pic_dep_quant_enabled_flag is inferred to be equal to [symbol] −1.

sign_data_hiding_enabled_flag equal to 0 specifies that sign bit hiding is disabled. sign_data_hiding_enabled_flag equal to 1 specifies that sign bit hiding is enabled. When sign_data_hiding_enabled_flag is not present, it is inferred to be equal to 0.

pic_deblocking_filter_override_present_flag equal to 1 specifies that pic_deblocking_filter_override_present_flag is present in the PH. pic_deblocking_filter_override_present_flag equal to 0 specifies that pic_deblocking_filter_override_flag is not present in the PH. When pic_deblocking_filter_override_present_flag is not present, it is inferred to be equal to 0.

pic_deblocking_filter_override_flag equal to 1 specifies that deblocking parameters are present in the PH. pic_deblocking_filter_override_flag equal to 0 specifies that deblocking parameters are not present in the PH. When not present, the value of pic_deblocking_filter_override_flag is inferred to be equal to 0.

pic_deblocking_filter_disabled_flag equal to 1 specifies that the operation of the deblocking filter is not applied for the slices associated with the PH. pic_deblocking_filter_disabled_flag equal to 0 specifies that the operation of the deblocking filter is applied for the slices associated with the PH. When pic_deblocking_filter_disabled_flag is not present, it is inferred to be equal to pic_deblocking_filter_disabled_flag.

plc_bets_offset_div2 and pic_tc_offset_div2 specify the deblocking parameter offset for β and tC (divided by 2) for the slices associated with the PH. The values of the pic_beta_offset_div2 and pic_sc_offset_div2 and pic_tc_offset_div2 are inferred to be equal to pps_beta_offset_div2 and pps_tc_offset_div2, respectively.

In one example, according to the techniques herein, an implementation of cross component filtering ultizing a picture header syntax structure may be based on the following syntax and semantics:

TABLE 29

| | Descriptor |
|---|---|
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |

[symbol]

indicates data missing or illegible when filed

TABLE 30

| | Descriptor |
|---|---|
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |

[symbol]

indicates data missing or illegible when filed

TABLE 31

| | Descriptor |
|---|---|
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |

[symbol]

indicates data missing or illegible when filed

TABLE 32

| | Descriptor |
|---|---|
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |

[symbol]

indicates data missing or illegible when filed

With respect to Tables 29-32, in one example, the [symbol] may be based on the semantics provided above and the following:

pic_alf_enabled_present_flag equal to 1 specifies that [symbol] [symbol] pic_cross_component_alf_cb_enabled_flag equal to 1 specifies that cross component Cb filter is enabled for all slices associated with the PH and may be applied to Cb colour component in the slices. [symbol] equal to 0 specifies that cross component Cb filter may be disabled for one, or more, or all slices associated with the PH. When not present, pic_cross_component_alf_cb_enabled_flag is inferred to be equal to 0.

pic_component_alf_cb_aps_id specifies the adaptation_parameter_set_id of the ALF APS that the Cb colour component of the slices associated with the PH refers to.

The value of alf_cross_component_cb_filter_signal_flag of the APS NAL unit having aps_params_type equal to ALF_APS and adaptation_parameter_set_id equal to [symbol] shall be equal 1.

pic_cross_component_cb_filters_signalled_minus1 plus 1 specifies the number of cross component Cb filters. The value of pic_cross_component_cb_filters_signalled_minus1 shall be in the range 0 to 3.

When pic_cross_component_alf_cb_enabled_flag equal to 1, it is a requirement of bitstream conformance that pic_cross_component_cb_filters_signalled_minus1 shall be less than or equal to the value of alf_cross_component_cb_filters_signalled_minus1 in the referenced ALF APS referred to by pic_cross_component_alf_cb_aps_id.

pic_cross_component_alf_cr_enabled_flag equal to 1 specifies that cross component Cr filter is enabled for all slices associated with the PH and may be applied to Cr colour component in the slices, pic_cross_component_alf_cr_enabled_flag equal to 0 specifies that cross component Cr filter may be disabled for one, or more, or all slices associated with the PH. When not present, pic_cross_component_alf_cr_enabled_flag is inferred to be equal to 0.

pic_cross_component_alf_cr_aps_id specifies the adaptation_parameter_set_id of the ALF APS that the Cr colour component of the slices associated with the PH refers to.

The value of alf_cross_component_cr_filter_signal_flag of the APS NAL unit having aps_params_type equal to ALF_AFS and adaptation_parameter_set_id equal to pic_cross_component_alf_cr_aps_id shall be equal to 1.

pic_cross_component_cr_filters_signalled_minus1 plus 1 specifies the number of cross component Cr filters. The value of pic_cross_component_cr_filters_signalled_minus1 shall be in the range 0 to 3.

When pic_cross_component_alf_cr_enabled_flag equal to 1, it is a requirement of bitstream conformance that pic_cross_component_cr_filters_signalled_minus1 shall be less than or equal to the value of pic_cross_component_cr_filters_signalled_minus1 in the referenced ALF APS referred to by pic_cross_component_alf_cr_aps_id.

alf_luma_filter_signal_flag equal to 1 specifies that a luma filter set is signalled. alf_luma_filter_signal_flag equal to 0 specifies that a luma filter set is not signalled.

alf_chroma_filter_signal_flag equal to 1 specifies that a chroma filter is signalled. alf_chroma_filter_signal_flag equal to 0 specifies that a chroma filter is not signalled. When ChromaArrayType is equal to 0, alf_chroma_filter_signal_flag shall be equal to 0.

The values of alf_luma_filter_signal_flag, alf_chroma_filter_signal_flag, alf_cross_component_cb_filter_signal_flag and alf_cross_component_cr_filter_signal_flag shall not all be equal to 0.

The variable [symbol] specifying the number of different adaptive loop filters is set equal to 25.

alf_cross_component_cb_filter_signal_flag equal to 1 specifies that a cross component Cb filter is signalled alf_cross_component_cb_filter_signal_flag equal to 0 specifies that a cross component Cb filter is not signalled. When ChromaArrayType is equal to 0, alf_cross_component_cb_filter_signal_flag shall be equal to 0.

alf_cross_component_cb_filters_signalled_minus1 plus 1 specifies the number of cross component Cb filters signalled in the current ALF APS. The value of alf_cross_component_cb_filters_signalled_minus1 shall be in the range 0 to 3.

alf_cross_component_cb_coeff_plus32[k][j] minus 32 specifies the value of the j-th coefficient of the signalled k-th cross-component Cb filter set. When alf_cross_component_cb_coeff_plus32[k][j] is not present, it is inferred to be equal to 32.

The signalled k-th cross component Cb filter coefficients [symbol] with elements [symbol] with j=0.7 are derived as follows:

[symbol]

alf_cross_component_cr_filter_signal_flag equal to 1 specifies that a cross component Cr filter is signalled alf_cross_component_cr_filter_signal_flag equal to 0 specifies that a cross component Cr filter is not signalled. When ChromaArrayType is equal to 0, alf_cross_component_cr_filter_signal_flag shall be equal to 0.

alf_cross_component_cr_filters_signalled_minus1 plus 1 specifies the number of cross component Cr filters signalled in the current ALF APS. The value of alf_cross_component_cr_filters_signalled_minus1 shall be in the range 0 to 3.

alf_cross_component_cr_coeff_plus32[k][k] minus 32 specifies the value of the j-th coefficient of the signalled k-th cross-component Cr filter set. When alf_cross_component_cr_coeff_plus32[k][k] is not present, it is inferred to be equal to 32.

The signalled k-th cross component Cr filter coefficient [symbol] with elements [symbol] , with j=0.7 are defined as follows:

[symbol]

slice_cross_component_alf_cb_enabled_flag equal to 0 specifies that the cross component Cb filter is most applied to Cb colour component, slice_cross_component_alf_cb_enabled_flag equal to 1 indicates that the cross component Cb filter is applied to the Cb colour component. When slice_cross_component_alf_cb_enabled_flag is not present, it is inferred to be equal to pic_cross_component_alf_cb_enabled_flag.

slice_cross_component_alf_cb_aps_id specifies the adaptation_parameter_set_id that the Cb colour component of the slice refers to. The TemporalId of the APS NAL unit having aps_params_type equal to ALF_APS and adaptation_parameter_set_id equal to slice_cross_component_alf_cb_aps_id shall be less than or equal to the TemporalId of the coded slice NAL units. When slice_cross_component_alf_cb_enabled_flag is equal to 1 and [symbol] is not present, the value of slice_cross_component_alf_cb_aps_id is inferred to be equal to the value of pic_cross_component_alf_cb_aps_id.

The value of slice_cross_component_cb_filter_signal_flag of the APS NAL unit having aps_params_type equal to ALF_APS and adaptation_parameter_set_id equal to slice_cross_component_alf_cb_aps_id shall be equal to 1.

slice_cross_component_cb_filters_signalled_minus1 plus 1 specifies the number of cross component Cb filters. The value of slice_cross_component_cb_filters_signalled_minus1 shall be in the range 0 to 3. When slice_cross_component_alf_cb_enabled_flag is equal to 1 and slice_cross_component_cb_filters_signalled_minus1 is not present, the value of slice_cross_component_cb_filters_signalled_minus1 is inferred to be equal to the value of pic_cross_component_cb_filters_signalled_minus1.

When slice_cross_component_alf_cb_enabled_flag equal to 1, it is a requirement of bitstream conformance that slice_cross_component_cb_filters_signalled_minus1 shall be less than or equal to the value of alf_cross_component_cb_filters_signalled_minus1 in the ALF APS referred to by slice_cross_component_alf_cb_aps_id of current slice.

slice_cross_component_alf_cr_enabled_flag equal to 0 specifies that the cross component Cr filter is not applied to Cr colour component slice_cross_component_alf_cr_enabled_flag equal to 1 indicates that the cross component adaptive loop filter is applied to the Cr colour component. When slice_cross_component_alf_cr_enabled_flag is not present, it is inferred to be equal to slice_cross_component_alf_cr_enabled_flag.

slice_cross_component_alf_cr_aps_id specifies the adaptation_parameter_set_id that the Cr colour component of the slice refers to. The TemporalId of the APS NAL unit having aps_parms_type equal to ALF_APS and adaptation_parameter_set_id equal to slice_cross_component_alf_cr_aps_id shall be less than or equal to the TemporalId of the coded slice NAL unit. When slice_cross_component_alf_cr_enabled_flag is equal to 1 and slice_cross_component_alf_cr_aps_id is not present, the value of slice_cross_component_alf_cr_aps_id is inferred to be equal to the value of slice_cross_component_alf_cr_aps_id.

The value of alf_cross_component_cr_filter_signal_flag of the APS NAL unit having aps_params_type equal to ALF_APS and adaptation_parameter_set_id equal to slice_cross_component_alf_cr_aps_id shall be equal to 1.

slice_cross_component_cr_filters_signalled_minus1 plus 1 specifies the number of cross component Cr filters. The value slice_cross_component_cr_filters_signalled_minus1 shall be in the range 0 to 3. When slice_cross_component_alf_cr_enabled_flag is equal to 1 and slice_cross_component_cr_filters_signalled_minus1 is not present, the value of slice_cross_component_cr_filters_signalled_minus1 is inferred to be equal to the value of slice_cross_component_cr_filters_signalled_minus1.

When slice_cross_component_alf_sr_enabled_flag equal to 1, it is a requirement of bitstream conformance that slice_cross_component_cr_filters_signalled_minus1 shall be less than or equal to the value of slice_cross_component_cr_filters_signalled_minus1 in the referenced ALF APS referred to by slice_cross_component_alf_cr_aps_id of current slice.

alf_ctb_cross_component_cb_idc[ [symbol] ] equal to 0 indicates that the cross component Cb filter is not applied to block of Cb colour component samples as luma location (xCt,yCtb), alfo_cross_component_cb_idc] [symbol] not equal to 0 indicates that the alf_cross_cb_idc [symbol] cross component Cb filter is applied to the block of Cb colour component samples at lumen location (xCtb,yXtb). When [symbol] is not present, it is inferred to be equal to 0.

alf_ctb_cross_component_cr_idc [symbol] equal to 0 indicates that the cross component Cr filter is not applied to block of Cr colour component samples of luma location (xTcb,yCtb), alf_cross_component_cr_ [symbol] not equal to 0 indicates that the [symbol] cross component Cr filter is applied to the block of Cr colour component samples at luma [symbol] (xCtb,yCtb). When [symbol] is not present, it is inferred to be equal to 0.

In one example, according to the techniques herein, for example, with respect to the syntax and [symbol] provided above with respect to Table 29-32, and adaptive loop filter process may be performed based on the following:

[symbol]

[symbol]

[symbol]

[symbol]

[symbol]

$$\text{?}$$

$$\text{?} \text{indicates text missing or illegible when filed}$$

[symbol]

$$\text{?}$$

$$\text{?} \text{indicates text missing or illegible when filed}$$

[symbol]

$$\text{?}$$

$$\text{?} \text{indicates text missing or illegible when filed}$$

[symbol]

[symbol]

$$curr = {alfPicture}_{C} [ xCtbC + x , yCtbC + y ]$$

[symbol]

$$\begin{matrix}sum = f [ 0 ] * {recPicture}_{L} [ h \text{?} , v \text{?} ] + \\ f [ 1 ] * {recPicture}_{L} [ h \text{?} , v \text{?} ] + \\ f [ 2 ] * {recPicture}_{L} [ h \text{?} , v \text{?} ] + \\ f [ 3 ] * {recPicture}_{L} [ h \text{?} , v \text{?} ] + \\ f [ 4 ] * {recPicture}_{L} [ h \text{?} , v \text{?} ] + \\ f [ 5 ] * {recPicture}_{L} [ h \text{?} , v \text{?} ] + \\ f [ 6 ] * {recPicture}_{L} [ h \text{?} , v \text{?} ] + \\ f [ 7 ] * {recPicture}_{L} [ h \text{?} , v \text{?} ]\end{matrix}$$

$$\text{?} \text{indicates text missing or illegible when filed}$$

$$deltaBitDepth = {BitDepth}_{Y} - {BitDepth}_{C} \\ scaledSum = ( sum + ( 1 << ( 6 + deltaBitDepth ) ) ) >> ( 7 + deltaBitDepth ) \\ scaledSum = Clip3 ( - ( 1 << ( {BitDepth}_{C} - 1 ) ) , ( 1 << ( {BitDepth}_{C} - 1 ) ) - 1 , scaledSum ) \\ sum = curr + scaledSum$$

[symbol]

$$ccAlfPicture [ xCtbC + x ] [ yCtbC + y ] = Clip3 ( 0 , ( 1 << {BitDepth}_{C} ) - 1 , sum )$$

TABLE 33

| [symbol] | [symbol] | [symbol] | [symbol] |
|---|---|---|---|
| [symbol] | [symbol] | [symbol] | [symbol] |
| [symbol] | [symbol] | [symbol] | [symbol] |
| [symbol] | [symbol] | [symbol] | [symbol] |
| [symbol] | [symbol] | [symbol] | [symbol] |
| [symbol] | [symbol] | [symbol] | [symbol] |

[symbol]

indicates data missing or illegible when filed

TABLE 34

| [symbol] | [symbol] | [symbol] |
|---|---|---|
| [symbol] | [symbol] | [symbol] |
| [symbol] | [symbol] | [symbol] |
| [symbol] | [symbol] | [symbol] |
| [symbol] | [symbol] | [symbol] |

[symbol]

indicates data missing or illegible when filed

It should be noted that the implementation of cross component filtering based on the syntax and semantics provided for Tables 29-32 provides an 8 tap filter. U.S. Provisional Application No. 62/913,065, filed on Oct. 9, 2019, each of which are incorporated by reference, provides an example implementation of a corresponding 6 tap filter.

In one example, according to the techniques herein, and ALF boundary position derivation process may be based on the following, where an input includes a virtual boundary offset [symbol] specifying the distance in luma samples between the bottom boundary of the current ending tree block and a virtual boundary.

[symbol]

Boundary Position Derivation

Inputs of this process are:
a [symbol] location [symbol] specifying the top-left sample of the current luma coding tree block relative to the top left sample of the current picture,
a luma location (x, y) specifying the current sample relative to the top-left sample of the current luma coding tree block.

Output of this process are:
the left vertical boundary position [symbol] ,
the right vertical boundary position [symbol] ,
the above horizontal boundary position [symbol] ,
the below horizontal boundary position [symbol] ,
the top left boundary flag [symbol] ,
the bottom right boundary flag [symbol] ,

The variables [symbol] and [symbol] are [symbol] equal to −128.

The variables [symbol] and [symbol] are [symbol] set equal to 0.

The variable [symbol] is modified as follows:
If y−( [symbol] −4) is greater than or equal to 0, the variable [symbol] is set equal to < [symbol] + [symbol] −4.

[symbol]

[symbol]

[symbol]

TABLE 35

| [symbol] | [symbol] | [symbol] |
|---|---|---|
| [symbol] | [symbol] | [symbol] |
| [symbol] | [symbol] | [symbol] |
| [symbol] | [symbol] | [symbol] |

[symbol]

indicates data missing or illegible when filed

Further, in one example, according to the techniques herein, for [symbol] and/or

[symbol] two variables [symbol] and [symbol] corresponding to probability state [symbol] .

Table 36 and 37 contain the values of the 6 bit variable [symbol] used in the initialization of context variables that are assigned to syntax elements [symbol] and

[symbol] . In Table 36 and Table 37 values of a variable [symbol] are mapped to [symbol] and [symbol] . It should be noted the in Table 36 and Table 37, the [symbol] value is used to derive [symbol] for a state [symbol] process. Further, the value EP indicates [symbol] and corresponds to a valued of 35 in JVET- [symbol] .

TABLE 36

| Initialization | [symbol] of alf_ctb_ [symbol] _component_cb_idc | | | | | | | | |
|---|---|---|---|---|---|---|---|---|---|
| variable | 0 | 1 | 2 | 3 | 4 | 5 | 6 | 7 | 8 |
| [symbol] Value | EP | EP | EP | EP | EP | EP | EP | EP | EP |
| shiftIdx | 0 | 0 | 0 | 0 | 0 | 0 | 0 | 0 | 0 |

[symbol]

indicates data missing or illegible when filed

TABLE 37

| Initialization | [symbol] of alf_ctb_ [symbol] _component_cr_idc | | | | | | | | |
|---|---|---|---|---|---|---|---|---|---|
| variable | 0 | 1 | 2 | 3 | 4 | 5 | 6 | 7 | 8 |
| [symbol] Value | EP | EP | EP | EP | EP | EP | EP | EP | EP |
| shiftIdx | 0 | 0 | 0 | 0 | 0 | 0 | 0 | 0 | 0 |

[symbol]

indicates data missing or illegible when filed

Form the [symbol] bit table entry [symbol] , the two 2 [symbol] variables [symbol] and [symbol] are derived as provided above.

The variables [symbol] and [symbol] , [symbol] in the [symbol] of [symbol] variable, are derived from [symbol] and

[symbol]

as [symbol] above.

The two values assigned to [symbol] and [symbol] for the [symbol] are derived from [symbol] , as provided above.

The two values assigned to [symbol] and [symbol] [symbol] the [symbol] are [symbol] as provided above.

The [symbol] for which [symbol] is [symbol] for each of the three [symbol] types, specifies by the variable [symbol] , and listed in Table 38. For P and B slice types, the [symbol] of [symbol] depends on the value of the [symbol] syntax element. The variable [symbol] as derived as follows:

```
if( slice_type = = I )
  initType = 0
else if( slice_type = = P )
  initType = [symbol] _init_flag ? 2 : 1
else
  initType = [symbol] _init_flag ? 1 : 2 [symbol]
indicates data missing or illegible when filed
```

TABLE 38

| [symbol] | [symbol] | [symbol] | [symbol] |
|---|---|---|---|
| [symbol] | [symbol] | [symbol] | [symbol] |
| [symbol] | [symbol] | [symbol] | [symbol] |
| [symbol] | [symbol] | [symbol] | [symbol] |

[symbol]

indicates data missing or illegible when filed

From Table 28, a variable [symbol] is set equal to [symbol] . The variable [symbol] is set equal to the

[symbol]

of [symbol] and

[symbol]

In one example, the assignment of [symbol] is specified as follows:

TABLE 39

| | binIdx | | | | | |
|---|---|---|---|---|---|---|
| Syntax element | 0 | 1 | 2 | 3 | 4 | >=5 |
| alf_ctb_ [symbol] _component_cb_idc[ ][ ] | 0 . . . 2 | bypass | bypass | bypass | bypass | bypass |
| | (Table 38) | | | | | |
| alf_ctb_ [symbol] _component_cr_idc[ ][ ] | 0 . . . 2 | bypass | bypass | bypass | bypass | bypass |
| | (Table 38) | | | | | |

[symbol]

indicates data missing or illegible when filed

For the

[symbol]

TABLE 40

| | | | |
|---|---|---|---|
| [symbol] | [symbol] | [symbol] | [symbol] |
| [symbol] | [symbol] | [symbol] | [symbol] |
| [symbol] | [symbol] | [symbol] | [symbol] |

[symbol]

indicates data missing or illegible when filed

In this manner, video encoder represents an example of a device configured to receive reconstructed sample data for a current component of video data, receiving reconstructed sample data for one or more additional components of video data, derive a cross component filter based on data associated with one or more additional components of video data, and apply a filter to the reconstructed sample data for a current component of video data based on the derived cross component filter and the reconstructed sample data for one or more additional components of video data.

FIG. 13 is a block diagram illustrating an example of a video decoder that may be configured to decode video data according to one or more techniques of this disclosure. In one example, video decoder 500 may be configured to reconstruct video data based on one or more of the techniques described above. That is, video decoder 500 may operate in a reciprocal manner to video encoder 200 described above. Video decoder 500 may be configured to perform intra prediction decoding and inter prediction decoding and, as such, may be referred to as a hybrid decoder. In the example illustrated in FIG. 14 video decoder 500 includes an entropy decoding unit 502, inverse quantization unit 504, inverse transformation processing unit 506, intra prediction processing unit 508, inter prediction processing unit 510, summer 512, filter unit 514, and reference buffer 516. Video decoder 500 may be configured to decode video data in a manner consistent with a video encoding system, which may implement one or more aspects of a video coding standard. It should be noted that although example video decoder 500 is illustrated as having distinct functional blocks, such an illustration is for descriptive purposes and does not limit video decoder 500 and/or sub-components thereof to a particular hardware or software architecture. Functions of video decoder 500 may be realized using any combination of hardware, firmware, and/or software implementations.

As illustrated in FIG. 13, entropy decoding unit 502 receives an entropy encoded bitstream. Entropy decoding unit 502 may be configured to decode quantized syntax elements and quantized coefficients from the bitstream according to a process reciprocal to an entropy encoding process. Entropy decoding unit 502 may be configured to perform entropy decoding according any of the entropy coding techniques described above. Entropy decoding unit 502 may parse an encoded bitstream in a manner consistent with a video coding standard. Video decoder 500 may be configured to parse an encoded bitstream where the encoded bitstream is generated based on the techniques described above.

Referring again to FIG. 13, inverse quantization unit 504 receives quantized transform coefficients (i.e., level values) and quantization parameter data from entropy decoding unit 502. Quantization parameter data may include any and all combinations of delta QP values and/or quantization group size values and the like described above. Video decoder 500 and/or inverse quantization unit 504 may be configured to determine QP values used for inverse quantization based on values signaled by a video encoder and/or through video properties and/or coding parameters. That is, inverse quantization unit 504 may operate in a reciprocal manner to coefficient quantization unit 206 described above. For example, inverse quantization unit 504 may be configured to infer predetermined values), allowed quantization group sizes, and the like, according to the techniques described above. Inverse quantization unit 504 may be configured to apply an inverse quantization. Inverse transform processing unit 506 may be configured to perform an inverse transformation to generate reconstructed residual data. The techniques respectively performed by inverse quantization unit 504 and inverse transform processing unit 506 may be similar to techniques performed by inverse quantization/transform processing unit 208 described above. Inverse transform processing unit 506 may be configured to apply an inverse DCT, an inverse DST, an inverse integer transform, Non-Separable Secondary Transform (NSST), or a conceptually similar inverse transform processes to the transform coefficients in order to produce residual blocks in the pixel domain. Further, as described above, whether a particular transform (or type of particular transform) is performed may be dependent on an intra prediction mode. As illustrated in FIG. 13, reconstructed residual data may be provided to summer 512. Summer 512 may add reconstructed residual data to a predictive video block and generate reconstructed video data. A predictive video block may be determined according to a predictive video technique (i.e., intra prediction and inter frame prediction).

Intra prediction processing unit 508 may be configured to receive intra prediction syntax elements and retrieve a predictive video block from reference buffer 516. Reference buffer 516 may include a memory device configured to store one or more frames of video data. Intra prediction syntax elements may identify an intra prediction mode, such as the intra prediction modes described above. In one example, intra prediction processing unit 508 may reconstruct a video block using according to one or more of the intra prediction coding techniques described herein. Inter prediction processing unit 510 may receive inter prediction syntax elements and generate motion vectors to identify a prediction block in one or more reference frames stored in reference buffer 516. Inter prediction processing unit 510 may produce motion compensated blocks, possibly performing interpolation based on interpolation filters. Identifiers for interpolation filters to be used for motion estimation with sub-pixel precision may be included in the syntax elements. Inter prediction processing unit 510 may use interpolation filters to calculate interpolated values for sub-integer pixels of a reference block.

Filter unit 514 may be configured to perform filtering on reconstructed video data. For example, filter unit 514 may be configured to perform deblocking and/or SAO filtering, as described above with respect to filter unit 216. In example filter unit 514 may include cross component filter unit 600 described below. Further, it should be noted that in some examples, filter unit 514 may be configured to perform proprietary discretionary filter (e.g., visual enhancements). As illustrated in FIG. 13, a reconstructed video block may be output by video decoder 500.

As described above, FIG. 5 illustrates an example of a cross component filter unit that may be configured to encode video data according to one or more techniques of this disclosure. FIG. 14 illustrates an example of a cross component filter unit that may be configured to decode video data according to one or more techniques of this disclosure. That it, cross component filter unit 600 may operation in a reciprocal manner to cross component filter unit 300. As illustrated in FIG. 14, component filter unit 600 includes filter determination unit 602 and sample modification unit 604. Sample modification unit 604 may operate in a manner similar to sample modification unit 304. That is, sample modification unit 604 may perform filtering according to derived filter, include one or more of the filters describe herein. As illustrated in FIG. 14, sample modification unit 604 may output the modified reconstructed block to the reference picture buffer (i.e., as an in-loop filter) and output the modified reconstructed block to an output (e.g., a display). Filter determination unit 602 may receive coding parameter information (e.g., an intra prediction) available at the time a current block is decoded and available video block data which, as illustrated in FIG. 14, at a video decoder, may include: Cross Component Reconstructed Block(s) and Current Component Reconstructed Block. However, as illustrated in FIG. 14 filter determination unit 602 may receive filter data. That is, filter data specifying a derived filter may be signaled to the filter determination unit 602. Examples of such signaling are described above. As such, filter determination unit 302 may derive a filter to be used on the chroma reconstructed block based on the video data, coding parameters and/or filter data.

As described above, the cross component filtering techniques describe herein may be generally applied to each component of video data. As such, one or more combinations of components of video data may be used to reduce a reconstruction error for one or more other components of video data. FIGS. 15A-15C are block diagrams illustrating examples of cross component filter units that may be configured to reduce a reconstruction error according to one or more techniques of this disclosure. That is, FIGS. 15A-15C illustrate examples of loop filters that may be included in filtering unit 514. In FIGS. 15A-15C, commonly number elements are described above. Cr Cross Component filter unit 702 is an example of a filter unit configured to filter a Cr component based on a luma component, a Cb component, filter data, and coding parameters. Luma Cross Component filter unit 704 is an example of a filter unit configured to filter a luma component based on a luma component, a Cb component, a Cr component, filter data, and coding parameters. Thus, video decoder 500 represents an example of a device configure to receive reconstructed sample data for a current component of video data, receiving reconstructed sample data for one or more additional components of video data, derive a cross component filter based on data associated with one or more additional components of video data, and apply a filter to the reconstructed sample data for a current component of video data based on the derived cross component filter and the reconstructed sample data for one or more additional components of video data.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Moreover, each functional block or various features of the base station device and the terminal device used in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

Various examples have been described. These and other examples are within the scope of the following claims.

### SUMMARY

In one example, a method of reducing a reconstruction error in video data, the method comprising: receiving reconstructed sample data for a current component of video data; receiving reconstructed sample data for one or more additional components of video data; deriving a cross component filter based on data associated with one or more additional components of video data; and applying a filter to the reconstructed sample data for a current component of video data based on the derived cross component filter and the reconstructed sample data for one or more additional components of video data.

In one example, the method, further comprising signaling information associated with the derived cross component filter.

In one example, the method, wherein deriving a cross component filter includes parsing signaling to determine cross component filter parameters.

In one example, the method, wherein deriving a cross component filter based on data associated with one or more additional components of video data includes deriving a cross component filter based on a known reconstruction error.

In one example, the method, a cross component filter is specified according to filter coefficients.

In one example, a device for coding video data, the device comprising one or more processors configured to perform any and all combinations of the steps.

In one example, the device, wherein the device includes a video encoder.

In one example, the device, wherein the device includes a video decoder.

In one example, a system comprising: the device includes a video encoder; and the device includes a video decoder.

In one example, an apparatus for coding video data, the apparatus comprising means for performing any and all combinations of the steps.

In one example, a non-transitory computer-readable storage medium comprising instructions stored thereon that, when executed, cause one or more processors of a device for coding video data to perform any and all combinations of the steps.

In one example, a method of filtering reconstructed video data, the method comprising: parsing a first syntax element used for setting cross-component filter coefficients; inputting a reconstructed luma picture sample array; deriving luma locations by using location corresponding to a current chroma sample; deriving an filter coefficient array by using the cross-component filter coefficients; deriving a variable by using the filter coefficient array and the reconstructed luma picture sample array defined by the luma locations; and deriving a scaled variable by using the variable, wherein the variable is modified by a sum of a sample of a current chroma block, which is defined by a predetermined location, and the scaled variable.

In one example, the method, wherein the syntax element is a syntax element for specifying an adaption parameter set identifier and the syntax element is included in a slice header.

In one example, the method, further comprising: decoding a second syntax element used for setting the cross-component filter coefficients, wherein the second syntax element is included in a coding tree unit syntax structure.

In one example, the method, wherein the first syntax element is decoded according to a value of a cross component adaptive loop filter enabled flag.

In one example, the method, wherein the second syntax element specifies whether a cross-component filter is applied to a block.

In one example, the method, wherein the second syntax element specifies whether a cross-component filter is applied to a block.

In one example, the method, wherein the second syntax element is entropy coded by using a truncated Rice binarization process.

In one example, a device for coding video data, the device comprising one or more processors configured to: code a first syntax element used for setting cross-component filter coefficients; input a reconstructed luma picture sample array; derive luma locations by using a location corresponding to a current chroma sample; derive an filter coefficient array by using the cross-component filter coefficients; derive a variable by using the filter coefficient array and the reconstructed luma picture sample array defined by the luma locations; and derive a scaled variable by using the variable, wherein the variable is modified by a sum of a sample of a current chroma block, which is defined by a predetermined location, and the scaled variable.

In one example, a device for decoding video data, the device comprising one or more processors configured to: decode a first syntax element used for setting cross-component filter coefficients; input a reconstructed luma picture sample array; derive luma locations by using a location corresponding to a current chroma sample; derive an filter coefficient array by using the cross-component filter coefficients; derive a variable by using the filter coefficient array and the reconstructed luma picture sample array defined by the luma locations; and derive a scaled variable by using the variable, wherein the variable is modified by a sum of a sample of a current chroma block, which is defined by a predetermined location, and the scaled variable.

### CROSS REFERENCE

This Nonprovisional application claims priority under 35 U.S.C. § 119 on provisional Application No. 62/913,065 on Oct. 9, 2019, No. 62/950,000 on December 18, PCT Application No. PCT/JP2020/024648 on Jun. 23, 2020, Application Ser. No. 17/766,322 on Apr. 4, 2022, Application Ser. No. 18/617,986 on Apr. 3, 2025, the entire contents of which are hereby incorporated by reference.

1: A decoder for decoding coded data, the decoder comprising:
a processor; and
a memory associated with the processor, wherein the processor is configured to:
parse a syntax element in a coding tree unit, wherein the syntax element specifies a cross-component filter that is applied to a chroma coding tree block; and
apply the cross-component filter to the chroma coding tree block,
wherein applying the cross-component filter to the coding tree block includes invoking an adaptive loop filter boundary position derivation process with (i) a first luma location (xCtb, yCtb) specifying a top-left sample location of a current luma coding tree block, (ii) a second luma location (x, y) specifying a current sample relative to the top-left sample of the current luma coding tree block, and (iii) a variable vbOffset, set equal to 4, specifying an offset for an adaptive loop filter virtual boundary as inputs,
wherein the adaptive loop filter boundary position derivation process includes setting an above horizontal boundary position clipTopPos equal to yCtb+CtbSizeY−vbOffset if y−(CtbSizeY−vbOffset) is greater than or equal to 0, wherein CtbSizeY is the size of the current luma coding tree block.

2: A encoder for decoding coded data, the decoder comprising:
a processor; and
a memory associated with the processor, wherein the processor is configured to:
encode a syntax element in a coding tree unit, wherein the syntax element specifies a cross-component filter that is applied to a chroma coding tree block; and
apply the cross-component filter to the chroma coding tree block,
wherein applying the cross-component filter to the coding tree block includes invoking an adaptive loop filter boundary position derivation process with (i) a first luma location (xCtb, yCtb) specifying a top-left sample location of a current luma coding tree block, (ii) a second luma location (x, y) specifying a current sample relative to the top-left sample of the current luma coding tree block, and (iii) a variable vbOffset, set equal to 4, specifying an offset for an adaptive loop filter virtual boundary as inputs,
wherein the adaptive loop filter boundary position derivation process includes setting an above horizontal boundary position clipTopPos equal to yCtb+CtbSizeY−vbOffset if y−(CtbSizeY−vbOffset) is greater than or equal to 0, wherein CtbSizeY is the size of the current luma coding tree block.

3: A non-transitory computer readable medium storing a program causing a processor to implement:
parsing a syntax element in a coding tree unit, wherein the syntax element specifies a cross-component filter that is applied to a chroma coding tree block; and applying the cross-component filter to the chroma coding tree block,
wherein applying the cross-component filter to the coding tree block includes invoking an adaptive loop filter boundary position derivation process with (i) a first luma location (xCtb, yCtb) specifying a top-left sample location of a current luma coding tree block, (ii) a second luma location (x, y) specifying a current sample relative to the top-left sample of the current luma coding tree block, and (iii) a variable vbOffset, set equal to 4, specifying an offset for an adaptive loop filter virtual boundary as inputs,
wherein the adaptive loop filter boundary position derivation process includes setting an above horizontal boundary position clipTopPos equal to yCtb+CtbSizeY−vbOffset if y−(CtbSizeY−vbOffset) is greater than or equal to 0, wherein CtbSizeY is the size of the current luma coding tree block.
